(19) United States
(12) Patent Application Publication
(10) Pub. No.: US 2014/0258183 A1
(43) Pub. Date: Sep. 11, 2014

(54) Systems, Methods And Devices Supporting Interactive Personal And Professional Guidance

(71) Applicant: Unstuck LLC, San Francisco, CA (US)

(72) Inventors: Keith E. YAMASHITA, Mill Valley, CA (US); Susan L. Schuman, New York, NY (US); David GLICKMAN, San Francisco, CA (US); Stephen LUCEY, San Francisco (US); Kelly CLARK, San Francisco, CA (US); Audrey LIU, San Francisco, CA (US)

(73) Assignee: Unstuck LLC, San Francisco, CA (US)

(21) Appl. No.: 14/205,300

(22) Filed: Mar. 11, 2014

Related U.S. Application Data
(63) Continuation of application No. PCT/US2012/058991, filed on Oct. 5, 2012.
(60) Provisional application No. 61/543,493, filed on Oct. 5, 2011.
(60) Provisional application No. 61/543,471, filed on Oct. 5, 2011.
(60) Provisional application No. 61/543,348, filed on Oct. 5, 2011.

(51) Int. Cl. G06N 5/04

(52) U.S. Cl. CPC G06N 5/04
USPC 706/11

(57) ABSTRACT

A system that helps users get unstuck determines an archetype to which the user's stuck moment belongs and then provides a diagnosis and one or more tools. Each archetype has a corresponding prescription, each prescription has a corresponding computer-implemented tool. The diagnosis for the person determines a prescription for that person, and the prescription for that person determines at least one computer-implemented tool for that person to deal with the stuck moment.

### RELATED APPLICATIONS

This application is related to and claims priority from, filed Oct. 5, 2012, the entire contents of which are hereby fully incorporated herein by reference for all purposes. This application is related to and claims priority from the following United States provisional patent applications, the entire contents of each of which are hereby fully incorporated herein for all purposes: (1) Application No. U.S. 61/543,493, titled “Systems, Methods and Devices Supporting Interactive Personal and Professional Guidance,” filed Oct. 5, 2011; (2) Application No. U.S. 61/543,471, titled “Systems, Methods and Devices Supporting Interactive Personal and Professional Guidance,” filed Oct. 5, 2011; and (3) Application No. U.S. 61/543,348, titled “Systems, Methods and Devices Supporting Interactive Personal and Professional Guidance,” filed Oct. 5, 2011.

### BACKGROUND OF THE INVENTION

### Copyright Statement

This patent document contains material subject to copyright protection. The copyright owner has no objection to the reproduction of this patent document or any related materials in the files of the United States Patent and Trademark Office, but otherwise reserves all copyrights whatsoever.

### APPENDICES

This application includes the following appendices which are considered part of the application:

Appendix A—tables and exemplary data structures.

Appendix B—source code.

### FIELD OF THE INVENTION

This invention relates to systems, methods and devices supporting interactive personal and professional guidance. More specifically, this invention relates to systems, methods and devices supporting interactive personal and professional guidance in getting unstuck.

### BACKGROUND

People often get stuck. Sometimes they get stuck in personal problems, sometimes in professional problems, sometimes both. Sometimes a person is stuck alone, and sometimes they are stuck with others. Often people don't even know or admit they're stuck, although their situation may be apparent to others. Too often, however, people do know that they're stuck (e.g., unable to make a decision or act), but they don't know how to move forward and get unstuck. All too often people who are stuck believe that they have no way out and that they are alone and even unique in their stuck situation.

It is desirable to provide a way to help people get unstuck.

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows a logical overview of a system/device to help a user get unstuck;

FIG. 2 shows a typical computer in the system;

FIGS. 3A-3B explain the see, believe, think, act paradigm used by the system;

FIG. 4 is a flowchart showing operation of aspects of the system of FIG. 1;

FIGS. 5A-5X are examples of displays used in an implementation of the system of FIG. 1;

FIG. 6 is a table showing information about feelings data used in an implementation of the system of FIG. 1;

FIG. 7 shows an exemplary flow of an unstuck application; and

FIGS. 8A to 8-o describe aspects of operation of various exemplary tools.

### DETAILED DESCRIPTION OF THE PRESENTLY PREFERRED EXEMPLARY EMBODIMENTS

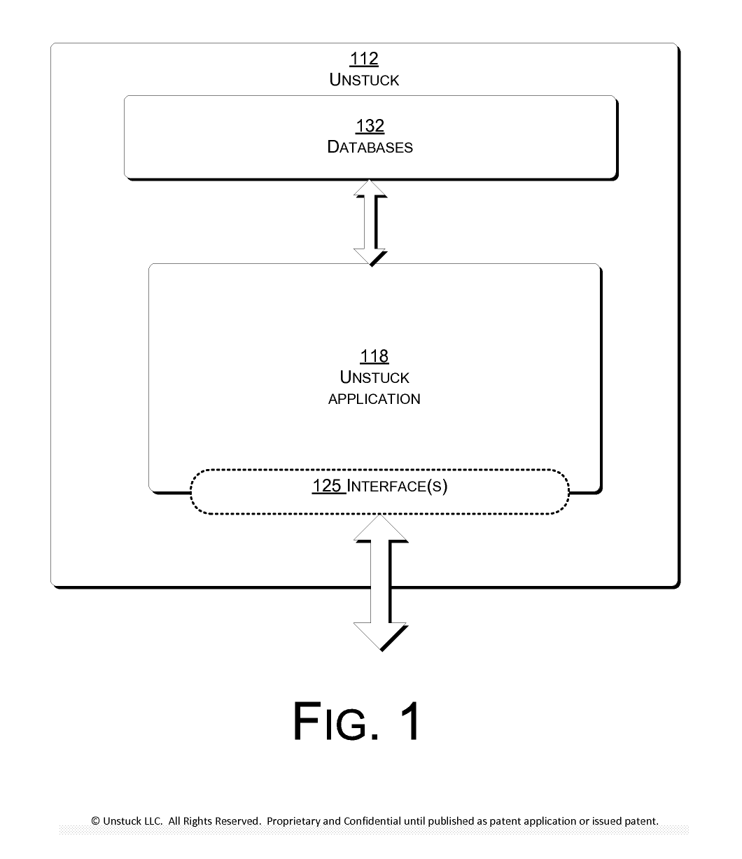

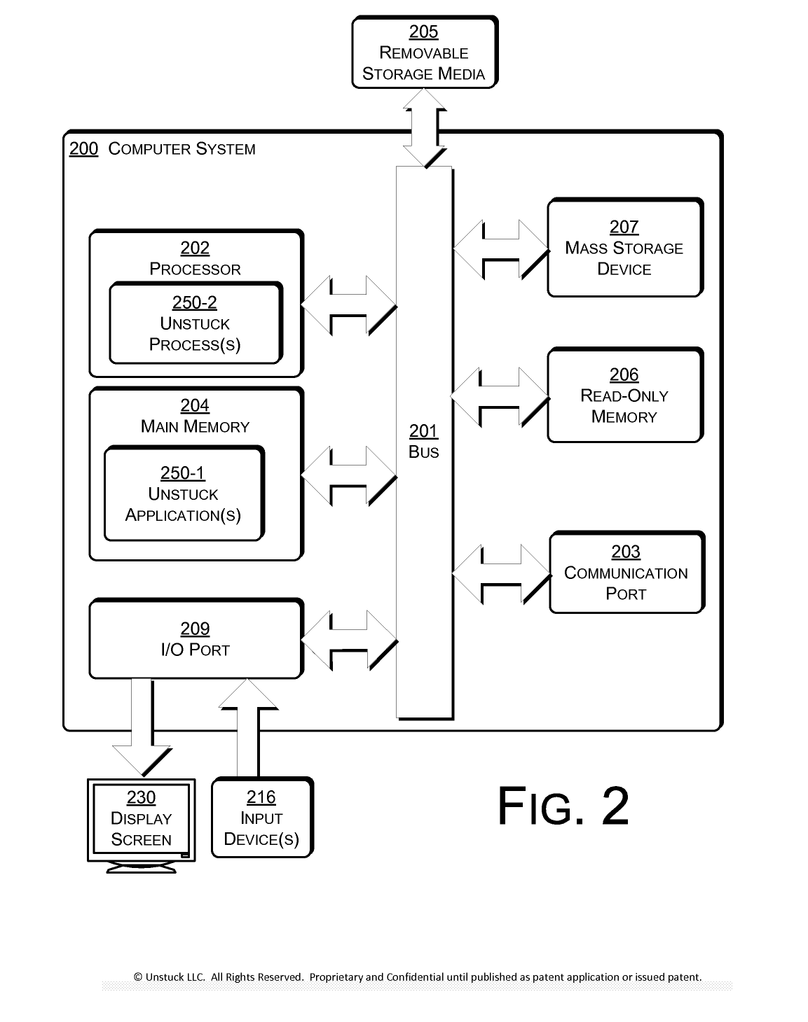

FIG. 1 shows a logical overview of a system/device 102 to help a user get unstuck. System/device 102 includes an unstuck application 104 and one or more interfaces 106 to that application. The unstuck application 104 access and interacts with one or more databases 108.

In a presently preferred implementation, the system 102 is implemented as a software application on a portable device such as an Apple iPad.

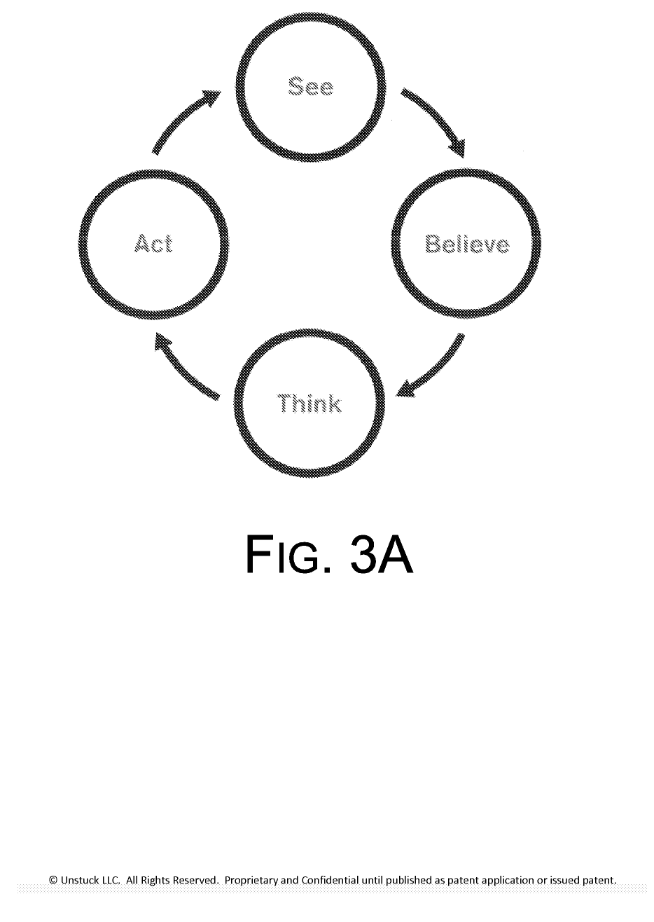

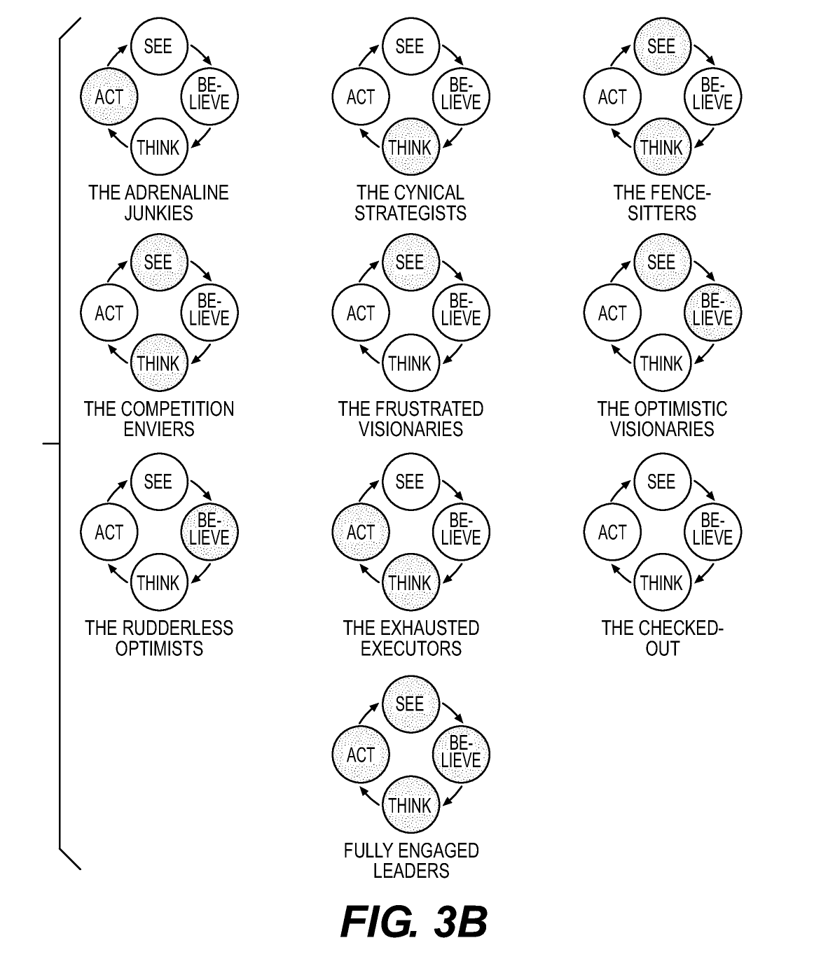

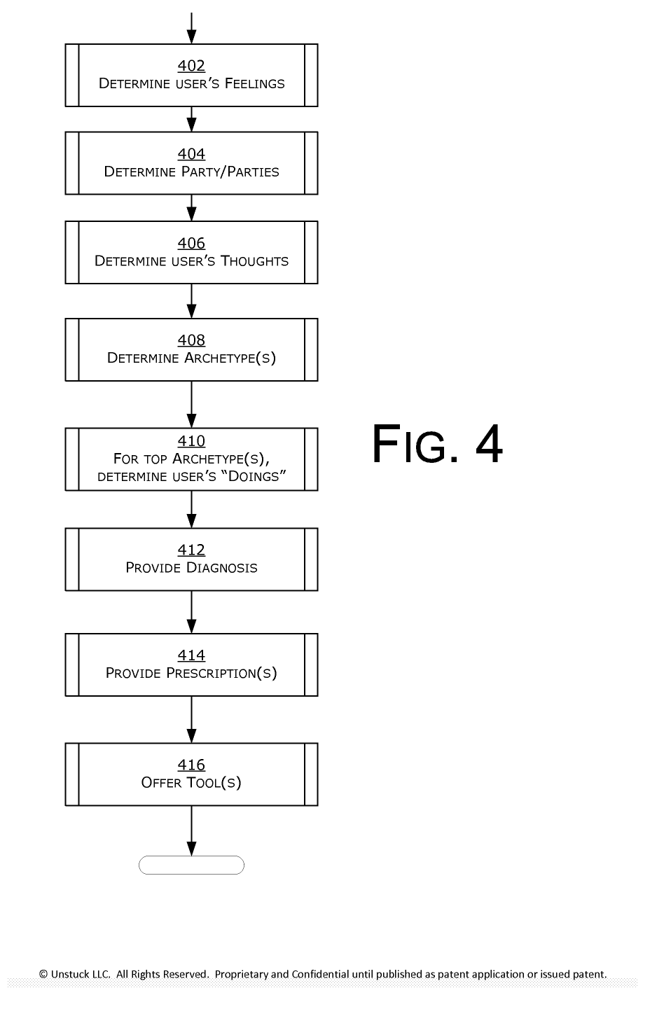

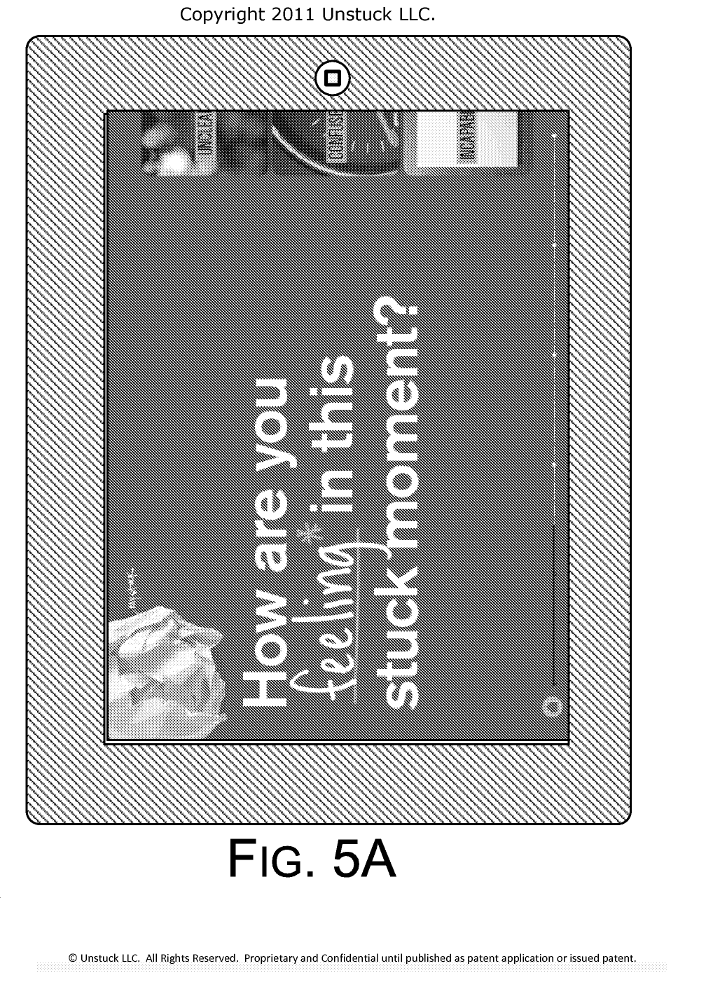

The system is organized around a “See, Believe, Think, Act” paradigm, e.g., as shown in FIG. 3A. A number of archetypes correspond to the “See, Believe, Think, Act” paradigm (“SBTA”). A number of archetypes (denoted Ai) correspond to the SBTA paradigm. In a presently preferred implementation there are eleven (11) archetypes that correspond to the SBTA paradigm. In a present implementation these archetypes are:

| | Archetype Description |
|---|---|
| A1 | Tunnel Visionary |
| A2 | Deflated Doer |
| A3 | Drifter |
| A4 | Waffler |
| A5 | Reluctant Adapter |
| A6 | Idle Achiever |
| A7 | Fuzzy Forecaster |
| A8 | Adlibber |
| A9 | Perplexed Planner |
| A10 | Lone Leader |
| A11 | Avoider |

Each of these archetypes corresponds to one or more configurations or states of the SBTA.

Each of the archetypes Aⱼ corresponds to one of the overarching SBTA categories. For the example archetypes shown above, the corresponding SBTA categories are shown in the following table (Table I).

TABLE I

| | Archetype | SBTA Category |
|---|---|---|
| A₁ | Tunnel Visionary | Seeing |
| A₂ | Deflated Doer | Seeing |
| A₃ | Drifter | Believing |
| A₄ | Waffler | Believing |
| A₅ | Reluctant Adapter | Believing |
| A₆ | Idle Achiever | Believing |
| A₇ | Fuzzy Forecaster | Thinking |
| A₈ | Ad-libber | Thinking |
| A₉ | Perplexed Planner | Thinking |
| A₁₀ | Lone Leader | Acting |
| A₁₁ | Avoider | Acting |

Those of skill in the art will realize and understand, upon reading this description, that different and/or other archetypes may be used, and that different names or descriptions of the various archetypes may be used. As there are four states in the SBTA paradigm, there are sixteen possible combinations of See, Believe, Think, and Act, leading to sixteen possible archetypes. However, the system is not limited by the number of archetypes used on to the SBTA paradigm.

FIG. 3B shows another set of possible archetypes corresponding to SBTA.

In order to help someone get unstuck (i.e., to provide a prescription to that person), it is first necessary to determine the archetype(s) to which their current stuck state corresponds. It should be appreciated that a particular stuck state may correspond to more than one archetype.

Once the archetype is determined (as described below), the user may be provided with a corresponding prescription (denoted Rxᵢ for the i-th archetype Aᵢ). The prescription is something that the user needs to do in order to get unstuck. In addition, as will be discussed below, the user may be provided with one or more tools to help carry out the prescription. The following table summarizes exemplary prescriptions and tools for the eleven (11) archetypes shown above.

Archetypes Table

| | Archetype | Prescription | |
|---|---|---|---|
| | (Diagnostic) | (Rx) | Tool |
| 1 | Tunnel Visionary | Stray from the | Map it out |
| | (Blind Observer) | usual | |
| 2 | Deflated Doer | Get restoked | Shake up your routine |
| 3 | Drifter | Figure it out | News-breaker |
| 4 | Waffler | Take a stand | Pros v. Pros |
| 5 | Reluctant Adapter | Gut check it | News-breaker |
| 6 | Idle Achiever | Commit | 5 Whys/Make it public |
| 7 | Fuzzy Forecaster | Envision | Visualize it |
| | | success | |
| 8 | Ad-libber | Make a game | Get your game on |
| | | plan | |
| 9 | Perplexed Planner | Make a fresh | Obstacle Course |
| | | start | |
| 10 | Lone Leader | Call in the | Call in the Cavalry |
| | | cavalry | |
| 11 | Avoider | Go for it | No Excuses |

Those of skill in the art will realize and understand, upon reading this description, that different and/or other prescriptions and/or tools may be used for any particular archetype. It should also be appreciated that the tool names are exemplary and possibly descriptive, and that each tool name preferably corresponds to a software tool (application) that can operate on the same device as the unstuck application.

The archetype(s) to which a user (or a user's stuck state) corresponds is a function of (at least) that user's feelings and thoughts relating to that stuck state.

As part of the analysis of a particular user's stuck situation, it is generally preferable to know whether or not this situation involves the user alone or the user with one or more others. It is also preferable to know whether the user is stuck in a personal situation or a professional situation. This information is used to tailor the diagnostic process and the prescription(s).

### Feelings:

A user may have or be having a number of feelings relating to a particular stuck state. These user feelings are selected from a set of feelings (denoted Fi that are weighted across the archetypes Ai). Thus, e.g., feeling Fᵢ will have a corresponding weight w_{i,j} for each of the archetypes Aⱼ. In a presently preferred implementation there are eighteen (18) feelings that are weighted (1-5) across all eleven (11) archetypes. In a presently preferred implementation these eighteen feelings are:

| | Feeling |
|---|---|
| F_{1.} | Afraid |
| F_{2.} | Aimless |
| F_{3.} | Baffled |
| F_{4.} | Conflicted |
| F_{5.} | Hazy |
| F_{6.} | Hesitant |
| F_{7.} | High and dry |
| F_{8.} | Lost |
| F_{9.} | Overwhelmed |
| F_{10.} | Paralyzed |
| F_{11.} | Tired |
| F_{12.} | Unclear |
| F_{13.} | Undisciplined |
| F_{14.} | Uninformed |
| F_{15.} | Uninspired |
| F_{16.} | Unmotivated |
| F_{17.} | Unprepared |
| F_{18.} | Wishy-washy |

Those of skill in the art will realize and understand, upon reading this description, that different and/or other feelings may be used. For example, the feeling “Frustrated” may be used in addition to or instead of one of the listed feelings.

It should be appreciated that the archetypes are numbered here for descriptive purposes, and the numbering is not intended to imply any ordering or preference for any archetypes.

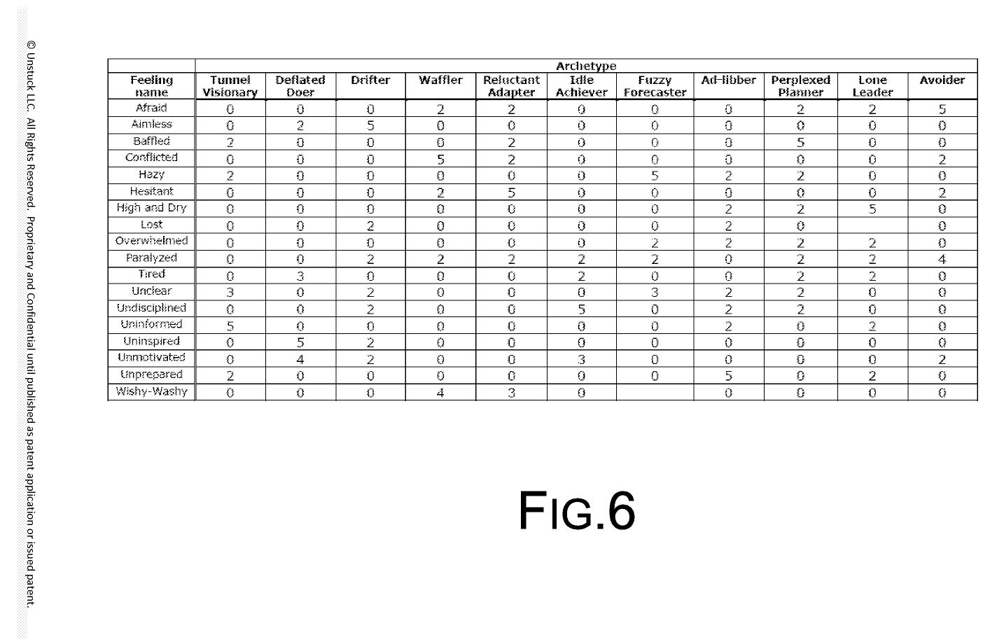

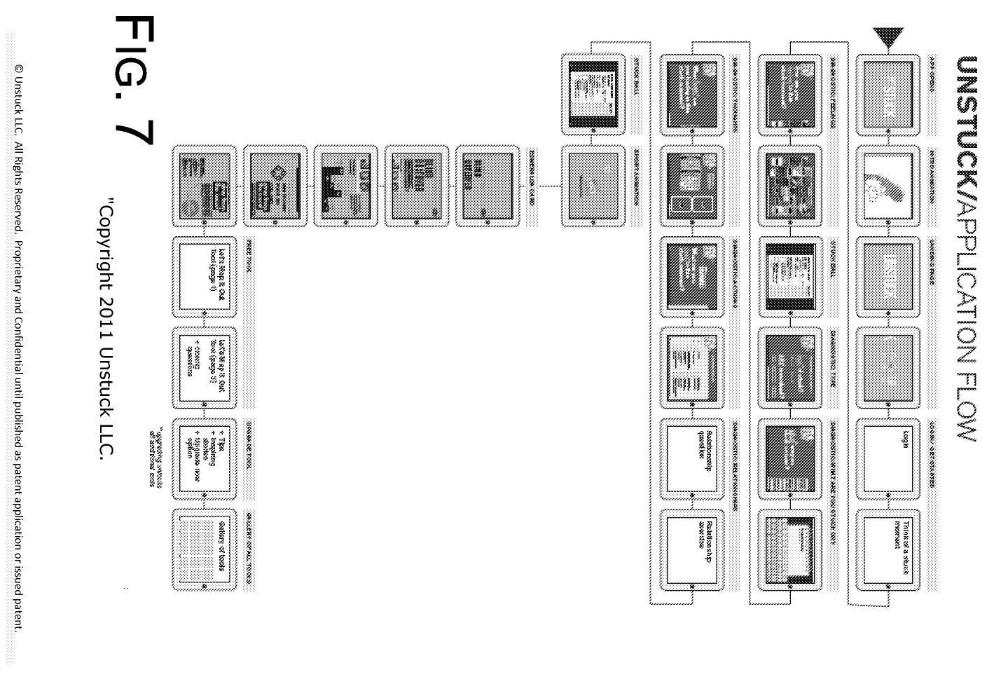

The table in FIG. 6 (Table II) shows the weights for each of the 18 feelings for each of the 11 archetypes in a current implementation. Each archetype has one feeling that gets the highest value of 5. From that table it can be see that, e.g., the feeling “Afraid” has a weight of 2 for the archetypes “Waffler”, “Reluctant Adapter”, Perplexed Planner” and “Lone Leader,” and a weight of 5 for the archetype “Avoider.” In this case, the feeling “wishy-washy” has no corresponding archetype with a weight of 5. Those of skill in the art will realize and understand, upon reading this description, that that different and/or other weights can be used for each feeling/archetype combination.

It should be appreciated that the feelings are numbered here for descriptive purposes, and the numbering is not intended to imply any ordering or preference for any feelings.

Thoughts

A user may have or be having a number of thoughts relating to a particular stuck state. These user thoughts are selected from a set of thoughts (denoted Ti that are weighted across the archetypes Ai). Thus, e.g., feeling Ti will have a corresponding weight tw_{i,j} for each of the archetypes Aj. However, unlike the feelings, the thoughts are preferably given a non-zero weighting for one archetype and a zero weight for all of the other archetypes. In a present implementation each thought Ti is given a weighting of ten (10) toward a specific archetype and a weighting of zero (0) for all other archetypes. In other words, for each thought Ti, and for each archetype Aj, tw_{i,j} is either zero or ten, and tw_{i,j} is only ten for one of the archetypes Aj.

In a present implementation there are 139 thoughts that are weighted across all eleven (11) archetypes. The exemplary 139 thoughts are listed in the Thoughts Table (Table III) in Appendix A hereto and are considered part of this description. For example, as shown in the Thoughts Table, thought T₁ is “I don't have enough to go on” and is weighted 10 for the archetype “Tunnel Visionary” and weighted zero for all other archetypes. As another example, the thought T₆₀ is “Change is hard” and is weighted 10 for the archetype “Reluctant Adapter” and zero of all other archetypes.

The archetype for which a thought is weighted 10 is also referred to as that thought's archetype category. So, in the examples just give, the thought T₁ is in the archetype category “Tunnel Visionary” and the thought T₆₀ is in the archetype category “Reluctant Adapter”.

It should be appreciated that the thoughts are numbered here for descriptive purposes, and the numbering is not intended to imply any ordering or preference for any thoughts.

In addition, each thought is also categorized as one of Seeing, believing, thinking, or acting. This categorization is referred to as the thought's SBTA category. Table IV in Appendix A shows the thoughts by SBTA Category for a current implementation.

Not all thoughts are applicable to all users or user situations, and the total set of thoughts is preferably pruned for each analysis based on information that the user has already provided. In particular, the applicability of a thought may depend on whether the user is stuck alone or with one or more others, and/or on whether the user is stuck personally or professionally. In this regard, each thought Ti is flagged with one or more flags corresponding to whether or not that thought relates to (or is applicable to) a stuck situation of the user alone (flag “me”), a stuck situation of the user plus one other (flag “me plus 1”), a stuck situation of the user plus 2 or more others (flag “me plus 2”), whether the stuck situation is personal (flag “personal”) or professional (flag “professional”).

Table V in Appendix A shows the flags corresponding to the 139 thoughts in a current implementation. For example, the thought T₇ (“We don't know enough to really get it”) is not applicable to a stuck situation for the user alone, but is appropriate to all of the other situations. Hence that thought has the flag “me” set to 0 and the other flags set to “1”.

Doing

A user may be doing a number of things related to their stuck situation. Ascertaining what the user is doing may be used as part of the diagnosis of that user's stuck situation. What the user is doing is denoted Di, and each doing is categorized as one of the overarching categories “See”, “Believe”, “Think”, “Act”. Each doing Di is also categorized according to a prescription (Rxᵢ). Table VI (in Appendix A hereto) shows a list of 64 “doings” mapped to corresponding prescriptions categories and SBTA categories. For example, as shown in the Table IV, the doing D₂₅ (“Second-guessing yourself”) corresponds to the prescription “Take a stand” and to the SBTA category “Believing”.

It should be appreciated that not all entries in the Doing list will be applicable to all user's unstuck situations. In particular, the applicability of a “doing” may depend on whether the user's stuck situation is alone or with others, or whether it is personal or professional. In this regard, each doing Di is preferably flagged with one or more flags corresponding to whether or not that doing relates to (or is applicable to) a stuck situation of the user alone (flag “me”), a stuck situation of the user plus one other (flag “me plus 1”), a stuck situation of the user plus 2 or more others (flag “me plus 2”), whether the stuck situation is personal (flag “personal”) or professional (flag “professional”). In the example list of doings given in Table IV, all doings are considered applicable to all situations, and so the flags are all set to one (and are not shown).

Each doing (Di) is assigned a weight for each of the prescription categories (Rx). In the present implementation, each doing (Di) is assigned a weight of ten (10) for the corresponding prescription category (as shown in Table IV), and a weight of zero (0) for all other prescription categories. Table V shows the prescription category weights for each of the doings (Di) in Table IV.

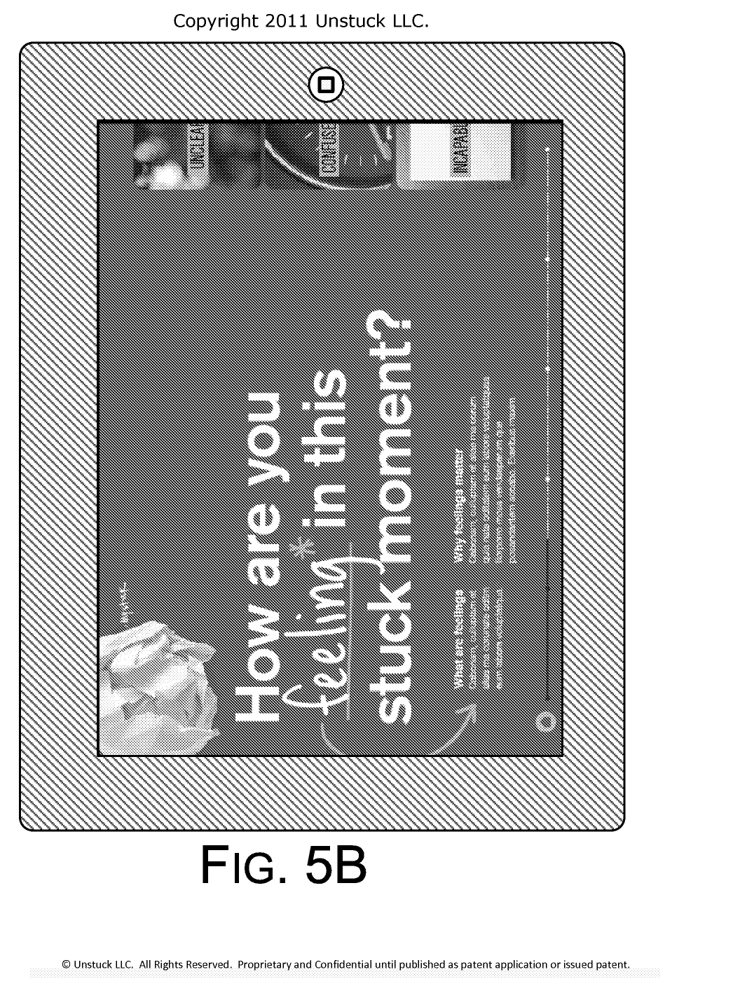

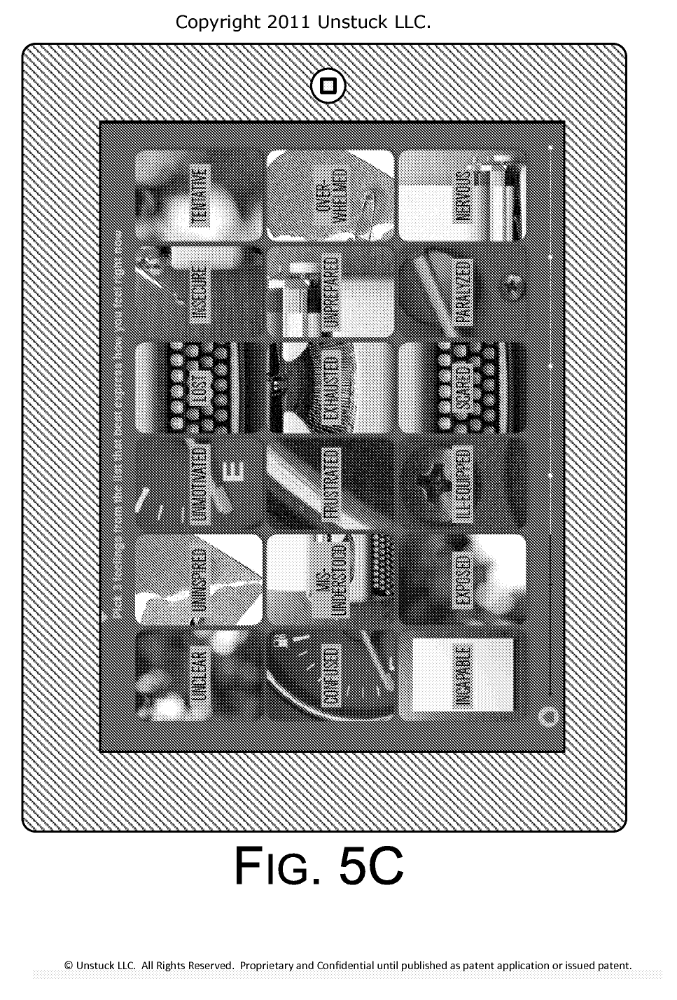

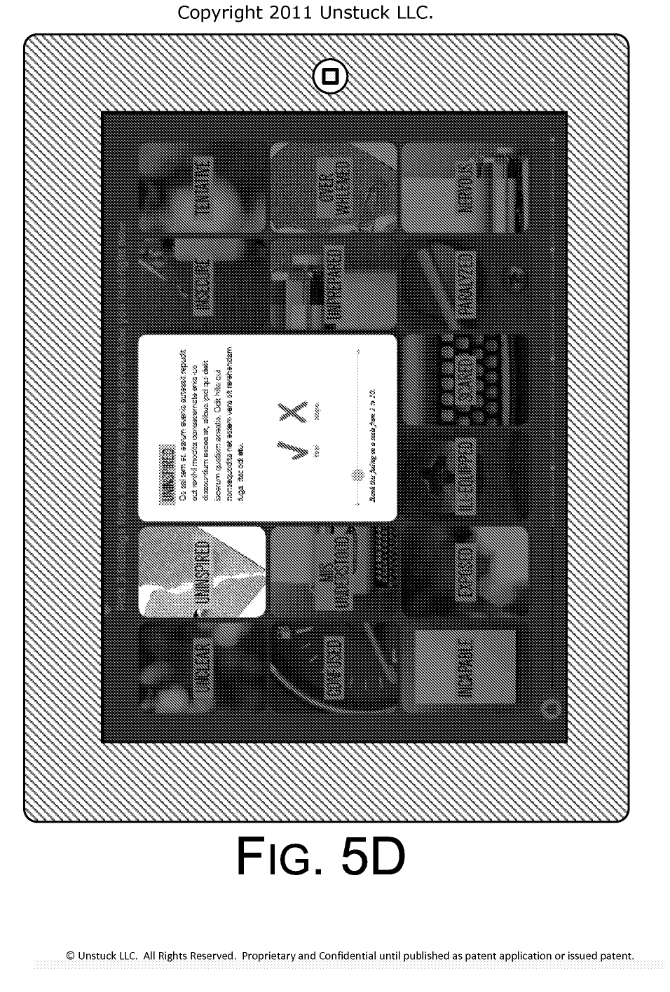

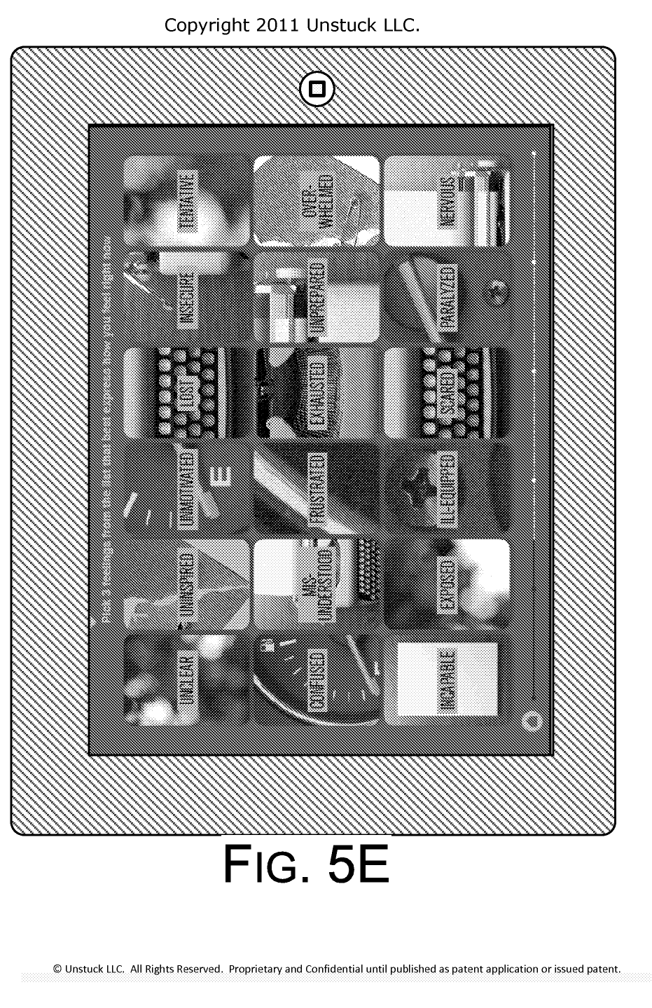

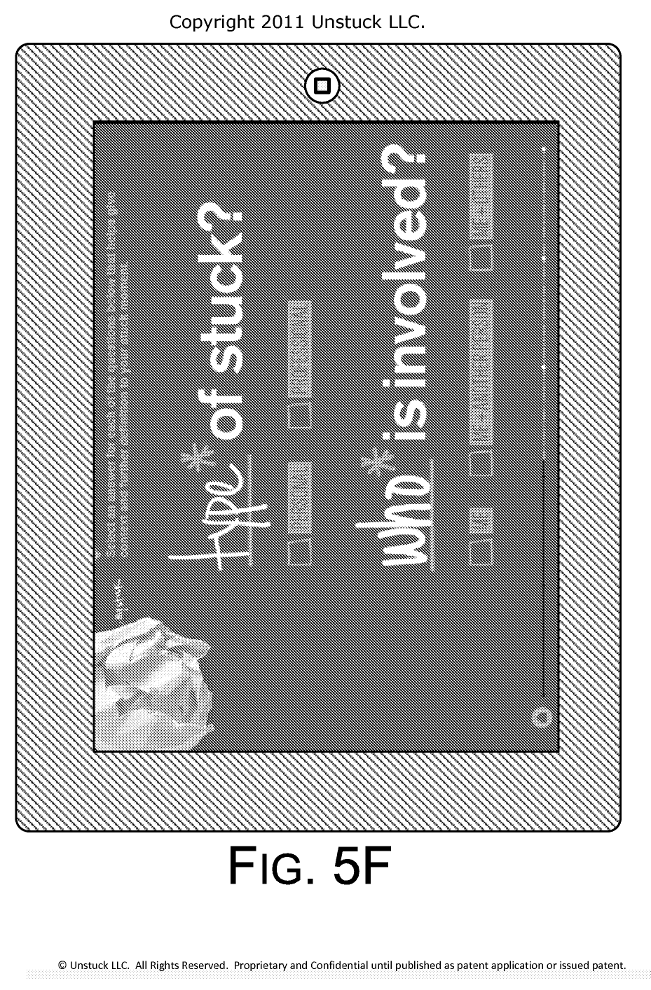

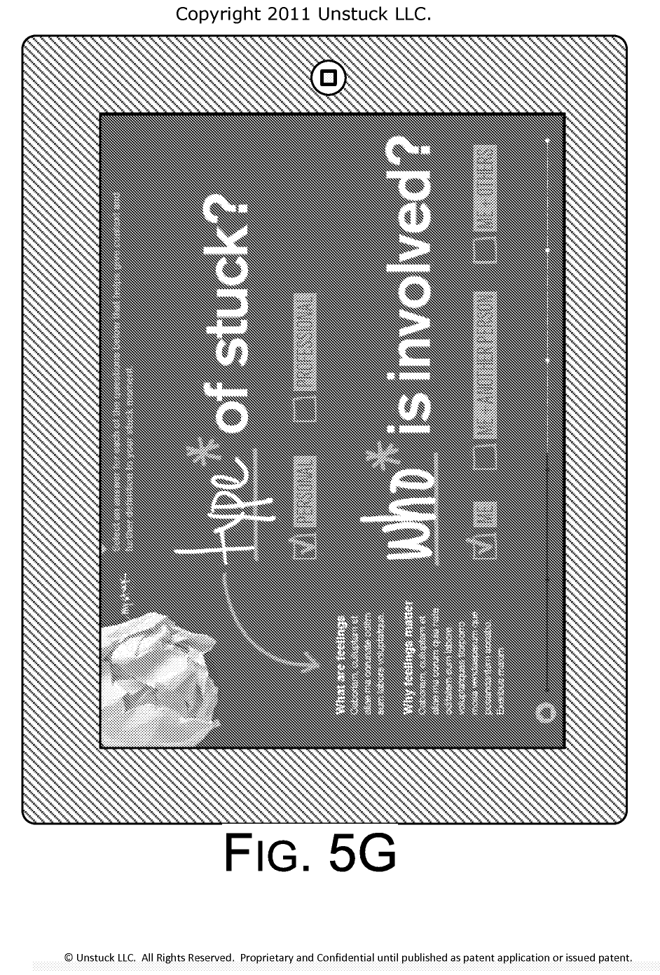

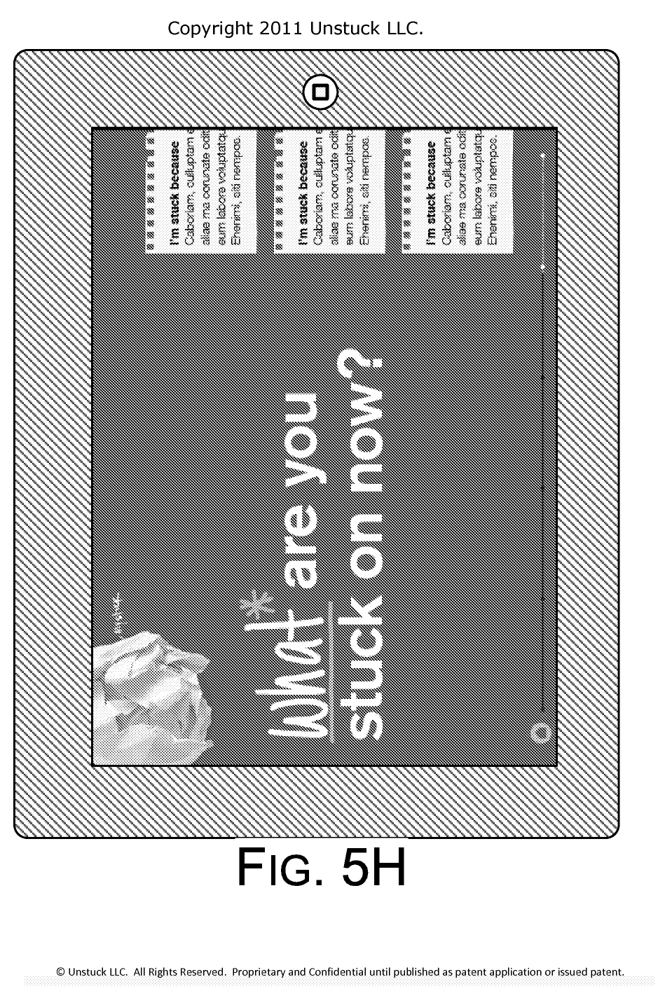

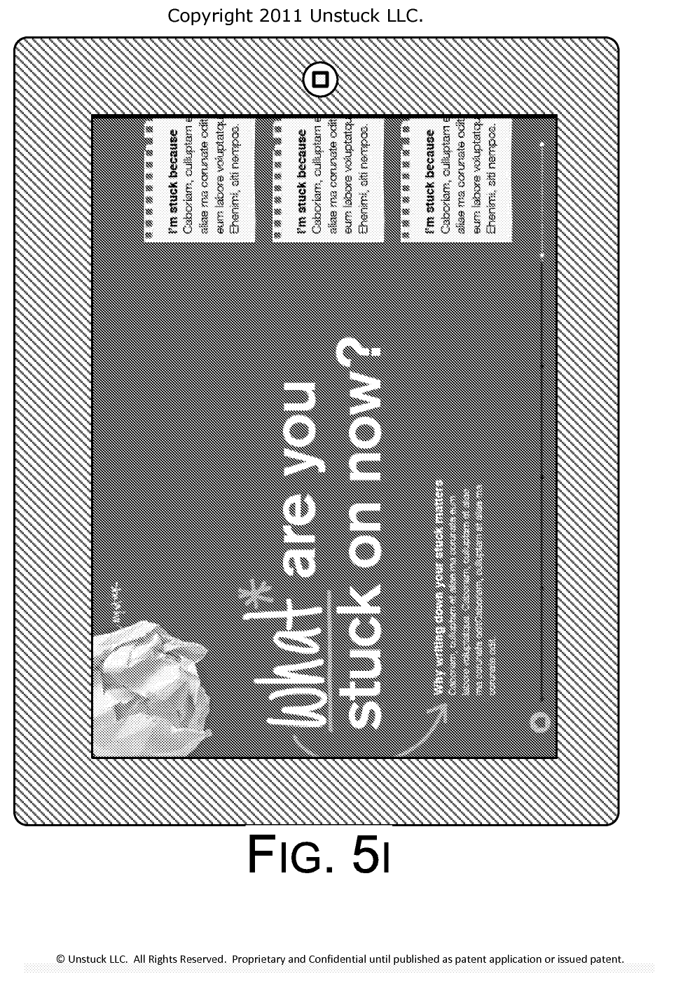

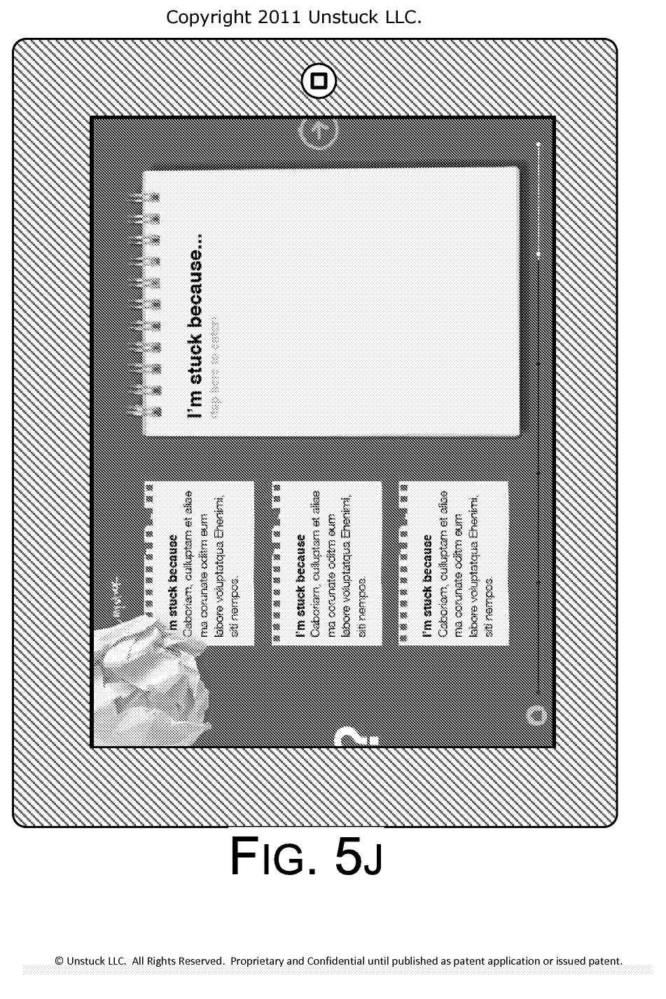

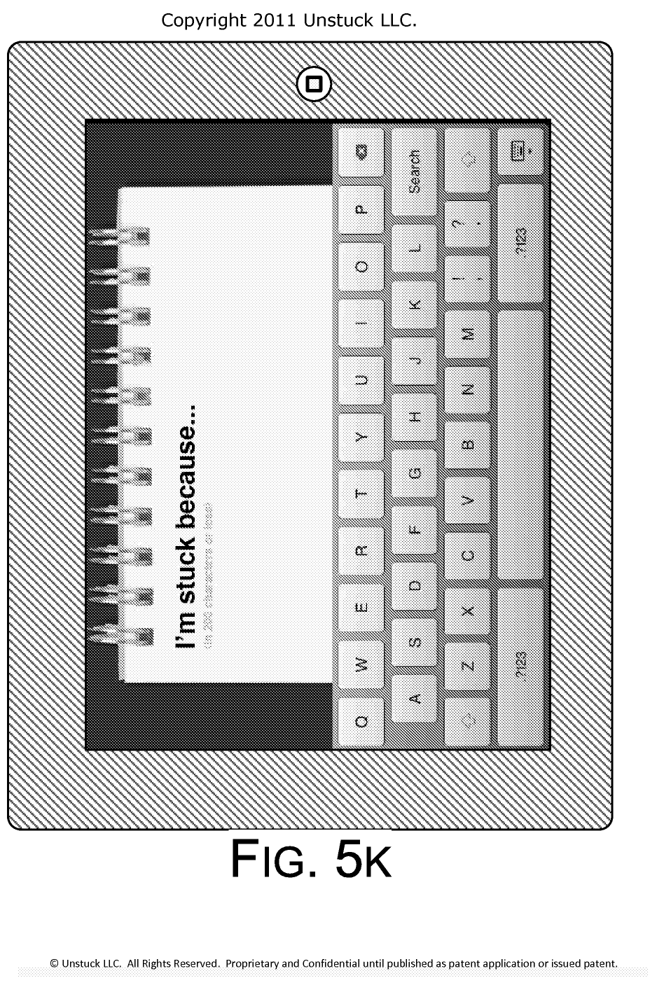

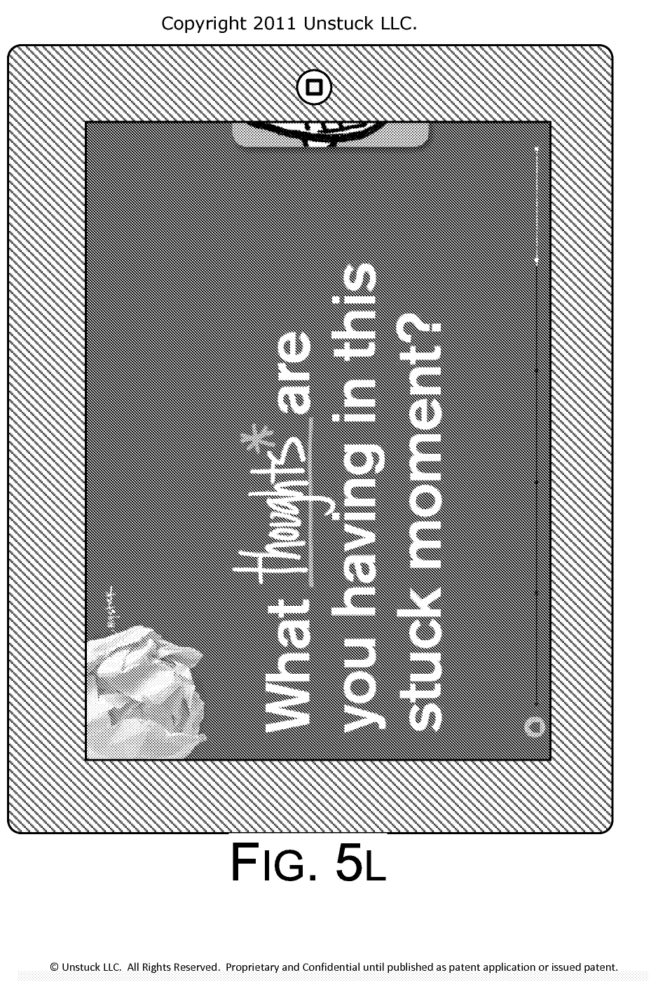

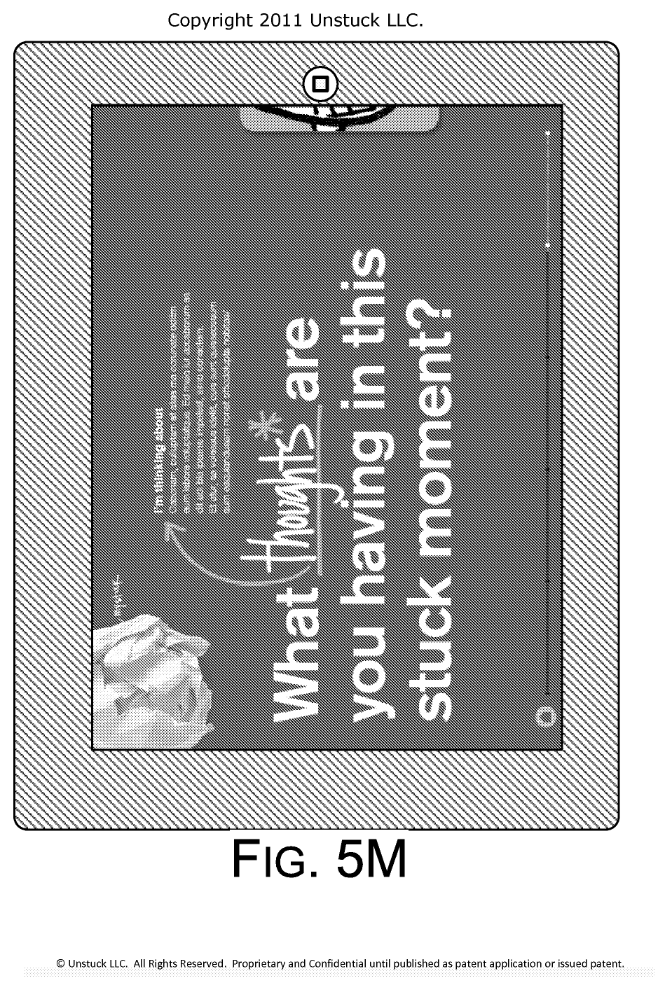

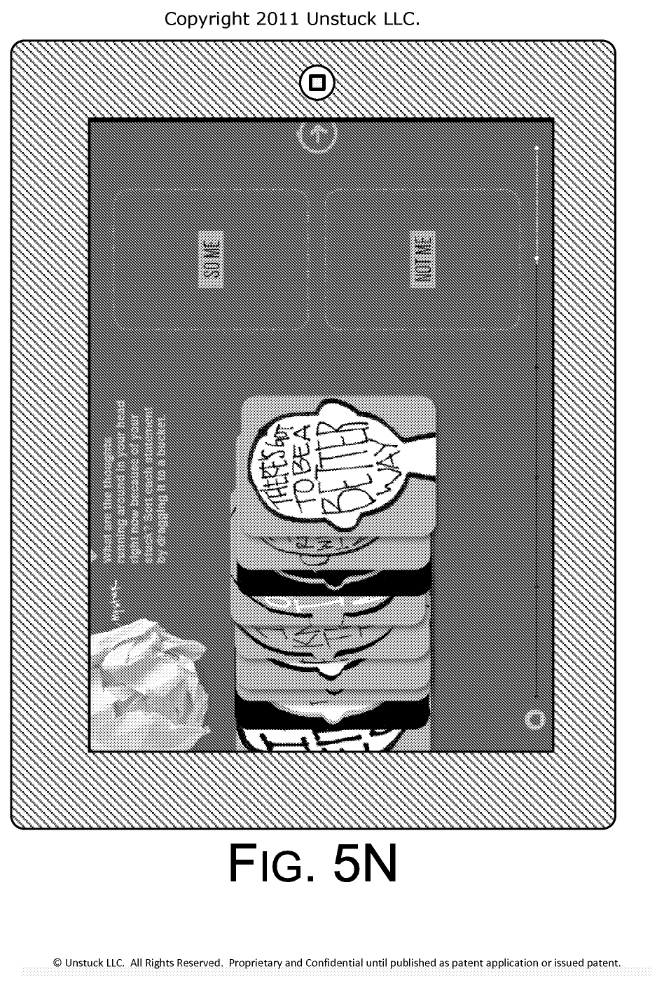

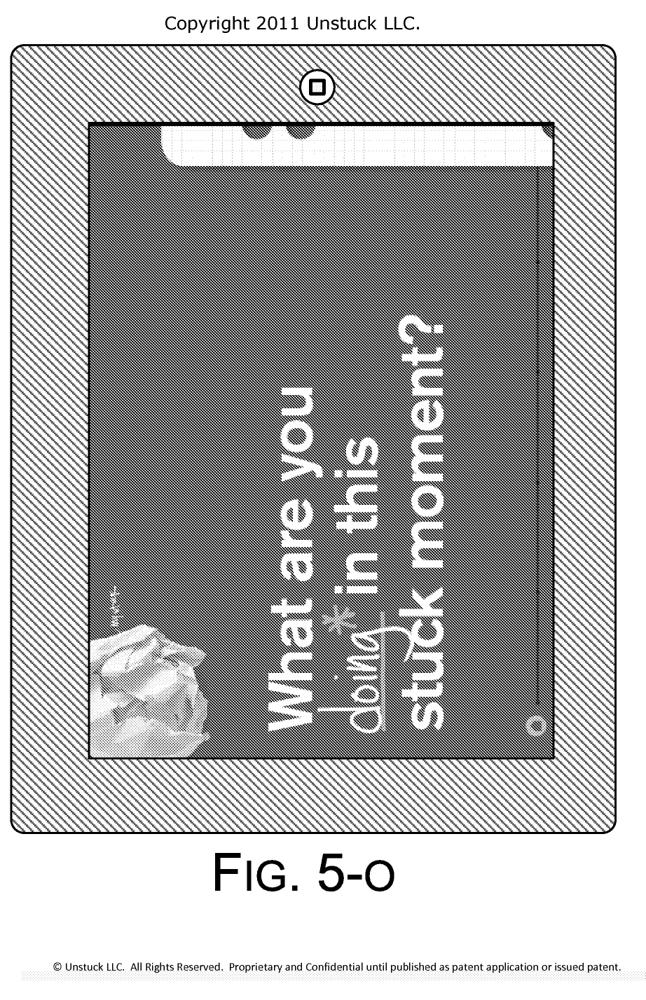

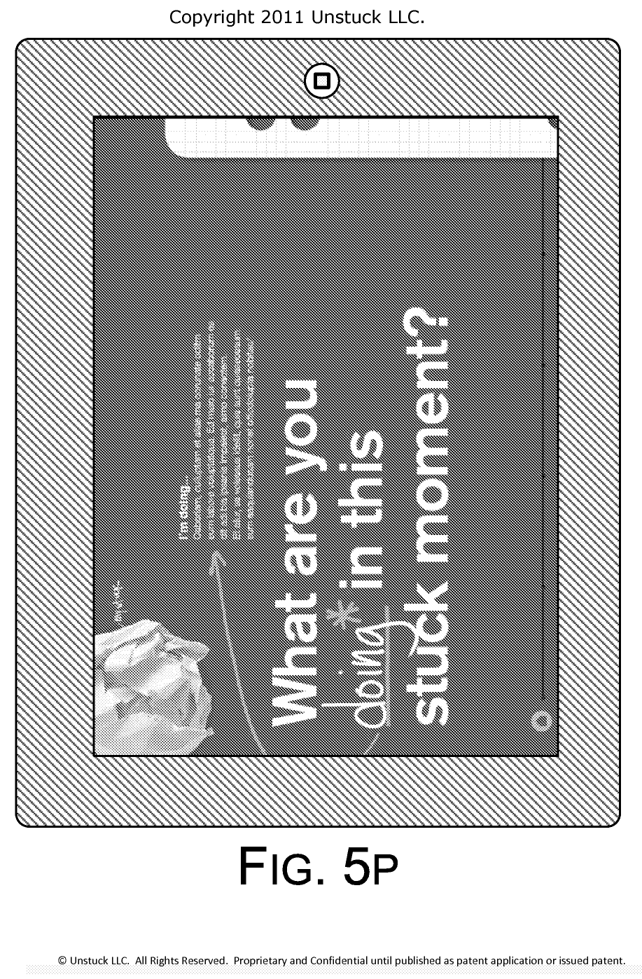

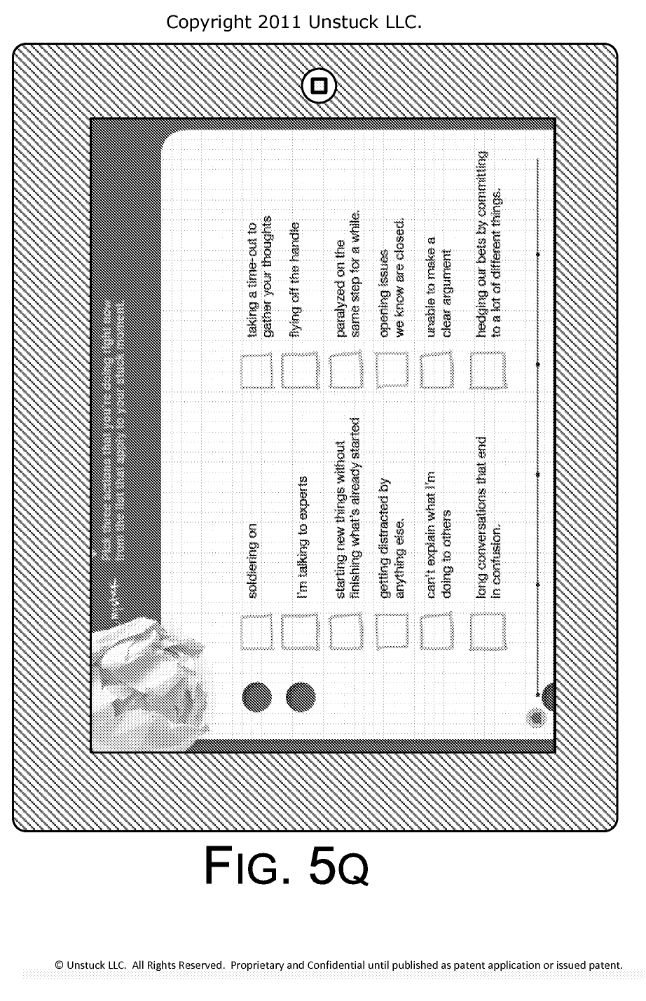

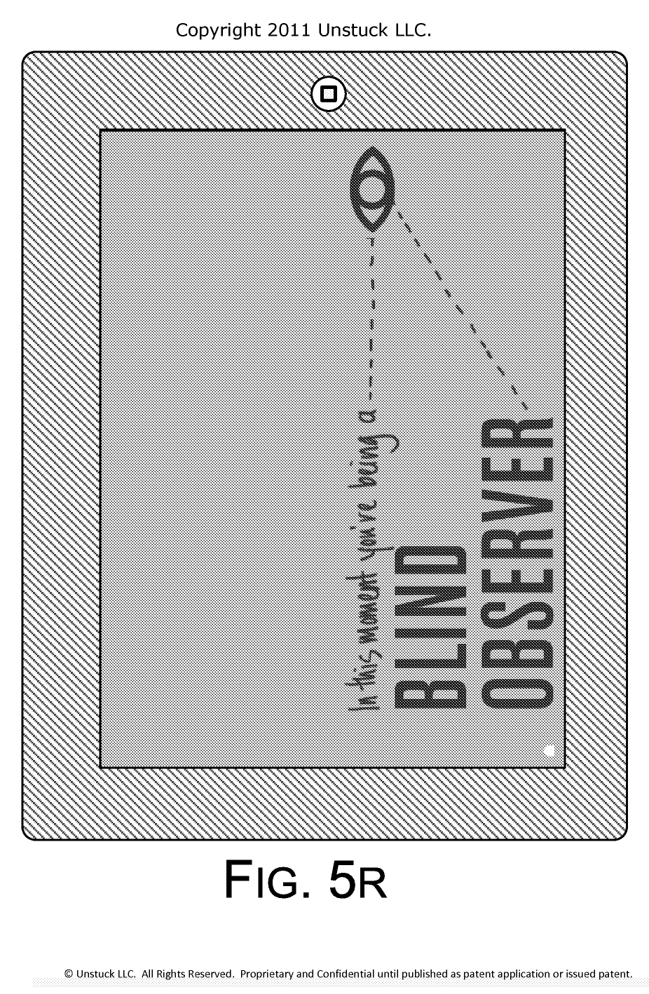

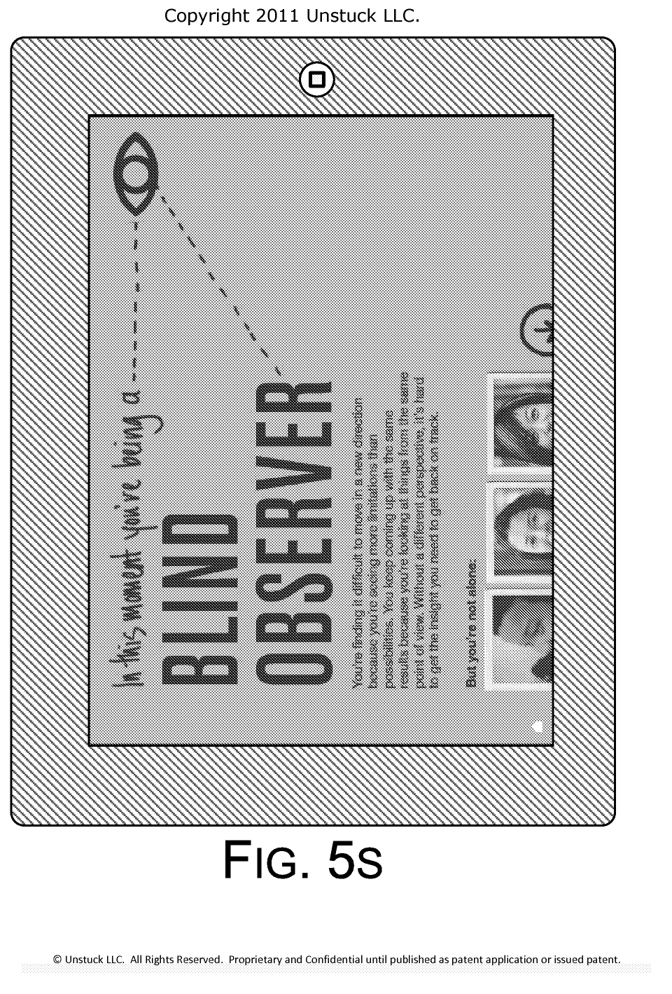

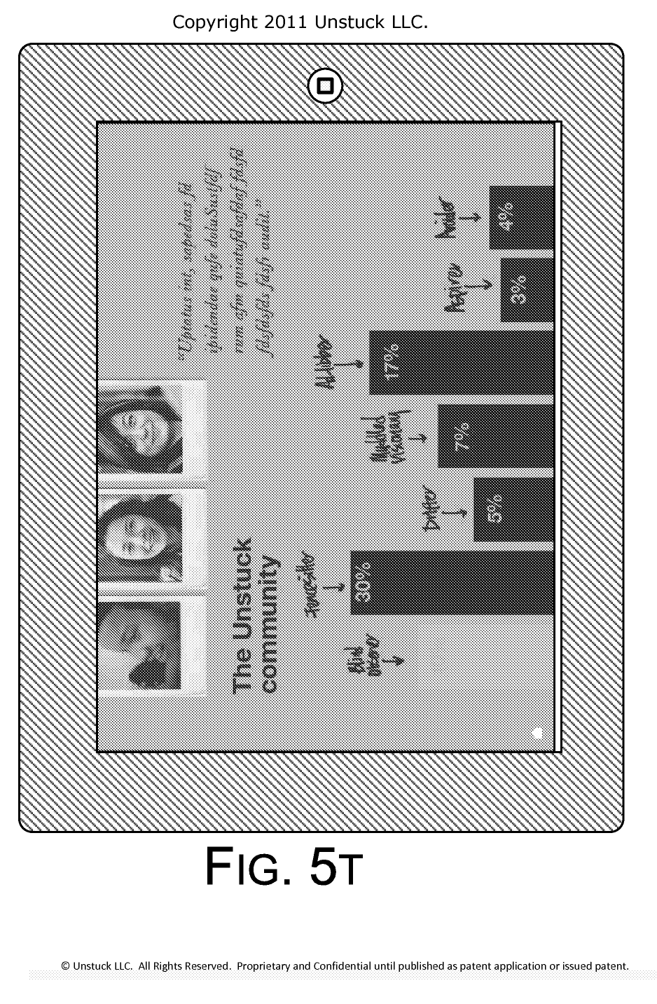

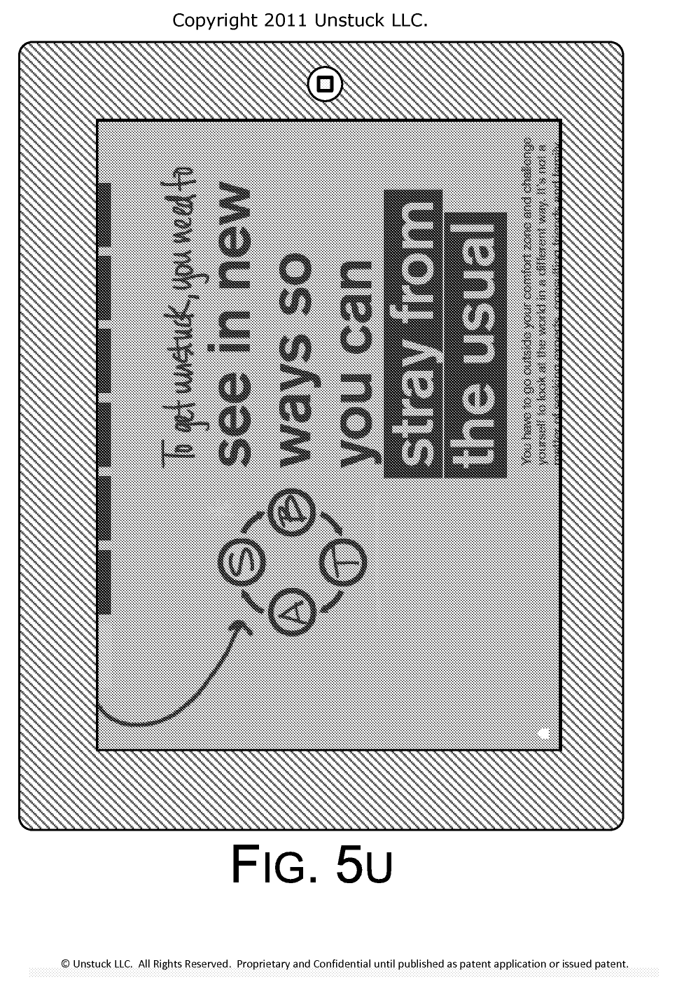

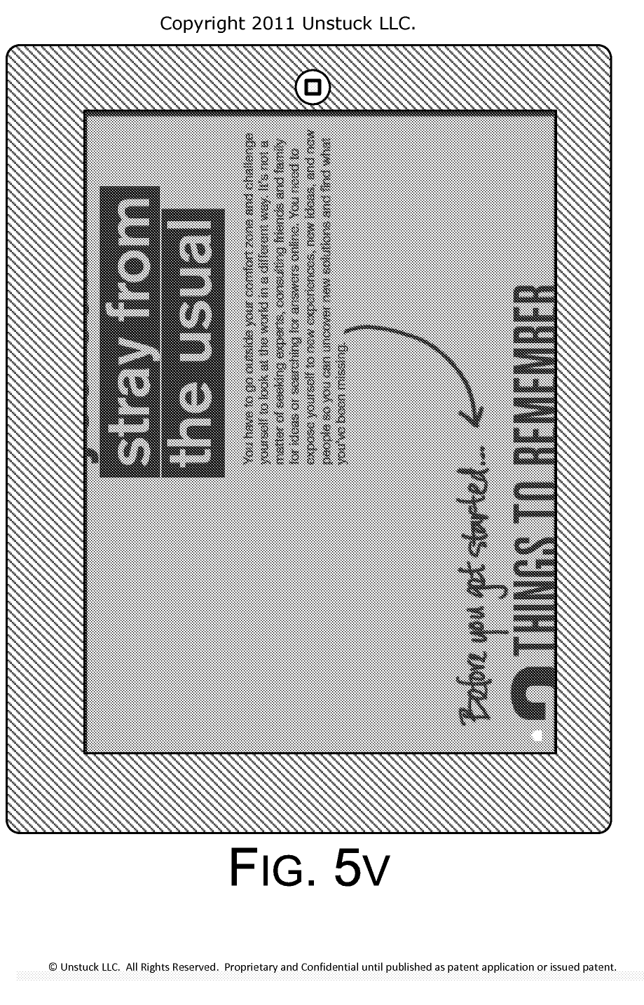

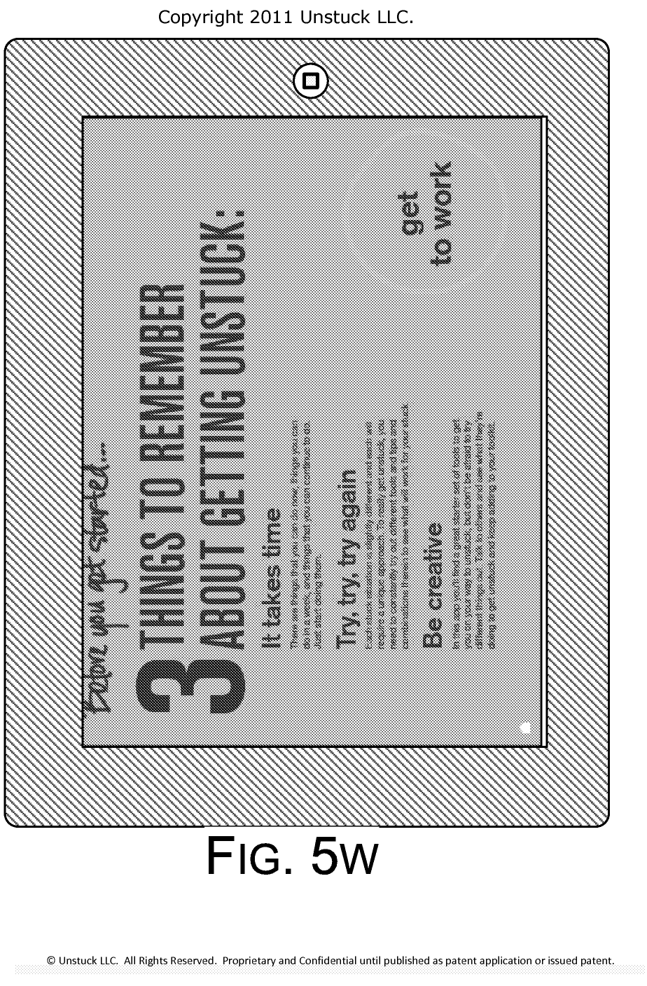

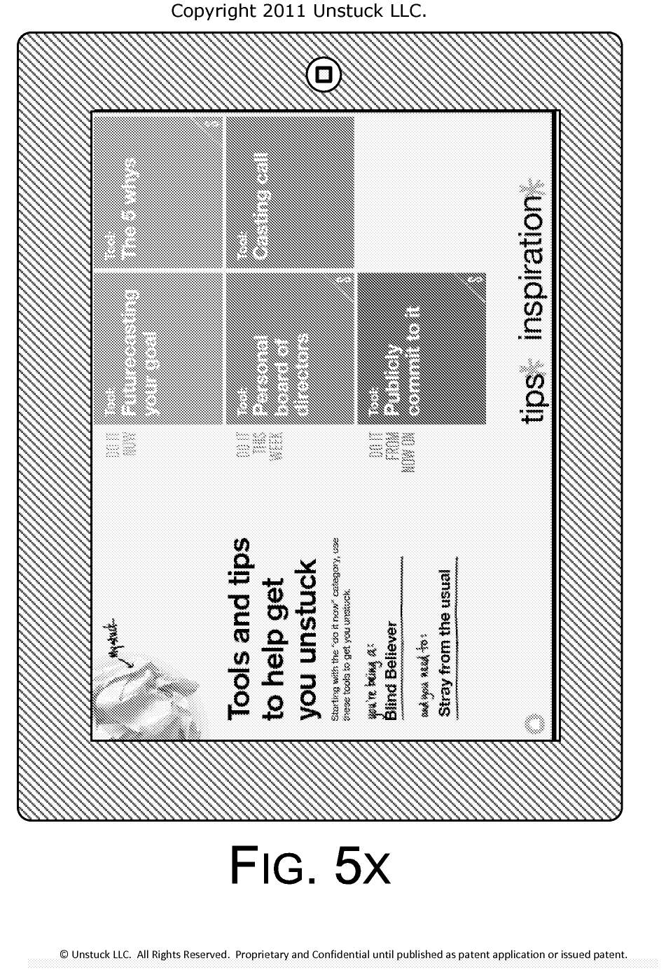

The process of getting a user unstuck (diagnosis and prescription) is now described with reference to the flow chart in FIG. 4. For this example it is assumed that the process being described is implemented as a software program (e.g., an application) running on a hand-held device such as an Apple iPad. Aspects of the description are made with reference to screen shots from that implementation (FIGS. 5A-5L). Those of skill in the art will realize and understand, upon reading this description, that any form of presentation and input may be used, including via a web interface, through a set-top box, via a PDA or telephone or the like.

The process described here is based on the exemplary data provided in this description. These tables will preferably be stored in a memory of the device on which the system is operating (e.g., in a memory of the iPad). While these tables have been shown here as separate tables, those of skill in the art will realize and understand, upon reading this description, that information in the tables may be combined in different data structures or tables, and that some of the information shown here may be derived from other information stored in the tables. The combination of the data in the tables, however stored, is also referred to as the database.

With reference to FIG. 4, first the user's feelings are determined (at 402). In a current implementation the user is asked how they are feeling in this stuck moment (FIGS. 5A-5B), and then asked to pick three feelings from the eighteen listed above. The feelings are presented on a screen of the device (FIG. 5C) in some manner which allows their selection by touch. While the user is allowed/required to select three feelings, it should be appreciated that the user may be allowed or required to select a different number of feelings.

Having selected a particular feeling, the user is then asked to rank that feeling. As shown in the example in FIG. 5D, the user is given a textual explanation of the selected feeling (“Uninspired” in the example), and is asked to rank that feeling on a sliding scale from 1 to 10. Recall that in the present implementation feelings are weighted from 1 to 5 across all 11 archetypes. Thus, when the user picks a feeling, she is asked to indicate on a sliding scale of less to more how intensely she is having that feeling. If she slides all the way to more, then the full number of points for that emotion is attributed to all of the archetypes to which it is weighted. If she slides it to less intense, only a portion of the weighting for that feeling is attributed.

A value (denoted insight Value) is calculated based on the three selected feelings and their selected weights, as rated by the user, as follows:

insightValue=feeling1 weight*(feeling 1 rating/10)+feeling2 weight*(feeling 2 rating/10)+feeling3 weight*(feeling 3 rating/10)

As the user selects feelings, they may be highlighted and/or numbered on the display screen (FIG. 5E).

Next the system determines who is involved in this “stuck” situation (the user alone or with one or more others), and whether it is a personal or professional situation (or both). Thus, the system determines the party or parties involved (FIG. 4 at 404). To obtain this information in a current implementation, the user is presented with a display screen such as shown in FIG. 5F, and is required to select from the various options. The user may be provided with additional information (e.g., as shown in FIG. 5G).

At this point the system knows the user's feelings (from step 402) and the party or parties involved (user alone or with others) and whether or not the stuck situation is personal and/or professional. This information can be used to set the various flags: “me” “me plus 1”, “me plus 2”, “personal”, and “professional”.

The system may ask the user what they are stuck on at this point. Although that information may be helpful to the user, in a preferred implementation it is not used to diagnose the stuck moment. The system may provide a free-form text entry to allow the user to describe their stuck moment and/or some of the entities involved. (FIGS. 5H-5K)

Next the system determines the user's thoughts (FIG. 4 at 406).

Recall that there is a set of thoughts that are weighted to each archetype. These are not weighted across archetypes like the feelings. They are each given a weighting of 10 points toward a specific archetype. The system picks twenty two (22) thoughts, two (2) thoughts at random (from the Thoughts table—Appendix A) from each of the 11 archetype categories, and the user is asked to sort those thoughts into one of two groups (as either applicable or not applicable to the user in the current stuck situation). As can be seen, the Thoughts table has a number of possible thoughts with a weighting of 10 for each archetype (e.g., as shown in the Thoughts table in Appendix A, there are 13 thoughts that correspond to archetype “Tunnel Visionary”), and so a user should preferably be given different “thoughts” to pick from each time they use the system.

As shown in FIGS. 5L-5N, in a current implementation, the user is asked what thoughts they are having in this stuck moment and are given a stack of twenty two cards, each listing a thought. The user then sorts the cards by moving each card to one of the two locations labeled “so me” and “not me”.

The user sorts through all 22 thoughts and puts them into either “so me” or “so not me”.

The thoughts that are put in the “so me” bucket all get 10 points attributed to their corresponding archetype. The thoughts that are put into the “so not me” category have zero points attributed to the corresponding archetype.

Next the system determines an archetype for the user in the current stuck situation (at 408). The system uses the points from the feelings and thoughts to determine which of the eleven (11) archetypes has the most points.

The insight value (insight Value) is adjusted to include values corresponding to the selected thoughts (sorted into the “so me” bucket). The insight value is also adjusted to include the values of the flags.

Next (at 410), the system determines what the user is doing about the current stuck situation. Based on the total of feelings and thoughts determined above, the user is served up with “doings” from all of the archetypes that fall within the corresponding overarching category (See, Believe, Think, Act). As shown in FIGS. 5o-5q, in a current implementation, the user is presented with a screen on the display of the device (e.g., iPad) and asked to select actions that the user is doing “right now” that apply to the user's stuck moment.

For example, if the user has the most points toward the archetype Adlibber after feelings and thoughts are totaled, then she falls into the overarching category of Think. So, she will be served up the doings that correspond to Adlibber, Fuzzy Forecaster, and Perplexed Planner because these are all archetypes in the Think category.

If after the feelings and thoughts are totaled, there is a tie between archetypes that fall within different overarching categories (e.g., Think and Believe), then the user is served up the doings for only the two archetypes that are tied (not the two whole overarching categories). For example, if the user has the same number of points for Adlibber and Waffler after the feelings and thoughts are totaled, she will be given the doings for just Adlibber and Waffler, not all of the doings for their overarching categories Think and Believe.

The user picks doings (preferably 3) from the list that is served up to her. Each doing is weighted at 10 points to a specific archetype (see Table V). The selected Doings points are added to the total points from the Feelings and Thoughts and the archetype that has the most points attributed to it is the diagnosis for that stuck moment that is served up to the user (at 412). For example, in a current implementation, as shown in FIGS. 5R-5X, the user is presented with a screen on the display of the device (e.g., iPad) in which the user's diagnosis for their current stuck moment is presented. In the example shown in the drawings, the diagnosis is “Blind Observer”. The screen showing the diagnosis is sometimes referred to as the “Esmeralda” card. In a present implementation the Esmeralda card includes more information than can fit on a single screen, and the card is scrolled vertically to show all of the information.

In some cases, when a person goes through the diagnostic, if they indicate that the stuck moment is me+l or me+others, they are presented with a set of relationship symptoms at the end of the diagnostic before the diagnostic summary. They are asked to choose one of the symptoms that applies to their situation. One of the options is “none of these apply”. As a result of this query, the system can set a symptom type “relationship”. In a present implementation there are nine (9) relationship types, including “none” (Leadership, Respect, Trust, Working style, Accountability, Alignment, Chemistry, Communications, None).

Table VII in Appendix A shows a list of example statements/questions and corresponding relationship types.

The user is served up one symptom from each of the relationship category types, and, based on which symptom they pick, they are put in that category (Leadership, Respect, Trust, Working style, Accountability, Alignment, Chemistry, Communications, None) and given tips for resolving that particular type of relationship issue.

Recall (from Table I), that each diagnostic archetype has a corresponding prescription as well as one or more corresponding tools. For example, the archetype “blind observer” (also referred to as “Tunnel Visionary”) has a prescription of “Stray from the usual” and a corresponding tool “Map it out.” Preferably (as shown in FIGS. 5R-5X), the user is presented with the prescription (something that they user needs to do to get unstuck) and information about the tool (something that the user can use to follow the prescription to get unstuck) (at 412-414).

As shown in FIG. 5W, the user is given some information about how to get unstuck and is provided with a link (the area around the text “get to work”) to begin running the preferred tool for that stuck moment. If the user selects “get to work” then the appropriate tool begins execution.

As noted earlier, there may be more than one tool that will help a particular user in any particular stuck moment. In a preferred implementation the user is provided with access (or limited access) to one appropriate tool, and is then given an option to acquire full access (if only limited access was provided) or to acquire other appropriate tools. The user may have to download and pay for those other tools or may be able to access them by acquiring a key to unlock them. In either case, payment can be handled in a manner known in the art. For example, when the system is implemented on an Apple iPad, the user may purchase the tools from the Apple Store in a well-known manner.

Computing

The operations and acts shown and described in FIG. 4 are implemented, at least in part, by the unstuck software, running on one or more computers or devices.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system (as noted above, FIG. 3 illustrates a typical computer).

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

The program(s) described herein, including the unstuck application and the tools will typically reside as programs in the memory/memories of one or more computers and/or, in part, on interaction devices.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

As used herein, the term “computer-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory 208, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements which are appropriate to perform the method.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

### Unstuck Tools

In the following sections, an archetype is given (e.g., “blind observer”) and then a prescription is listed. Based at least in part on the archetype/prescription (and what the user needs), one or more tools may be useful to the user.

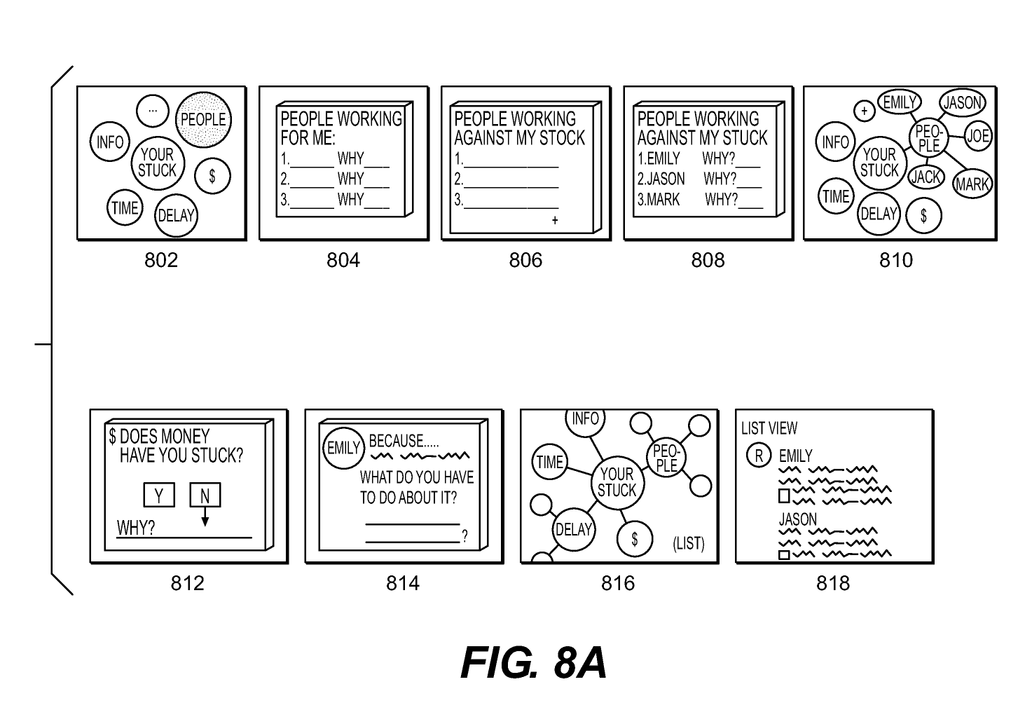

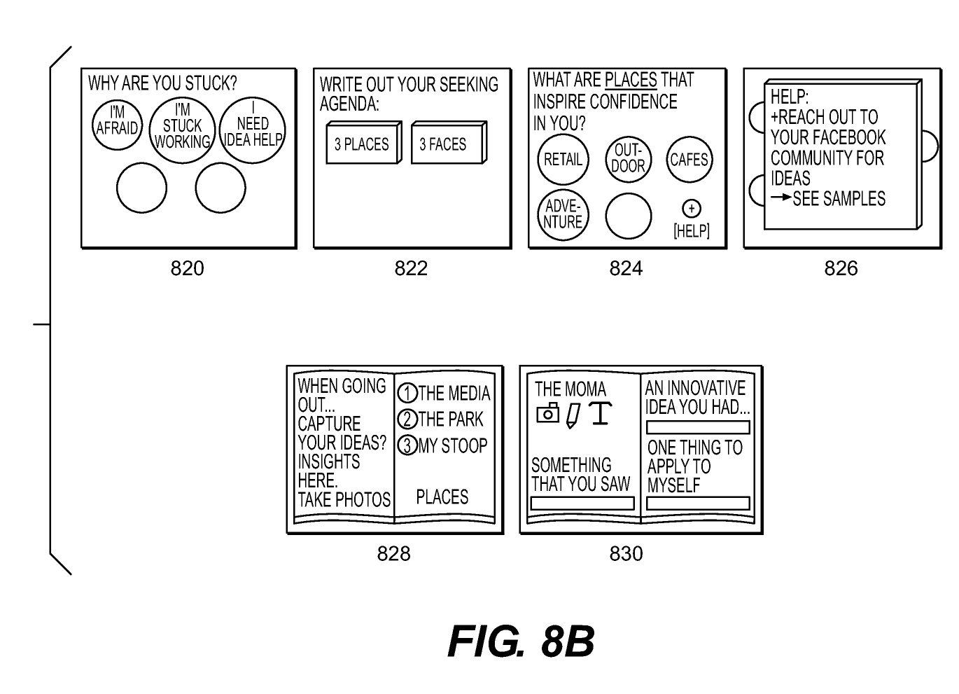

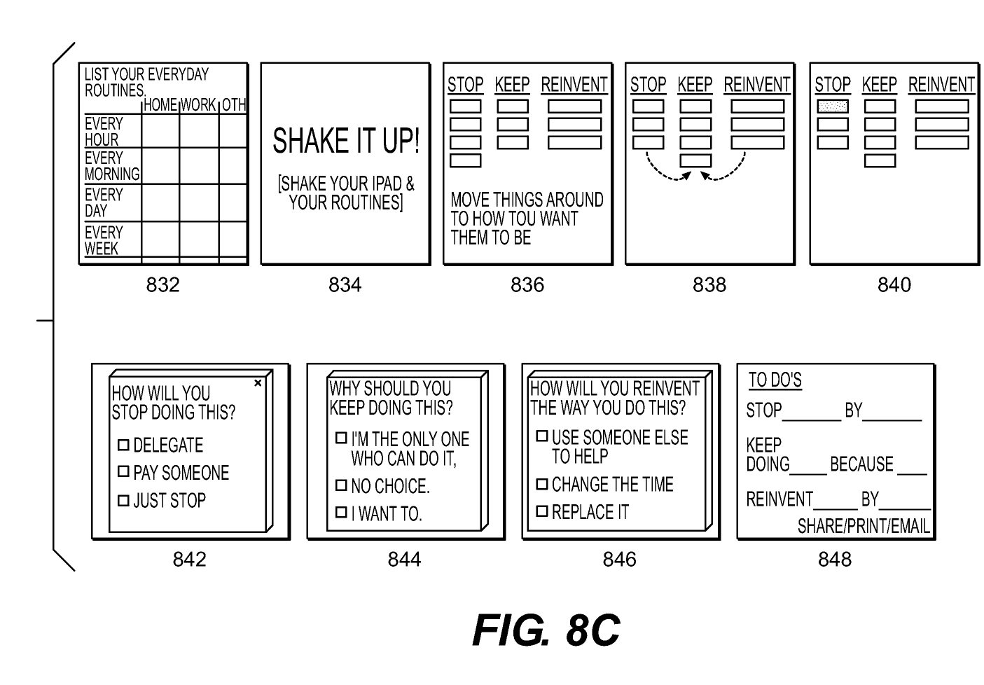

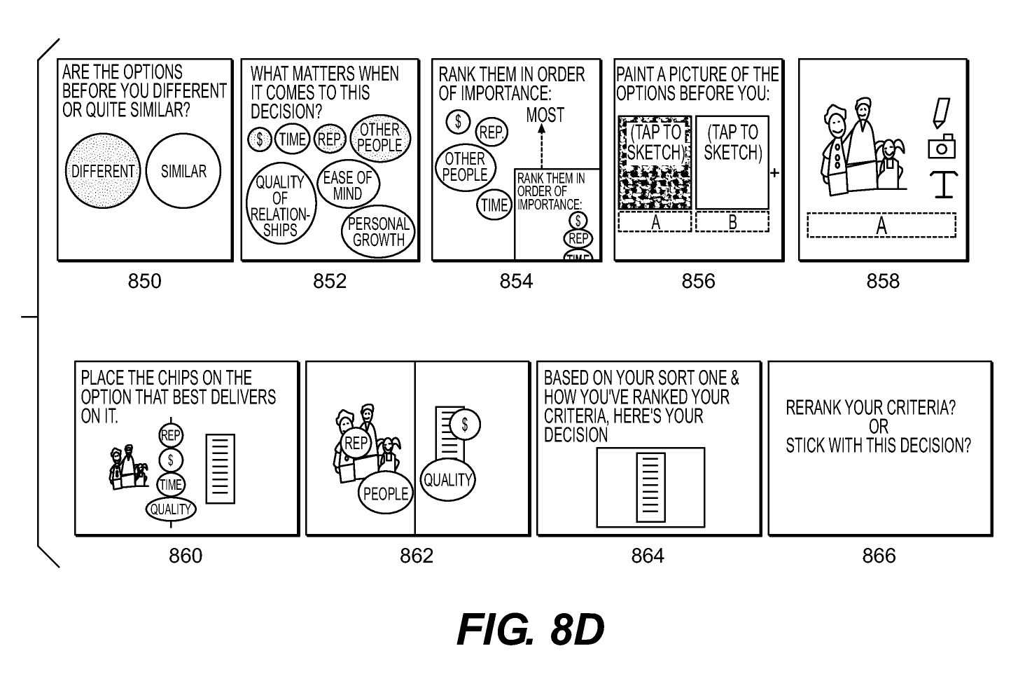

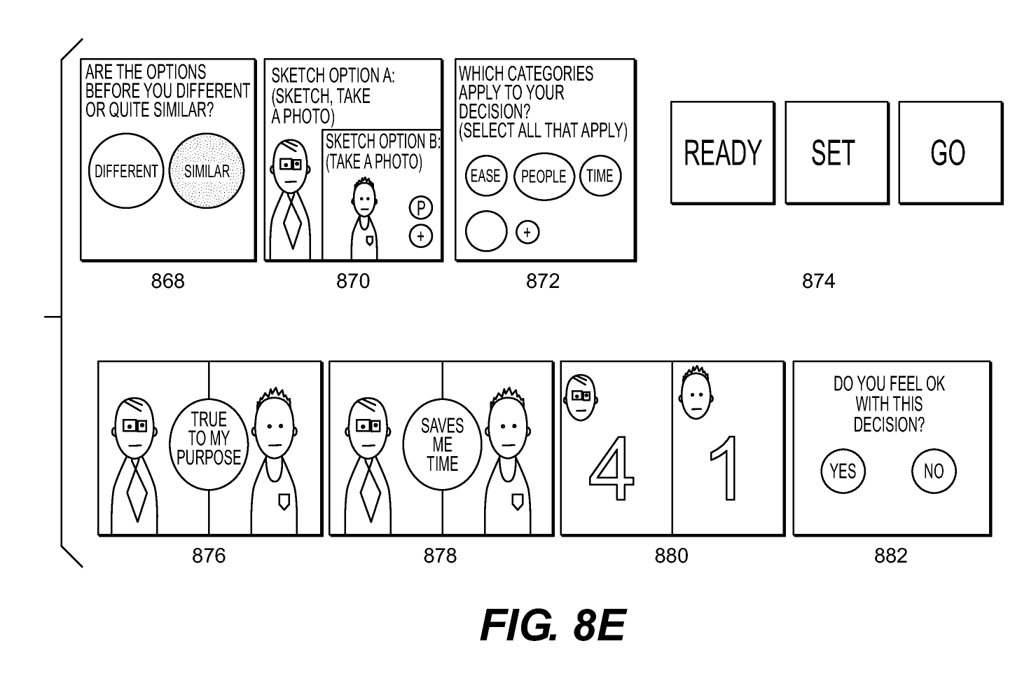

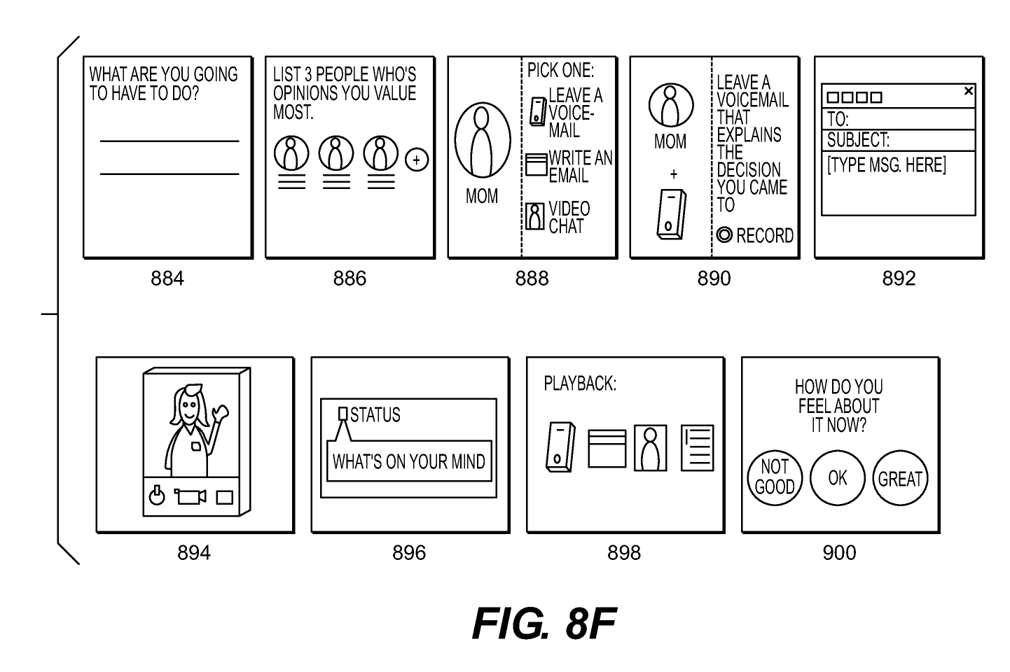

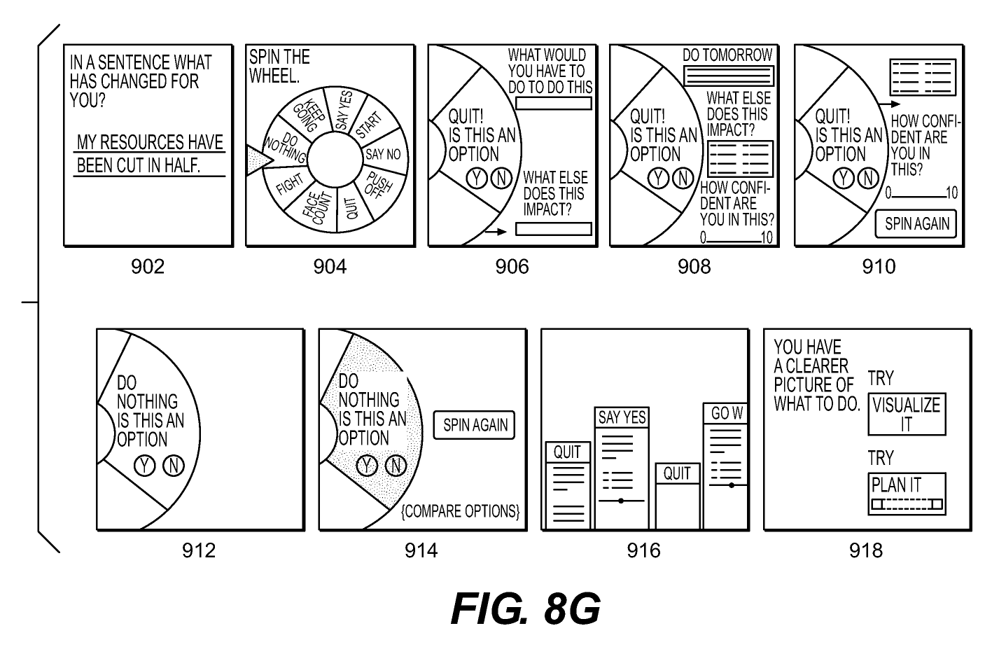

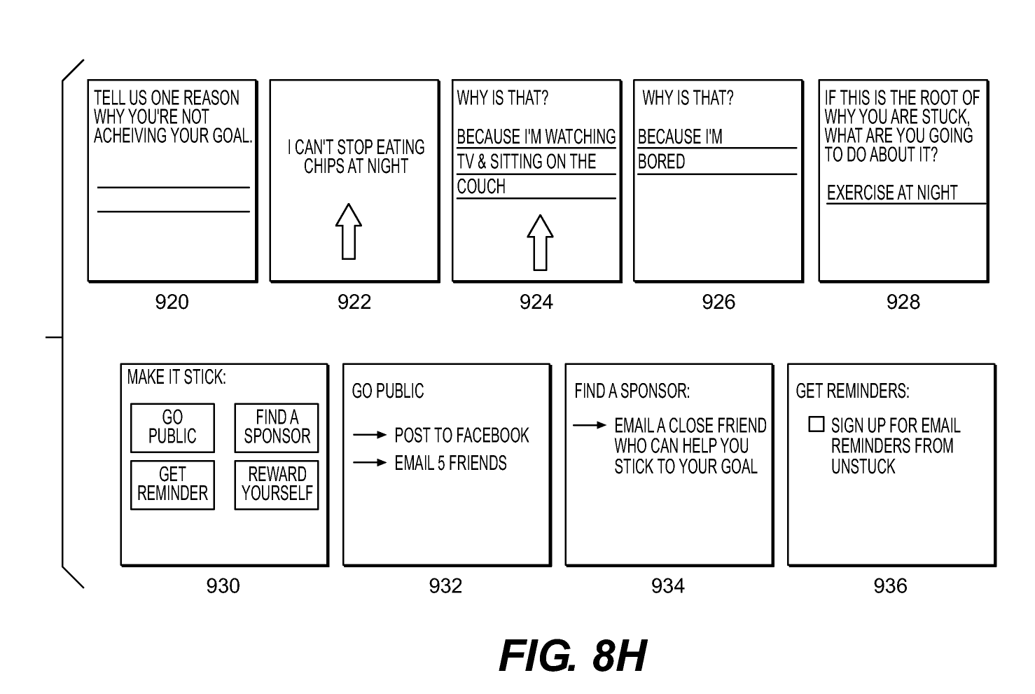

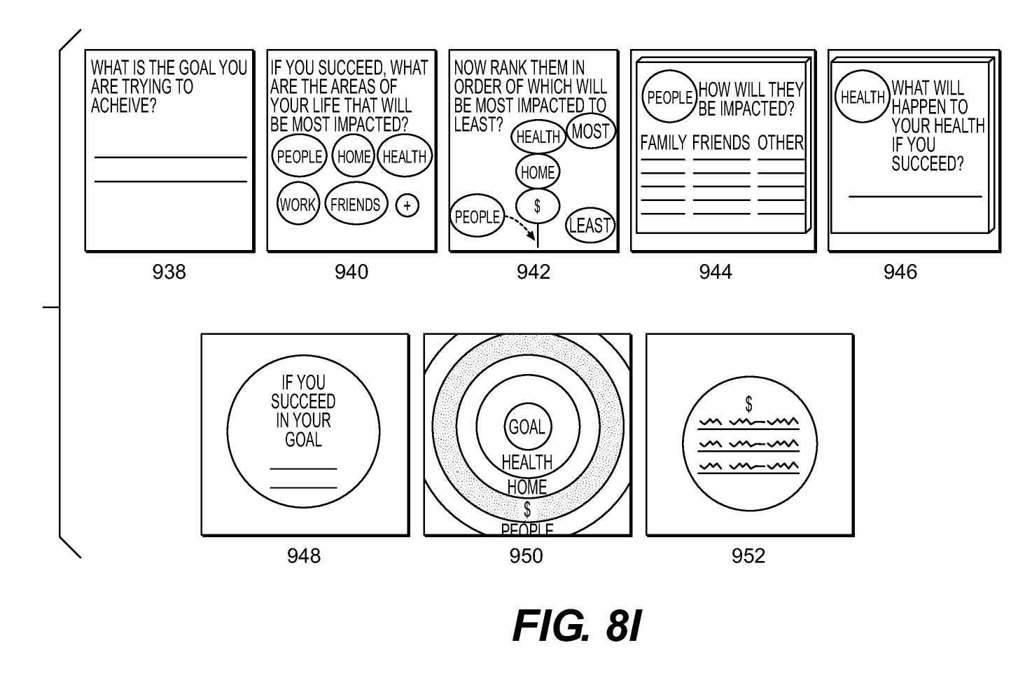

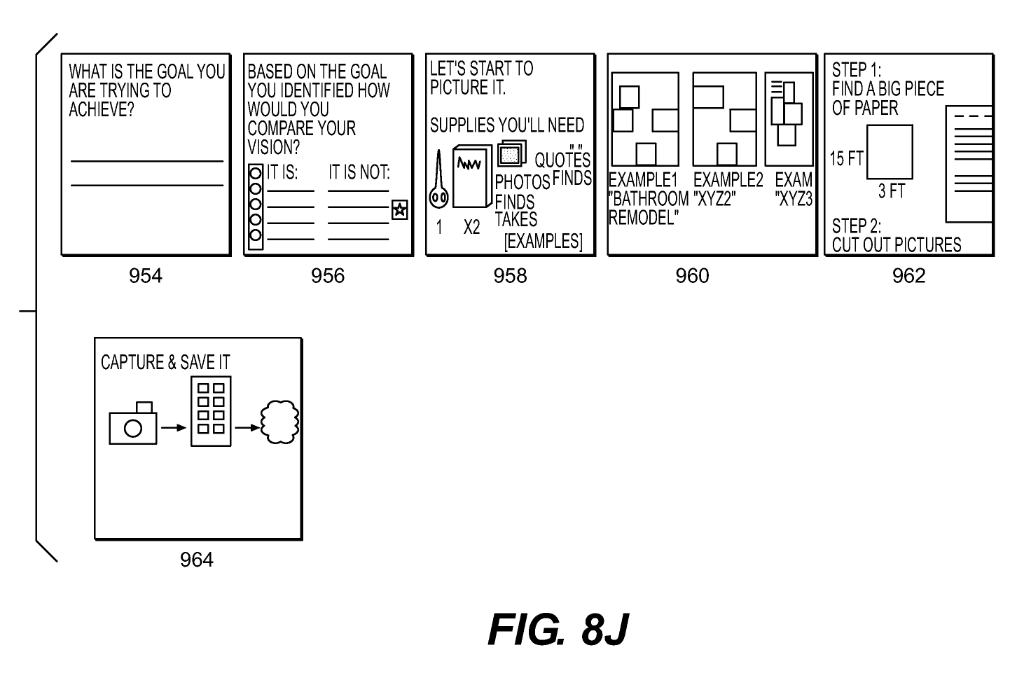

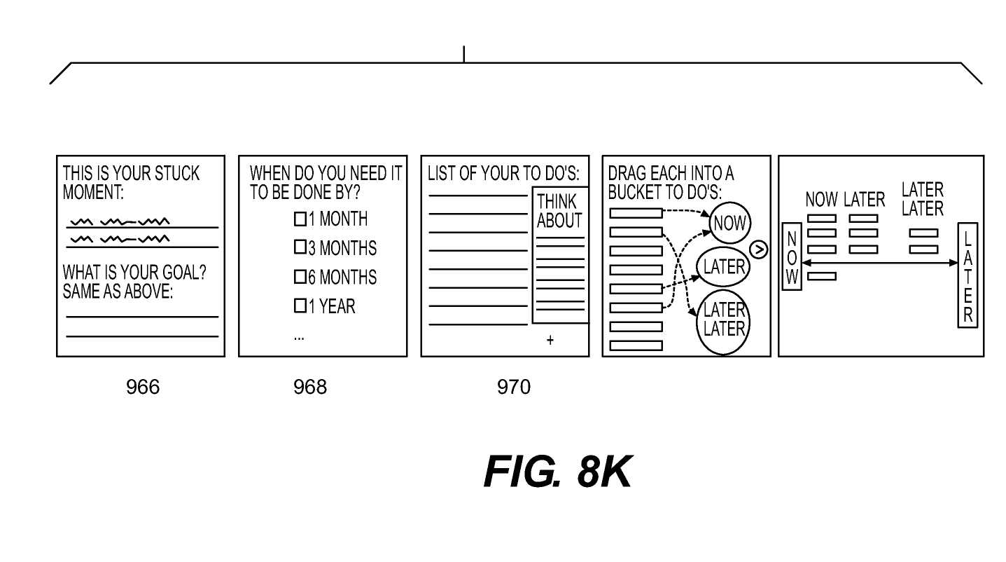

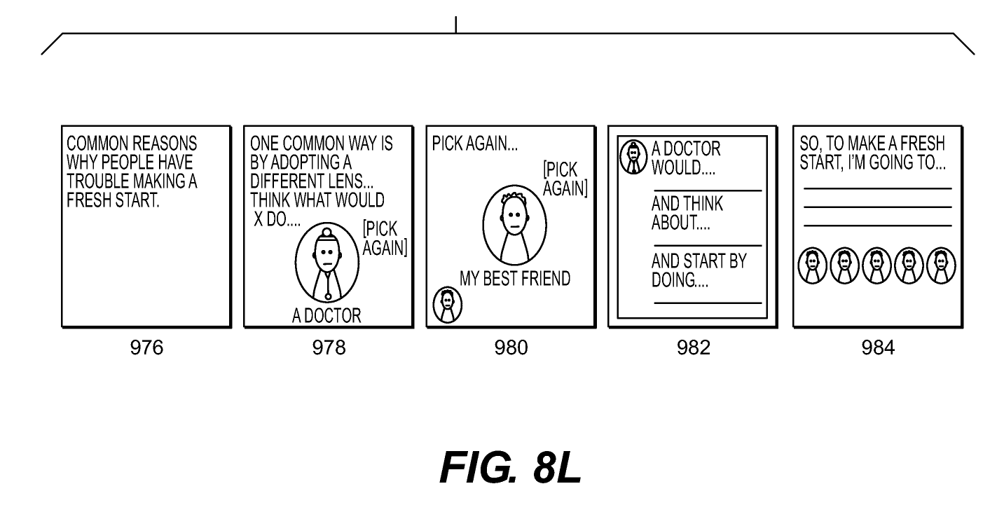

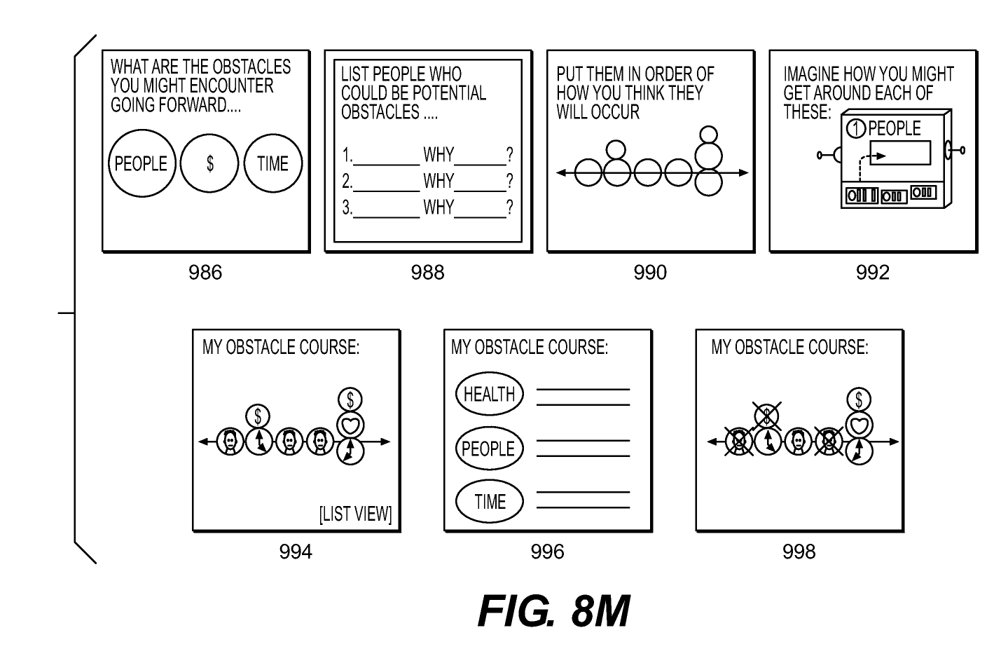

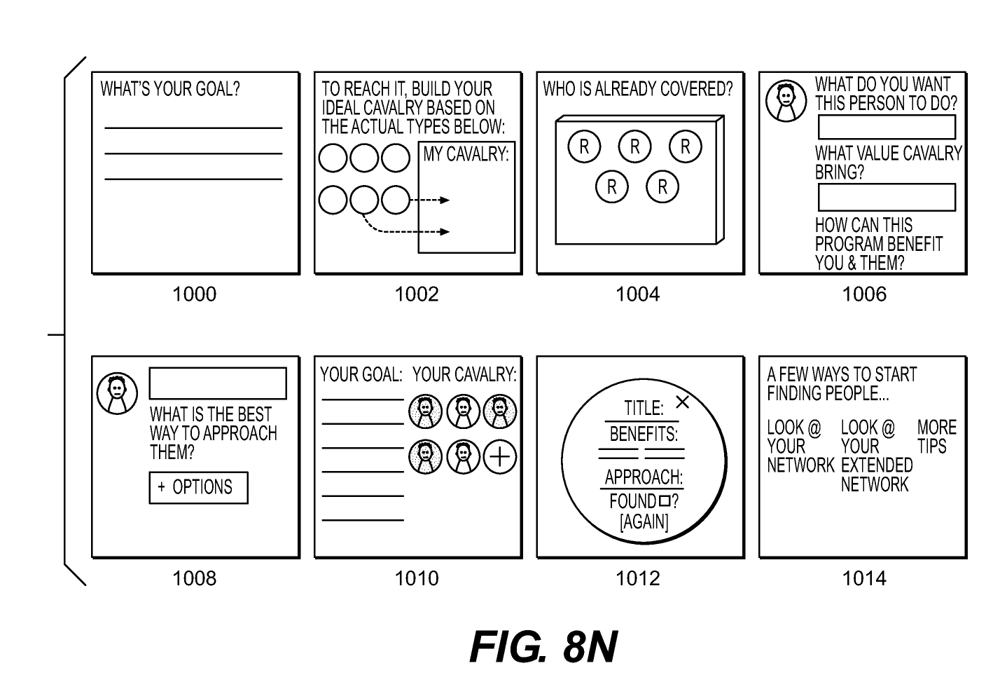

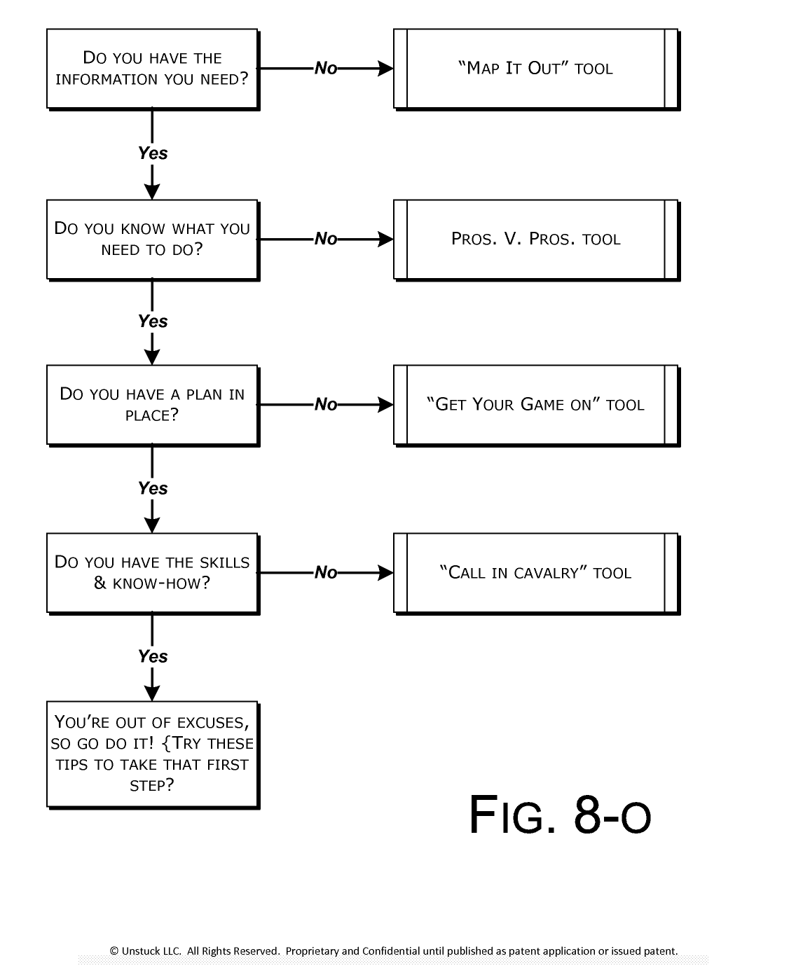

Various exemplary tools are described here with reference to the drawings in FIGS. 8A to 8-o. Those of skill in the art will realize and understand, upon reading this description, that the tools described are merely exemplary and that different and/or other tools may be used. In addition, it should be appreciated that the actual implementations of the example tools may differ from the examples given here.

The tools described here may run via a web interface or on a portable device (e.g., an iPad or the like).

| | |
|---|---|
| Archetype: | Blind Observer |
| Prescription: | Stray from the usual |
| User Needs: | New knowledge or information |

### Example Stucks (Stuck Situations):

How to work with my partners to redirect the focus of the firm.
I'd like to get a new side project going . . . however the scope of it is so big that I psyche myself out and don't commit to tackling it . . . and as time continues to pass, the fire that was once burning so bright, is slowly fading. it's mostly a lack of momentum. thinking of that hard push to get the ball rolling is putting me off from actually doing it.
I sit on the board of a company that is having success fundraising, but is experiencing more delays/declines than 1 would prefer. Trying to figure out how to get them on the right path to build a reliable network of donors. The team is working towards the goal, and we are refining the list. However, it is a small team, so each person needs to focus and prioritize. And, we are stuck on how to best prioritize and consistently push the ball forward on the fundraising front.

### Tool: Map it Out

Tool Goal: By focusing on your situation in a different way, you will see your stuck moment in a different way. And with your new perspective, you can begin to move forward.

With reference to FIG. 8A, the users stuck moment appears in the center bubble (at 802), surrounded by other bubbles that are prepopulated with categories that could be affecting the stuck, either for or against. The user can also write in categories. The user is also asked (at 804) to identify people who are working in their favor—to help get them unstuck. Probably should ask for positive influences, then negative influences. They tap a bubble (at 806) and are asked to answer questions pertaining to the category. The questions will vary according category. Once they identify people, they're asked why each person is getting in the way of their stuck. Tool will offer prepopulated suggestions, but user can type in their own reply (at 808). As user completes answers, a map begins to build, with the answers creating bubbles that are connected to and surround the pertinent category (810). They continue to make their way around the map. Filling out the exercises for each (812). The user is instructed to tap each of the new bubbles and prompted to answer how she will address this constraint or make use of the positive influence (814). The completed map can be viewed two ways, either as the bubble map (816) or as a list (818). In list view, the items under “what are you going to do about it” become the user's to-do list.

Sharables/Printables

User can share any or all of her to-dos. For example: “I want to start a new side project. Using the Unstuck iPad app, I've come up with to-do items that will help me reach my goal. Here is one of my to-dos (are my to-dos). What do you think? [Link to web site, e.g., Unstuck.com.'” User can email and/or print final list, which can be used as a to-do list.

### Call to Action at End of Tool

After running the tool the user is given a “call to action”, e.g., “Congratulations! You've mapped out your stuck moment and come up with ways to move past it. For further inspiration and motivation, try the Visualize tool.”

### Suggested Tool: Get Out

Tool Goal: By exposing yourself to different things and experiences, you'll be reinspired to see your stuck in a new way.

With reference to FIG. 8B, user is asked why they're stuck and what they need to get unstuck (820):
I'm afraid, so I need a push
I'm stuck in a rut and I need a spark
I'm uneasy and could use more information
I'm tired and could use a jolt

In the example in the drawing, she picks “afraid” and is asked to think of three places that inspire confidence in her, three faces, three things, and three experiences (at 822). These details will make up her “seeing” agenda.

Some categories may be prepopulated with examples to help them think of where to start (at 824). The user is encouraged to seek out the input of friends and family on social network sites such as Facebook and the like for ideas on places to visit that they may not have thought of (at 826). When done completing the net of places, faces, things, and experiences, a journal opens with instructions for how to use it while on their “Get Out” tour. The journal compiles their entries from the previous steps. (at 828) For each item on their list, they are asked to document the experience through photos, sketches, or typed descriptions (at 830). Questions accompany each section, e.g.,:
What was something new you saw?
One innovative idea that you had?
One thing you saw/experienced that you can apply to your stuck?

The “things I can apply to my stuck” could eventually be compiled into a to-do list. In some implementations, users are able to share sections of their journal and/or photos.

Sharables/Printables

User can upload a question to social network sites such as Facebook asking for ideas on places to go visit, things to do, etc. User can upload photos with statements to Facebook or the like or email them to friends. User can print their journal.

| | |
|---|---|
| Archetype: | Blind Observer |
| Prescription: | Get Restoked |
| Needs: | A change to become inspired to move forward |

### Example Stucks:

1. Hitting a wall with a project;
2. Started a small on-line gift company . . . now I am stuck filling orders—and realizing an on-line company holds no interest for me. Now what to do?
3. Wanting to find a boyfriend I love;
4. I'm trying to decide whether to stay in a relationship or not;
5. Improving sports performance where I feel I reached a plateau

### Suggested Tool: Shake Up Your Routine

Tool Goal: Find out if any parts of your routine are holding you back from being inspired.

With reference to FIG. 8C, at 832, ask user to create lists of items that are part of their routines through the day and week in no particular order. We will provide a framework for them, such as: Every Morning, Every Afternoon, Every Night, Every Day, Every Hour, At Work, At Home, In Transit, Every Week, Other. They should have at least some predetermined amount and no more than some other predetermined amount. User shakes the iPad or device (834). Items in the list are randomly ordered into three categories: Stop Doing This, Keep Doing This, Do This in a Different Way (at 836). The surprise order of the list items prompts the user to realize there may be a different may to do things. The user is prompted (e.g., using audio) to reorder the list the way they want it, not how it currently is (838, 840). For items in Stop Doing This list, user can indicate how she will stop it but toggling through a prepopulated list of suggestions (842). User can also write in how she will stop. For example, I will delegate, I will taper off, etc. For items in Keep Doing It list, the user, using same toggle device, indicates (at 844) reasons why she continues these items, such as I enjoy this, No one does it better, It won't get done otherwise, etc. For items in Do in a Different Way list, the user, using same toggle device, indicates how each item needs to be reinvented (at 846). For example (848), a to-do list is created once the user has rearranged her list. User can go back and change the list as needed in the future.

Sharables/Printables

Once toggle is done for each item on the list, user can share this decision socially. For example: “I want to get Unstuck, I'm no longer going to cook dinner every night. I've decided to taper off What do you think?” Link to web site, e.g., Unstuck.com. User can email and/or print final list, which can be used as a to-do list.

Call to Action at End of Tool:

After running the tool the user is given a “call to action”, e.g., “Your new routine should give you the room you need to get unstuck. Push to gallery of tools.”

| | |
|---|---|
| Archetype: | Waffler |
| Prescription: | Take a stand |
| Needs: | Discover what they believe in most. |

### Example Stucks:

1. Balancing work and home life;
2. Almost content with current self, but coming short of being completely satisfied Am I ready to deal with everything that comes with a decision?;
3. Should I pay for the house to be refinished or save the money?
4. Deciding if i want to have kids;
5. My wife and I are stuck trying to figure out our new married estate plan
Suggested Tool: Pros Vs. Pros

Tool Goal: You will discover what is more important to you. With this knowledge you are free to come up with a plan.

With reference to FIG. 8D, the user is asked if the problem they are dealing with is similar or different. If they answer different, they engage in the following exercise (850). If user selects “different,” (852) she is asked to create a list of criteria for making the decision that are important to her. She is supplied with choices that she can drag into her list. For example: Money, Time, Reputation, Family, Practicality, Environmental Impact, Authority, Friendship, etc. She can write in her own as well. Possibly stream choices that come from other users' answers. These criteria are ranked (854). Next she lists the two opposing issues (e.g., “Stay Home”, “Go to work”) (856, 858). She sketches/takes a photo/or types out a description of the choices and gives it a name (860). For each criterion, she selects one of the two issues as the big win. For instance, Home wins out over Work in the Family category. But Work wins out over Home in the Money category (862). Based on how she ranked the criteria, she is presented with the overall winning issue and the scores for each issue (864). Messaging will depend on the spread of scores (866). If the spread is small (1-3 point difference) user will be encouraged to either try it again and be more discerning or use another Waffler tool. If spread is medium (4-7), messaging indicates there is a winner, but asks user test out the decision with a few questions, such as How does this decision feel? (supply answer choices) Would you be proud to tell your closest friend about the decision? (supply answer choices) Do you think you might change your mind about this decision? (supply answer choices). If spread is large (8 and above) user is congratulated for coming up with an answer that frees them up to move forward, and is encouraged to move to a planning tool.

Sharables/Printables

The score is sharable on a social networking site such as Facebook. For example: “I'm trying to decide if I should stay at home or go back to work. Using the Unstuck iPad app, I scored 14 for stay at home, 12 for go back to work. What do you think?” Preferably people preview what will be shown on Facebook so it isn't a surprise. Final answers and statement are emailable and printable.

Call to Action at End of Tool:

Depends on outcome, as stated in flow.

Suggested Tool: Pros Vs. Pros

Tool Goal: You will discover what is more important to you. With this knowledge you are free to come up with a plan.

With reference to FIG. 8E, the user is asked if the problem they are dealing with is similar or different (868). If they answer similar, they engage in the following exercise:

They are asked to sketch/grab a photo/describe their options (870). They are then asked to select categories of criteria that apply to their stuck moment. To inspire them, provide examples and possibly stream answers from other users (872). What matters most to them when making this decision. They can also add categories if they want to. The following exercise is a gut check with a fast paced gaming quality to it. Its split decision time and we're here to force them off of the fence (874). The first category pops up with both of the options and they need to select which option delvers best on those criteria in a matter of seconds (876). A timer is used to make sure the user doesn't mull over the answer but goes from her gut. They continue to cycle through the criteria they've established choosing one option over the other along the way (878). The score is tallied (880). If the spread is small (e.g., 1-3 point difference) user will be encouraged to either try it again and be more discerning or use another Waffler tool. If spread is medium (e.g., 4-7), messaging indicates there is a winner, but asks user test out the decision with a few questions, such as How does this decision feel? (supply answer choices) Would you be proud to tell your closest friend about the decision? (supply answer choices) Do you think you might change your mind about this decision? (supply answer choices). If spread is large (e.g., 8 and above) user is congratulated for coming up with an answer that frees them up to move forward, and is encouraged to move to a planning tool.

Sharables/Printables

The score is sharable on Facebook or other social network sites. For example: “I'm trying to decide if I should stay at home or go back to work. Using the Unstuck Pad app, I scored 14 for stay at home, 12 for go back to work. What do you think?” (Preferably people preview what will be shown on Facebook so it isn't a surprise.) Final answers and statement are emailable and printable

Call to Action at End of Tool:

Depends on outcome, as stated in flow.

| | |
|---|---|
| Archetype: | Waffler |
| Prescription: | Gut check it |
| Needs: | Find out if you need to change your mind about your |
| | current path. |

### Example Stucks:

1. Taking a relationship to the next level;
2. Trying to figure out what I want to do with my job and what direction I want to go in terms of work/life balance and finding a career that resonates with me on a personal level;
3. Compensation structure has changed and the new structure is demotivating. Considering staying and building my own work arounds or taking a stand and risking being asked to leave.

### Suggested Tool: Newsbreaker

Tool Goal: You will test out a possible decision before you make it. Let your immediate reactions guide you in the right direction.

With reference to FIG. 8F, the user lists a potential decision (844). User comes up with a list of people, e.g., 3 or more people, whose opinions she values (866). The list is prepopulated with choices such as Mom, Best Friend, Co-Worker, etc. and user can write in her own. For each, she is encouraged to upload a photo. User selects first important person and picks a communication method, such as voicemail, email, video chat, Facebook status. Audio instructions guide user in how to craft messages (888). If she chooses voicemail, she records her message, telling the important person what she has decided to do (890). If she chooses email, she writes her message, telling the important person what she has decided to do (892). I she chooses video (must have appropriate device, e.g., iPad), she tapes her message, telling the important person what she has decided to do (894). If she chooses Facebook status, she types her status as replica of a Facebook page (896). She repeats the process for the rest of her important people. Next she plays back the messages and is prompted to answer the question: How do you feel about the decision now? She answers by selecting Not Good, Okay, Great! (898).

Calls to Action

After running the tool the user is given a “call to action”, e.g.,
Not Good: Doesn't sound like this is the choice for you. And that's good news! You've made headway in finding the right direction. Try the exercise again with a different decision and see how you feel.
Okay: Are you still feeling stuck? Your lukewarm response indicates that you are. Why not try this again with a different choice and see how you feel.
Great!: Congratulations! Your instincts are telling you that you've found the right choice for you. Now that you're unstuck, keep the momentum going by using the planning tool.

Sharables/Printables

The gut-check is shared on Facebook. For example: “I feel bad about my goal to [what user wrote]. I did a gut-check using the Unstuck iPad app, and I think I need a different goal. What do you think?” Communications and final message are emailable and printable, as appropriate

Call to action at end of tool: Depends on outcome, as stated in flow.

### Suggested Tool: Wheel O′ Stuck (or Wheel O′ Spin)

Tool Goal: You will discover if what has worked for you in the past still works of if you need to change your approach.

With reference to FIG. 8G, the user types out what has changed that is making her reconsider her belief (902). She is asked to spin the wheel (904). The wheel is populated with possible options, such as delay it, ignore it, quit, delegate, etc. Each time she lands on an option, she selects yes, this is an option, or no, this isn't an option. (906) If yes (908), she answers a series of questions. These questions can be answered by using a rating tool. For instance:
How much does this strengthen your current belief?
Would this require a lot of work or change on your part?
How many people in your life does this affect?
How confident are you that you would do this?

After answering the questions, she can opt to spin again (910). If the spinner lands on an action that is not an option, the option grays out (912). She can then spin again and the next spin will skip over the previous option (914). User must select at least two options, but is not required to complete the entire wheel. Once two options are selected, the chart, shown in next board (916), starts to build. She taps the “tally” button and she sees a graphical display of all her options, the tallest ones being those she rated most confidence in, the shortest with the least confidence. Now the user has a clearer picture of where she feels most comfortable moving ahead. If this path feels right for her, try the planner tool to move ahead. If still waffling, try picturing the goal with the Visionary tool (918).

Sharables/Printables

The score is sharable, e.g., on Facebook or some other social networking site. For example: “I'm trying to decide if I should stay at home or go back to work. Using the Unstuck iPad app, I scored 14 for stay at home, 12 for go back to work. What do you think?” Final answers and statement are emailable and printable.

Call to action at end of tool: see last board.

| | |
|---|---|
| Archetype: | Drifter |
| Prescription: | Commit |
| Needs: | Commit to the direction/goal they've chosen. |

### Example Stucks:

1. What type of writing do I want to do next? Journalism? Another book? Alone or as a ghostwriter? With what type of individual? About what subject? To what end?;
2. Wondering what to do career wise. Couple different things going on including starting my own business;

### Suggested Tool: the 5 Whys

Tool Goal: You will get to the root of why you're having trouble achieving your goal.

With reference to FIG. 8H, the user is asked for one reason why she's having trouble sticking to her goal. The reason is displayed large on her device (e.g., iPad). Then the tool asks the user a series of “why is that?” questions (924). After a series of questions the tool asks the user what they're going to do to solve their root problem (928). Audio overlay explains that there are proven methods for getting a commitment to stick (e.g., you can go public, find a sponsor, get reminders, or reward yourself) (930). If she selects “go public” she can either post her new commitment to a social network (e.g., Facebook) or email some friends (e.g., 5 friends) about it (932). If she selects “find a sponsor” they are asked to email a close friend and ask them to be her sponsor (934). The user can also sign up for reminders from a web based system (936).

### Suggested Tool: Picture Success

Tool Goal/You will discover how you feel about making a change by putting things in perspective. This perspective will be your compass for getting unstuck.

User is asked to write out her goal (938). User is asked to select which areas of her life will be affected if the goal is achieved (940). This is prepopulated with categories, such as People, Health, Home, Work, etc. User can write in additional ones. User selects her categories (942) and puts them in order of how much each will be affected. For each category, one at a time, user writes the answer to the question (944, 946): How will this be affected? App provides general guidance for this, either an audio instruction or a pop-up of sample answers. Then user ranks the importance of this impact to her, using a sliding scale. The screen starts to build out an infographic (948, 950) to show the reach of the impact that their success can have. Screen displays concentric circles. Goal is the middle circle. The circle around the goal is the category ordered most affected by the user in Board 3, and so on. This shows a ripple effect. The importance rankings from Board 4 are indicated by the thickness or thinness of the bands. By tapping on any of the circles, the circle turns to display the subcategory content (952).

Call to Action at End of Tool:

After running the tool the user is given a “call to action”, e.g., audio, celebratory voice on chart screen: “Look how much impact this goal has on your life. Like what you see? Start making a plan with the planning tool.”

Sharables/Printables

The chart is sharable on Facebook. For example: “My goal is to [whatever goal user wrote]. Using the Unstuck iPad app, I discovered fresh perspective by charting how it would affect different areas of my life. What do you think?” Final answers and statement are emailable and printable (e.g., as refrigerator art). In some cases the chart can be made into the backdrop on the user's device (e.g. iPad).

| | |
|---|---|
| Archetype: | Muddled Visionary |
| Prescription: | Envision it |
| Needs: | Needs to envision the goal in order to act on it. |

### Example Stucks:

I'm trying to figure out how to stabilize my business in America so I can move with my wife to take advantage of an exciting opportunity in China;
Trying to convince a middle schooler to eat healthier and exercise more;
My wife and I see differently on what to do with our outdoor space;
Can't decide what colors to paint the living room and dining room;
I don't seem to figure out how to place my frames/paintings/posters in my home walls. This has always been a problem for me; therefore most of my walls are always bare. All in storage waiting to be framed or hang. I don't seem to be able to commit on such a small thing.

### Tool/Visualize it

Tool Goal: By examining your goal from different angles you will see it in a fresh, clear way. Clarity will get you unstuck!

With reference to FIG. 8J, the user lists her goal (954). User is asked to characterize her goal by what it is and what it isn't, using words, not sentences (956). Examples are provided in a pop-up. This gets her thinking about her goal. User is prompted to begin gathering a few supplies to start her own collage off-line (958). She doesn't have to attain all of the supplies, just some to get her started. Examples of other people's collages may be shown (at 960). Step-by-step instructions for how to create her own collage (962) are provided. Instructions to capture and save her collage with her stuck moment and refer to it often to stay true to her vision (964).

Sharables/Printables

The collage is sharable on social network networks such as, e.g., Facebook. For example: “My goal is to [whatever the goal they wrote]. I was inspired to clarify it, using the Unstuck iPad app, so I created this collage. What do you think?” Collage is emailable and printable (e.g., as refrigerator art).

| | |
|---|---|
| Archetype: | Adlibber |
| Prescription: | Make a plan |
| Needs: | A plan |

### Example Stucks:

This boy likes me and I want him to talk to me about it before I talk to him about it. I know what I want to say I just want him to approach me. I keep running in circles because I want to talk to him but I want him to say something first;
Not making it to the gym and yoga classes as much as I would like;
getting the group at church to work on a project together;
Finding time to see my friends outside of work

### Tool/Get Your Game on

Tool Goal/You will discover the joy of organization. An organized plan frees you up to act on your goal.

With reference to FIG. 8K, the user lists her goal and how long from now she would like it completed (966). She indicates this with prepopulated choices, such as 1 month, 5-6 months, 9 months, 12-15 months, 2 years (968). She lists out all the to-dos to achieve goal (970). They aren't necessarily in any particular order. She drags her to-dos into time buckets, such as Now, Later, Much Later (972). A timeline is created (974) for the user who has trouble making a plan. This is a starting point. She can move items around.

Call to action at end of tool: “You have a plan! And now you're ready to move past your Unstuck moment. Remember, you can always revise your plan using this tool, should things change.”

Sharables/Printables

The To Do list is sharable on social network sites, e.g., Facebook. For example: “My goal is to [whatever goal user wrote]. Using the Unstuck iPad app, I came up with a plan to make it happen. Check it out and let me know what you think.” To Do list is emailable and printable (e.g., as refrigerator art).

| | |
|---|---|
| Archetype: | Adlibber |
| Prescription: | Make a fresh start |
| Needs: | A new plan |

### Tool/Super Fresh Start

Tool goal: By seeing your stuck moment through the eyes of someone else, you'll gain fresh perspective and fresh ideas to move ahead.

With reference to FIG. 8L, at 976 voiceover explains the point of the tool, which is to look at the user's situation through a different point of view, based on types, such as doctor, scientist, artist, etc. User is encouraged to select at least 3 types for this exercise. User selects (at 978) the types she wants to explore. With each choice, there is a short blurb (one sentence) that explains the type. For instance, Doctor: Doctors often use deductive reasoning—eliminating probabilities as a way to find the root cause. They redo the exercise (at 980) as many times as they want with the archetypes collecting at the bottom of the screen. Once all the types are selected (982), user taps on one of her types and is presented with a mad-lib-style questionnaire that helps them approach the situation from the type's point of view. Once all the mad libs are complete, user is asked to consider these different points of view and write how they will approach a super fresh start (984).

Sharables/Printables

User can share any of the type perspectives she creates and/or the super fresh statement she writes at the end. For example: “Finding time outside of work has me stuck. Using the Unstuck iPad app, I looked at this from the perspective of a doctor, artist, and banker, and I've come up with this super fresh start: [whatever goal user wrote]. What do you think? [link to Unstuck.com]” User can email and/or print final list, which can be used as a to-do list.

Call to Action at End of Tool

After running the tool the user is given a “call to action”, e.g., “If you like your idea for a super fresh start, keep the momentum going by using the planning tool. If it doesn't seem right, try again using other people's perspective or try the Obstacle Course tool.”

### Tool/Obstacle Course

Tool goal: By identifying what is keeping you stuck, you can begin to find ways to remove those obstacles and move forward.

With reference to FIG. 8N, the user is presented with categories that may be obstacles for getting unstuck. These are prepopulated. Some implementations may allow user to add her own obstacles to the list. User selects a category and answers what specifically is the obstacle and why. She does this for all categories. Some categories may not apply, so she can skip those (should tap a button to indicate this). User is asked to order her obstacles in the order she thinks she will encounter them. Some can be at the same time. Preferably this is made to look like an actual obstacle course. User is asked to “run” the obstacle course by selecting each obstacle and coming up with a way to get around it. We can offer prepopulated choices or user can enter her own. We track her progress as she works on this. User taps a button to see her obstacle course in list view. She can do this at any time during the process, but it isn't complete until she has finished coming up with ways to get around obstacles. User can track her progress as she overcomes obstacles by coming back to tool and checking off those she has completed. When she checks them all off, sounds of applause and congratulations ensue. The user may get a badge upon completion.

Sharables/Printables

User can share any or all of the obstacles. For example: “I am stuck getting my church group to work on a project. Using the Unstuck iPad app, I have identified my obstacles and plans to move past them. What do you think?” User can email and/or print final list, which can be used as a to-do list.

Call to Action at End of Tool

After running the tool the user is given a “call to action”, e.g., “Congratulations! You've made an important first step toward getting unstuck by creating a to-do list of obstacles and how to get past them. Use it as your guide to moving forward. And remember, you can always revise it as things change in your life. Just come back to Unstuck and modify your course.”

| | |
|---|---|
| Archetype: | In over your head |
| Prescription: | Call in the cavalry |
| Needs: | People with skills or knowledge she doesn't have to help |
| | her. |

### Example Stucks:

I need to write out a plan that illustrates clearly what the needs are with regards to knowledge sharing tools for the organization. It is hard to get going on it because there are so many issues that are related yet are difficult to fully explain or describe simply. It is also very intimidating here because so many people have the skill to write out amazing plans that make sense. Stepping up to that standard seems difficult, so doing busy work and avoiding getting started is easier.
I want to buy a new car, but I haven't started the process because I am unfamiliar and uncomfortable with the buying/selling process. All car transactions are nightmares, right? I feel paralyzed just thinking about it and need some expert advice.
I am trying to decide whether to fire an employee.
I'm short on resources. I have a strategic plan but not a tactical plan. I've been paralyzed about finding someone to do it for me (partially because of funds) and I've been intimidated (as silly as that sounds) to do the research myself because I'm kind of worried i don't know how to do it in the latest and greatest fashion. I consider myself an expert in the field but I'm not an expert in these latest tactics and it is making me feel exposed.

### Tool/Call in the Cavalry (Skill Mapper)

Tool goal: Sometimes it takes a little help from our friends, or making new friends, to move ahead. Let's put together your cavalry! ‘

With reference to FIG. 8N, the user writes out her goal. User selects the type of people she needs for her cavalry. She chooses from a variety of types that are prepopulated on the screen and puts them in her cavalry area. If user already knows people who meet these types, she indicates that she knows someone (e.g., taps a button) and identifies them. If she does not know people to match the needed types, she indicates that she needs to find someone and lists people who may be able to help her find someone. For each type, user indicates what she would like this person to do for her and how this can benefit both the user and the person helping her. (In some cases suggestions may be populated based on type). She then selects the best way to approach each person. Suggestions are provided, but the user can write in her own. A “My Cavalry” screen shows goal plus all the members, indicates if known or not. Preferably there is an option to add to the cavalry in case someone doesn't work out. The user can tap on any of the bubbles and it flips over to reveal a list of what they can do, mutual benefit, and approach tactic. Also are checkboxes that user can check when she has completed finding someone or reaching out to someone. They can also delete, if that type turns out to not be necessary. The tool ends by providing tips for the user on how to go about finding people to fill these missing archetypes.

Sharables/Printables

User can share her search for a cavalry member or her entire cavalry. For example: “I want to buy a new car, but I'm stuck. Using the Unstuck iPad app, I've learned that a financial whiz would help me get unstuck. Can you recommend anyone?” User can email and/or print the final list, which can be used as a to-do list.

Call to Action at End of Tool

After running the tool the user is given a “call to action”, e.g., “Charge! By putting together a group with the skills or knowledge you need, you've pushed yourself free of your stuck moment. Keep the momentum going by planning out your next steps with the planning tool.”

| | |
|---|---|
| Archetype: | Avoider |
| Prescription: | Go for it |
| Needs: | Courage to move forward. |

### Example Stucks:

I need to get a new computer . . . I'd love to pull the trigger on acquiring it soon, but know that if I wait I'll be able to find exactly what I'm looking for.
Getting out of a working out/running rut . . .
Taking a leap with work, a new project.
next stage of a relationship.
Getting into a habit of working out. I hate exercise, I hate gyms, I don't want to stop eating what I love to eat. So I'm avoiding starting this habit—even thought I know it'll be good for me, and that I'll feel better.
Repair relationship with dad.

Tool Goal: You'll find out if its fear or something else that's holding you back and the help you'll need to get past it.

With reference to FIG. 8-o, the user is asked a series of questions to see if her avoidance can be addressed by any of the other tools. First, she is asked a question that would lead to Blind Observer, Map It Out tool. if she answers Yes, she goes to tool. If she answers No, she goes to next question. Asked a question to see if she is a Waffler. If yes, she goes to Pros vs Pros tool. If No, she goes to next question. Asked a question to see if she is an Ad Libber. If Yes, she goes to Get Your Game On tool. If no, she goes to next question. Asked a question to see if she is In Over Her Head. If Yes, she goes to Call in the Cavalry tool. If no, she goes to next question. If user doesn't need any of the tools, she simply needs a push to make her goal happen. We message to that and provide tips that help her overcome her fear.

Sharables/Printables

User can share her what she's really stuck on and what she plans to do about it. For example: “I want to repair my relationship with dad. Using the Unstuck iPad app, I've realized that it is fear keeping me back. I'm going to try [ . . . ] to get past it. What do you think?” User can email and/or print tips from last screen, which can be used as a to-do list.

Call to Action at End of Tool:

After running the tool the user is given a “call to action”, e.g., “You're so close to being unstuck! Read through the tips to see if any of these can help you reach success. If they don't give you the push you need, go to the tool gallery for more help, or you may need to start your Stuck Moment over. {links to tool gallery and diagnosis start page}”

Where a process is described herein, those of skill in the art will appreciate that the process may operate without any user intervention. In another embodiment, the process includes some human intervention (e.g., a step is performed by or with the assistance of a human).

As used herein the words “first”, “second”, and so on, when used as adjectives before a term, are merely used to distinguish similar terms, and their use does not imply or define any numerical limits or any ordering (temporal or otherwise).

Thus are described systems and methods supporting interactive personal and professional guidance and assistance in getting unstuck.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

### APPENDIX A

### Tables and Exemplary Data Structures

### Thoughts Table

TABLE III

| | | Archetype | | | | | | | | | | |
|---|---|---|---|---|---|---|---|---|---|---|---|---|
| | | Tunnel | Deflated | | | Reluctant | Idle | Fuzzy | Ad- | Perplexed | Lone | |
| Thought | | Visionary | Doer | Drifter | Waffler | Adapter | Achiever | Forecaster | libber | Planner | Leader | Avoider |
| T₁ | I don't have enough to | 10 | 0 | 0 | 0 | 0 | 0 | 0 | 0 | 0 | 0 | 0 |
| | go on. | | | | | | | | | | | |
| T₂ | I don't know enough to | 10 | 0 | 0 | 0 | 0 | 0 | 0 | 0 | 0 | 0 | 0 |
| | really get it. | | | | | | | | | | | |
| T₃ | There are too many | 10 | 0 | 0 | 0 | 0 | 0 | 0 | 0 | 0 | 0 | 0 |
| | things that I don't know. | | | | | | | | | | | |
| T₄ | I need to know more. | 10 | 0 | 0 | 0 | 0 | 0 | 0 | 0 | 0 | 0 | 0 |
| T₅ | I must be missing | 10 | 0 | 0 | 0 | 0 | 0 | 0 | 0 | 0 | 0 | 0 |
| | something here. | | | | | | | | | | | |
| T₆ | I feel like I'm caught in | 10 | 0 | 0 | 0 | 0 | 0 | 0 | 0 | 0 | 0 | 0 |
| | the weeds. | | | | | | | | | | | |
| T₇ | We don't know enough | 10 | 0 | 0 | 0 | 0 | 0 | 0 | 0 | 0 | 0 | 0 |
| | to really get it. | | | | | | | | | | | |
| T₈ | There are too many | 10 | 0 | 0 | 0 | 0 | 0 | 0 | 0 | 0 | 0 | 0 |
| | things that we don't | | | | | | | | | | | |
| | know. | | | | | | | | | | | |
| T₉ | We're missing | 10 | 0 | 0 | 0 | 0 | 0 | 0 | 0 | 0 | 0 | 0 |
| | something here. | | | | | | | | | | | |
| T₁₀ | We need to know more. | 10 | 0 | 0 | 0 | 0 | 0 | 0 | 0 | 0 | 0 | 0 |
| T₁₁ | Feels like we're caught | 10 | 0 | 0 | 0 | 0 | 0 | 0 | 0 | 0 | 0 | 0 |
| | in the weeds. | | | | | | | | | | | |
| T₁₂ | We don't have enough | 10 | 0 | 0 | 0 | 0 | 0 | 0 | 0 | 0 | 0 | 0 |
| | to go on. | | | | | | | | | | | |
| T₁₃ | We don't understand | 10 | 0 | 0 | 0 | 0 | 0 | 0 | 0 | 0 | 0 | 0 |
| | the big picture. | | | | | | | | | | | |
| T₁₄ | I'm just going through | 0 | 10 | 0 | 0 | 0 | 0 | 0 | 0 | 0 | 0 | 0 |
| | the motions. | | | | | | | | | | | |
| T₁₅ | My heart just isn't in | 0 | 10 | 0 | 0 | 0 | 0 | 0 | 0 | 0 | 0 | 0 |
| | this. | | | | | | | | | | | |
| T₁₆ | I'm stuck in a rut. | 0 | 10 | 0 | 0 | 0 | 0 | 0 | 0 | 0 | 0 | 0 |
| T₁₇ | Every day just feels the | 0 | 10 | 0 | 0 | 0 | 0 | 0 | 0 | 0 | 0 | 0 |
| | same. | | | | | | | | | | | |
| T₁₈ | I could use a good | 0 | 10 | 0 | 0 | 0 | 0 | 0 | 0 | 0 | 0 | 0 |
| | dose of inspiration. | | | | | | | | | | | |
| T₁₉ | Our hearts just aren't in | 0 | 10 | 0 | 0 | 0 | 0 | 0 | 0 | 0 | 0 | 0 |
| | this. | | | | | | | | | | | |
| T₂₀ | We could use a good | 0 | 10 | 0 | 0 | 0 | 0 | 0 | 0 | 0 | 0 | 0 |
| | dose of inspiration. | | | | | | | | | | | |
| T₂₁ | Every day just feels the | 0 | 10 | 0 | 0 | 0 | 0 | 0 | 0 | 0 | 0 | 0 |
| | same. | | | | | | | | | | | |
| T₂₂ | We're stuck in a rut. | 0 | 10 | 0 | 0 | 0 | 0 | 0 | 0 | 0 | 0 | 0 |
| T₂₃ | What is the goal? | 0 | 0 | 10 | 0 | 0 | 0 | 0 | 0 | 0 | 0 | 0 |
| T₂₄ | I wish I had more of a | 0 | 0 | 10 | 0 | 0 | 0 | 0 | 0 | 0 | 0 | 0 |
| | direction. | | | | | | | | | | | |
| T₂₅ | I don't know what I | 0 | 0 | 10 | 0 | 0 | 0 | 0 | 0 | 0 | 0 | 0 |
| | want. | | | | | | | | | | | |
| T₂₆ | I want to be great, but | 0 | 0 | 10 | 0 | 0 | 0 | 0 | 0 | 0 | 0 | 0 |
| | at what? | | | | | | | | | | | |
| T₂₇ | What do I want to | 0 | 0 | 10 | 0 | 0 | 0 | 0 | 0 | 0 | 0 | 0 |
| | achieve? | | | | | | | | | | | |
| T₂₈ | Where am I going? | 0 | 0 | 10 | 0 | 0 | 0 | 0 | 0 | 0 | 0 | 0 |
| T₂₉ | What do I want to do? | 0 | 0 | 10 | 0 | 0 | 0 | 0 | 0 | 0 | 0 | 0 |
| T₃₀ | Why am I doing this? | 0 | 0 | 10 | 0 | 0 | 0 | 0 | 0 | 0 | 0 | 0 |
| T₃₁ | I've lost sight of what | 0 | 0 | 10 | 0 | 0 | 0 | 0 | 0 | 0 | 0 | 0 |
| | I'm trying to do. | | | | | | | | | | | |
| T₃₂ | I'm feeling unfulfilled. | 0 | 0 | 10 | 0 | 0 | 0 | 0 | 0 | 0 | 0 | 0 |
| T₃₃ | What do we want to | 0 | 0 | 10 | 0 | 0 | 0 | 0 | 0 | 0 | 0 | 0 |
| | achieve? | | | | | | | | | | | |
| T₃₄ | Remind me why we are | 0 | 0 | 10 | 0 | 0 | 0 | 0 | 0 | 0 | 0 | 0 |
| | doing this again. | | | | | | | | | | | |
| T₃₅ | We don't know what we | 0 | 0 | 10 | 0 | 0 | 0 | 0 | 0 | 0 | 0 | 0 |
| | want. | | | | | | | | | | | |
| T₃₆ | We've lost sight of what | 0 | 0 | 10 | 0 | 0 | 0 | 0 | 0 | 0 | 0 | 0 |
| | we're trying to do. | | | | | | | | | | | |
| T₃₇ | We wish we had more | 0 | 0 | 10 | 0 | 0 | 0 | 0 | 0 | 0 | 0 | 0 |
| | of a direction. | | | | | | | | | | | |
| T₃₈ | What are we doing? | 0 | 0 | 10 | 0 | 0 | 0 | 0 | 0 | 0 | 0 | 0 |
| T₃₉ | What is the goal? | 0 | 0 | 10 | 0 | 0 | 0 | 0 | 0 | 0 | 0 | 0 |
| T₄₀ | I don't know why this | 0 | 0 | 0 | 10 | 0 | 0 | 0 | 0 | 0 | 0 | 0 |
| | matters to me. | | | | | | | | | | | |
| T₄₁ | Maybe I need to ask | 0 | 0 | 0 | 10 | 0 | 0 | 0 | 0 | 0 | 0 | 0 |
| | somebody what to do. | | | | | | | | | | | |
| T₄₂ | I could go either way on | 0 | 0 | 0 | 10 | 0 | 0 | 0 | 0 | 0 | 0 | 0 |
| | this. | | | | | | | | | | | |
| T₄₃ | Can't someone else | 0 | 0 | 0 | 10 | 0 | 0 | 0 | 0 | 0 | 0 | 0 |
| | decide? | | | | | | | | | | | |
| T₄₄ | I can't decide. | 0 | 0 | 0 | 10 | 0 | 0 | 0 | 0 | 0 | 0 | 0 |
| T₄₅ | There are too many | 0 | 0 | 0 | 10 | 0 | 0 | 0 | 0 | 0 | 0 | 0 |
| | choices. | | | | | | | | | | | |
| T₄₆ | Why is it so hard to | 0 | 0 | 0 | 10 | 0 | 0 | 0 | 0 | 0 | 0 | 0 |
| | decide? | | | | | | | | | | | |
| T₄₇ | We could go either way | 0 | 0 | 0 | 10 | 0 | 0 | 0 | 0 | 0 | 0 | 0 |
| | on this. | | | | | | | | | | | |
| T₄₈ | Why can't someone | 0 | 0 | 0 | 10 | 0 | 0 | 0 | 0 | 0 | 0 | 0 |
| | else decide for us? | | | | | | | | | | | |
| T₄₉ | We can't decide. | 0 | 0 | 0 | 10 | 0 | 0 | 0 | 0 | 0 | 0 | 0 |
| T₅₀ | Why is it so hard to | 0 | 0 | 0 | 10 | 0 | 0 | 0 | 0 | 0 | 0 | 0 |
| | decide? | | | | | | | | | | | |
| T₅₁ | Maybe we should ask | 0 | 0 | 0 | 10 | 0 | 0 | 0 | 0 | 0 | 0 | 0 |
| | somebody what to do. | | | | | | | | | | | |
| T₅₂ | I thought I knew what to | 0 | 0 | 0 | 0 | 10 | 0 | 0 | 0 | 0 | 0 | 0 |
| | do, but now I'm not | | | | | | | | | | | |
| | sure. | | | | | | | | | | | |
| T₅₃ | Change is hard. | 0 | 0 | 0 | 0 | 10 | 0 | 0 | 0 | 0 | 0 | 0 |
| T₅₄ | I'm finding it hard to | 0 | 0 | 0 | 0 | 10 | 0 | 0 | 0 | 0 | 0 | 0 |
| | adapt. | | | | | | | | | | | |
| T₅₅ | I'm not sure how this | 0 | 0 | 0 | 0 | 10 | 0 | 0 | 0 | 0 | 0 | 0 |
| | affects me. | | | | | | | | | | | |
| T₅₆ | Remind me why this is | 0 | 0 | 0 | 0 | 10 | 0 | 0 | 0 | 0 | 0 | 0 |
| | important to me. | | | | | | | | | | | |
| T₅₇ | I'm questioning myself. | 0 | 0 | 0 | 0 | 10 | 0 | 0 | 0 | 0 | 0 | 0 |
| T₅₈ | We're not sure how this | 0 | 0 | 0 | 0 | 10 | 0 | 0 | 0 | 0 | 0 | 0 |
| | affects us. | | | | | | | | | | | |
| T₅₉ | We thought we knew | 0 | 0 | 0 | 0 | 10 | 0 | 0 | 0 | 0 | 0 | 0 |
| | what to do, but now | | | | | | | | | | | |
| | we're not sure. | | | | | | | | | | | |
| T₆₀ | Change is hard. | 0 | 0 | 0 | 0 | 10 | 0 | 0 | 0 | 0 | 0 | 0 |
| T₆₁ | Remind us why this is | 0 | 0 | 0 | 0 | 10 | 0 | 0 | 0 | 0 | 0 | 0 |
| | important to us. | | | | | | | | | | | |
| T₆₂ | We're finding it hard to | 0 | 0 | 0 | 0 | 10 | 0 | 0 | 0 | 0 | 0 | 0 |
| | adapt. | | | | | | | | | | | |
| T₆₃ | We're starting to | 0 | 0 | 0 | 0 | | 10 | 0 | 0 | 0 | 0 | 0 |
| | question our decision. | | | | | | | | | | | |
| T₆₄ | I know what I want to | 0 | 0 | 0 | 0 | 0 | 10 | 0 | 0 | 0 | 0 | 0 |
| | do, I'm just not doing it. | | | | | | | | | | | |
| T₆₅ | I'm having trouble | 0 | 0 | 0 | 0 | 0 | 10 | 0 | 0 | 0 | 0 | 0 |
| | sticking to it. | | | | | | | | | | | |
| T₆₆ | I keep starting and | 0 | 0 | 0 | 0 | 0 | 10 | 0 | 0 | 0 | 0 | 0 |
| | stopping. | | | | | | | | | | | |
| T₆₇ | I need someone to | 0 | 0 | 0 | 0 | 0 | 10 | 0 | 0 | 0 | 0 | 0 |
| | keep on me. | | | | | | | | | | | |
| T₆₈ | I'll do it tomorrow. | 0 | 0 | 0 | 0 | 0 | 10 | 0 | 0 | 0 | 0 | 0 |
| T₆₉ | We'll get to it tomorrow. | 0 | 0 | 0 | 0 | 0 | 10 | 0 | 0 | 0 | 0 | 0 |
| T₇₀ | We know what we want | 0 | 0 | 0 | 0 | 0 | 10 | 0 | 0 | 0 | 0 | 0 |
| | to do, we're just not | | | | | | | | | | | |
| | doing it. | | | | | | | | | | | |
| T₇₁ | We're having trouble | 0 | 0 | 0 | 0 | 0 | 10 | 0 | 0 | 0 | 0 | 0 |
| | sticking to it. | | | | | | | | | | | |
| T₇₂ | We keep starting and | 0 | 0 | 0 | 0 | 0 | 10 | 0 | 0 | 0 | 0 | 0 |
| | stopping. | | | | | | | | | | | |
| T₇₃ | It's hard for us to stay | 0 | 0 | 0 | 0 | 0 | 10 | 0 | 0 | 0 | 0 | 0 |
| | focused. | | | | | | | | | | | |
| T₇₄ | We need someone to | 0 | 0 | 0 | 0 | 0 | 10 | 0 | 0 | 0 | 0 | 0 |
| | keep on us. | | | | | | | | | | | |
| T₇₅ | I just can't see it. | 0 | 0 | 0 | 0 | 0 | 0 | 10 | 0 | 0 | 0 | 0 |
| T₇₆ | It doesn't seem real | 0 | 0 | 0 | 0 | 0 | 0 | 10 | 0 | 0 | 0 | 0 |
| | yet. | | | | | | | | | | | |
| T₇₇ | I can't get others to see | 0 | 0 | 0 | 0 | 0 | 0 | 10 | 0 | 0 | 0 | 0 |
| | what I see. | | | | | | | | | | | |
| T₇₈ | I know what I want to | 0 | 0 | 0 | 0 | 0 | 0 | 10 | 0 | 0 | 0 | 0 |
| | do, but the details | | | | | | | | | | | |
| | aren't clear yet. | | | | | | | | | | | |
| T₇₉ | I can't see it in my | 0 | 0 | 0 | 0 | 0 | 0 | 10 | 0 | 0 | 0 | 0 |
| | mind's eye yet. | | | | | | | | | | | |
| T₈₀ | I can't get others to | 0 | 0 | 0 | 0 | 0 | 0 | 10 | 0 | 0 | 0 | 0 |
| | understand my idea. | | | | | | | | | | | |
| T₈₁ | We just can't see it. | 0 | 0 | 0 | 0 | 0 | 0 | 10 | 0 | 0 | 0 | 0 |
| T₈₂ | We know what we want | 0 | 0 | 0 | 0 | 0 | 0 | 10 | 0 | 0 | 0 | 0 |
| | to do, but the details | | | | | | | | | | | |
| | are unclear. | | | | | | | | | | | |
| T₈₃ | It doesn't seem real to | 0 | 0 | 0 | 0 | 0 | 0 | 10 | 0 | 0 | 0 | 0 |
| | us yet. | | | | | | | | | | | |
| T₈₄ | It's clear to us but not | 0 | 0 | 0 | 0 | 0 | 0 | 10 | 0 | 0 | 0 | 0 |
| | to others. | | | | | | | | | | | |
| T₈₅ | We can't agree on what | 0 | 0 | 0 | 0 | 0 | 0 | 10 | 0 | 0 | 0 | 0 |
| | it should look like. | | | | | | | | | | | |
| T₈₆ | Other people just don't | 0 | 0 | 0 | 0 | 0 | 0 | 10 | 0 | 0 | 0 | 0 |
| | get it. | | | | | | | | | | | |
| T₈₇ | We each have different | 0 | 0 | 0 | 0 | 0 | 0 | 10 | 0 | 0 | 0 | 0 |
| | ideas of what this | | | | | | | | | | | |
| | should be. | | | | | | | | | | | |
| T₈₈ | I'm not sure what to | 0 | 0 | 0 | 0 | 0 | 0 | 0 | 10 | 0 | 0 | 0 |
| | expect or do next. | | | | | | | | | | | |
| T₈₉ | This disorganization is | 0 | 0 | 0 | 0 | 0 | 0 | 0 | 10 | 0 | 0 | 0 |
| | killing me. | | | | | | | | | | | |
| T₉₀ | Doing a lot, but getting | 0 | 0 | 0 | 0 | 0 | 0 | 0 | 10 | 0 | 0 | 0 |
| | nowhere. | | | | | | | | | | | |
| T₉₁ | I don't know where to | 0 | 0 | 0 | 0 | 0 | 0 | 0 | 10 | 0 | 0 | 0 |
| | begin. | | | | | | | | | | | |
| T₉₂ | Everything is a mess. | 0 | 0 | 0 | 0 | 0 | 0 | 0 | 10 | 0 | 0 | 0 |
| T₉₃ | I'm not so good at the | 0 | 0 | 0 | 0 | 0 | 0 | 0 | 10 | 0 | 0 | 0 |
| | details. | | | | | | | | | | | |
| T₉₄ | I know what I want to | 0 | 0 | 0 | 0 | 0 | 0 | 0 | 10 | 0 | 0 | 0 |
| | do, but I just don't know | | | | | | | | | | | |
| | how. | | | | | | | | | | | |
| T₉₅ | We're not so good at | 0 | 0 | 0 | 0 | 0 | 0 | 0 | 10 | 0 | 0 | 0 |
| | the details. | | | | | | | | | | | |
| T₉₆ | We're not sure what to | 0 | 0 | 0 | 0 | 0 | 0 | 0 | 10 | 0 | 0 | 0 |
| | expect or do next. | | | | | | | | | | | |
| T₉₇ | We're trying hard, but | 0 | 0 | 0 | 0 | 0 | 0 | 0 | 10 | 0 | 0 | 0 |
| | getting nowhere. | | | | | | | | | | | |
| T₉₈ | Everything is a mess | 0 | 0 | 0 | 0 | 0 | 0 | 0 | 10 | 0 | 0 | 0 |
| T₉₉ | We know what we want | 0 | 0 | 0 | 0 | 0 | 0 | 0 | 10 | 0 | 0 | 0 |
| | to do, but we just don't | | | | | | | | | | | |
| | know how. | | | | | | | | | | | |
| T₁₀₀ | The disorganization is | 0 | 0 | 0 | 0 | 0 | 0 | 0 | 10 | 0 | 0 | 0 |
| | killing us. | | | | | | | | | | | |
| T₁₀₁ | We don't know where | 0 | 0 | 0 | 0 | 0 | 0 | 0 | 10 | 0 | 0 | 0 |
| | to begin. | | | | | | | | | | | |
| T₁₀₂ | I don't know why this | 0 | 0 | 0 | 0 | 0 | 0 | 0 | 0 | 10 | 0 | 0 |
| | isn't working. | | | | | | | | | | | |
| T₁₀₃ | My old way of doing | 0 | 0 | 0 | 0 | 0 | 0 | 0 | 0 | 10 | 0 | 0 |
| | this just isn't working. | | | | | | | | | | | |
| T₁₀₄ | For every step forward, | 0 | 0 | 0 | 0 | 0 | 0 | 0 | 0 | 10 | 0 | 0 |
| | I take two steps back. | | | | | | | | | | | |
| T₁₀₅ | I never have enough | 0 | 0 | 0 | 0 | 0 | 0 | 0 | 0 | 10 | 0 | 0 |
| | time. | | | | | | | | | | | |
| T₁₀₆ | How do other people | 0 | 0 | 0 | 0 | 0 | 0 | 0 | 0 | 10 | 0 | 0 |
| | manage to do this? | | | | | | | | | | | |
| T₁₀₇ | Our priorities keep | 0 | 0 | 0 | 0 | 0 | 0 | 0 | 0 | 10 | 0 | 0 |
| | shifting. | | | | | | | | | | | |
| T₁₀₈ | We never have enough | 0 | 0 | 0 | 0 | 0 | 0 | 0 | 0 | 10 | 0 | 0 |
| | time. | | | | | | | | | | | |
| T₁₀₉ | How do other people | 0 | 0 | 0 | 0 | 0 | 0 | 0 | 0 | 10 | 0 | 0 |
| | manage to do this? | | | | | | | | | | | |
| T₁₁₀ | We don't know why this | 0 | 0 | 0 | 0 | 0 | 0 | 0 | 0 | 10 | 0 | 0 |
| | isn't working. | | | | | | | | | | | |
| T₁₁₁ | Our old way of doing | 0 | 0 | 0 | 0 | 0 | 0 | 0 | 0 | 10 | 0 | 0 |
| | this just isn't working. | | | | | | | | | | | |
| T₁₁₂ | There's got to be a | 0 | 0 | 0 | 0 | 0 | 0 | 0 | 0 | 10 | 0 | 0 |
| | better way. | | | | | | | | | | | |
| T₁₁₃ | I'm not sure how I'm | 0 | 0 | 0 | 0 | 0 | 0 | 0 | 0 | 0 | 10 | 0 |
| | going to do this all by | | | | | | | | | | | |
| | myself. | | | | | | | | | | | |
| T₁₁₄ | I wish I had an expert | 0 | 0 | 0 | 0 | 0 | 0 | 0 | 0 | 0 | 10 | 0 |
| | to help me. | | | | | | | | | | | |
| T₁₁₅ | This is beyond me. | 0 | 0 | 0 | 0 | 0 | 0 | 0 | 0 | 0 | 10 | 0 |
| T₁₁₆ | There's only so much I | 0 | 0 | 0 | 0 | 0 | 0 | 0 | 0 | 0 | 10 | 0 |
| | can do on my own. | | | | | | | | | | | |
| T₁₁₇ | I need help. | 0 | 0 | 0 | 0 | 0 | 0 | 0 | 0 | 0 | 10 | 0 |
| T₁₁₈ | This will take forever by | 0 | 0 | 0 | 0 | 0 | 0 | 0 | 0 | 0 | 10 | 0 |
| | myself. | | | | | | | | | | | |
| T₁₁₉ | I have better things to | 0 | 0 | 0 | 0 | 0 | 0 | 0 | 0 | 0 | 10 | 0 |
| | do with my time. | | | | | | | | | | | |
| T₁₂₀ | I'm spread too thin. | 0 | 0 | 0 | 0 | 0 | 0 | 0 | 0 | 0 | 10 | 0 |
| T₁₂₁ | We have better things | 0 | 0 | 0 | 0 | 0 | 0 | 0 | 0 | 0 | 10 | 0 |
| | to do with our time. | | | | | | | | | | | |
| T₁₂₂ | There's only so much | 0 | 0 | 0 | 0 | 0 | 0 | 0 | 0 | 0 | 10 | 0 |
| | we can do on our own. | | | | | | | | | | | |
| T₁₂₃ | We're not sure how | 0 | 0 | 0 | 0 | 0 | 0 | 0 | 0 | 0 | 10 | 0 |
| | we're going to get this | | | | | | | | | | | |
| | all done. | | | | | | | | | | | |
| T₁₂₄ | I wish we had an expert | 0 | 0 | 0 | 0 | 0 | 0 | 0 | 0 | 0 | 10 | 0 |
| | to help us. | | | | | | | | | | | |
| T₁₂₅ | We're spread too thin. | 0 | 0 | 0 | 0 | 0 | 0 | 0 | 0 | 0 | 10 | 0 |
| T₁₂₆ | This is beyond us. | 0 | 0 | 0 | 0 | 0 | 0 | 0 | 0 | 0 | 10 | 0 |
| T₁₂₇ | This will take us | 0 | 0 | 0 | 0 | 0 | 0 | 0 | 0 | 0 | 10 | 0 |
| | forever. | | | | | | | | | | | |
| T₁₂₈ | Fear is taking over. | 0 | 0 | 0 | 0 | 0 | 0 | 0 | 0 | 0 | 0 | 10 |
| T₁₂₉ | I'm scared to do what I | 0 | 0 | 0 | 0 | 0 | 0 | 0 | 0 | 0 | 0 | 10 |
| | know I have to do. | | | | | | | | | | | |
| T₁₃₀ | I just can't seem to pull | 0 | 0 | 0 | 0 | 0 | 0 | 0 | 0 | 0 | 0 | 10 |
| | the trigger and go do it. | | | | | | | | | | | |
| T₁₃₁ | I'm good at finding | 0 | 0 | 0 | 0 | 0 | 0 | 0 | 0 | 0 | 0 | 10 |
| | excuses not to do it. | | | | | | | | | | | |
| T₁₃₂ | I'm nervous about what | 0 | 0 | 0 | 0 | 0 | 0 | 0 | 0 | 0 | 0 | 10 |
| | might happen next. | | | | | | | | | | | |
| T₁₃₃ | I just don't have | 0 | 0 | 0 | 0 | 0 | 0 | 0 | 0 | 0 | 0 | 10 |
| | the (insert excuse | | | | | | | | | | | |
| | here). | | | | | | | | | | | |
| T₁₃₄ | There's no good reason | 0 | 0 | 0 | 0 | 0 | 0 | 0 | 0 | 0 | 0 | 10 |
| | why I'm not doing this. | | | | | | | | | | | |
| T₁₃₅ | There's no good reason | 0 | 0 | 0 | 0 | 0 | 0 | 0 | 0 | 0 | 0 | 10 |
| | why we're not doing | | | | | | | | | | | |
| | this. | | | | | | | | | | | |
| T₁₃₆ | We're nervous about | 0 | 0 | 0 | 0 | 0 | 0 | 0 | 0 | 0 | 0 | 10 |
| | what might happen | | | | | | | | | | | |
| | next. | | | | | | | | | | | |
| T₁₃₇ | We just can't pull the | 0 | 0 | 0 | 0 | 0 | 0 | 0 | 0 | 0 | 0 | 10 |
| | trigger and go do it. | | | | | | | | | | | |
| T₁₃₈ | Fear is taking over. | 0 | 0 | 0 | 0 | 0 | 0 | 0 | 0 | 0 | 0 | 10 |
| T₁₃₉ | We keep finding | 0 | 0 | 0 | 0 | 0 | 0 | 0 | 0 | 0 | 0 | 10 |
| | excuses not to do it. | | | | | | | | | | | |

### Table IV Thoughts by SBTA Category

TABLE IV
Thoughts by SBTA Category

| | | SBTA |
|---|---|---|
| Thought | | category |
| T₁ | I don't have enough to go on. | Seeing |
| T₂ | I don't know enough to really get it. | Seeing |
| T₃ | There are too many things that I don't know. | Seeing |
| T₄ | I need to know more. | Seeing |
| T₅ | I must be missing something here. | Seeing |
| T₆ | I feel like I'm caught in the weeds. | Seeing |
| T₇ | We don't know enough to really get it. | Seeing |
| T₈ | There are too many things that we don't know. | Seeing |
| T₉ | We're missing something here. | Seeing |
| T₁₀ | We need to know more. | Seeing |
| T₁₁ | Feels like we're caught in the weeds. | Seeing |
| T₁₂ | We don't have enough to go on. | Seeing |
| T₁₃ | We don't understand the big picture. | Seeing |
| T₁₄ | I'm just going through the motions. | Seeing |
| T₁₅ | My heart just isn't in this. | Seeing |
| T₁₆ | I'm stuck in a rut. | Seeing |
| T₁₇ | Every day just feels the same. | Seeing |
| T₁₈ | I could use a good dose of inspiration. | Seeing |
| T₁₉ | Our hearts just aren't in this. | Seeing |
| T₂₀ | We could use a good dose of inspiration. | Seeing |
| T₂₁ | Every day just feels the same. | Seeing |
| T₂₂ | We're stuck in a rut. | Seeing |
| T₂₃ | What is the goal? | Believing |
| T₂₄ | I wish I had more of a direction. | Believing |
| T₂₅ | I don't know what I want. | Believing |
| T₂₆ | I want to be great, but at what? | Believing |
| T₂₇ | What do I want to achieve? | Believing |
| T₂₈ | Where am I going? | Believing |
| T₂₉ | What do I want to do? | Believing |
| T₃₀ | Why am I doing this? | Believing |
| T₃₁ | I've lost sight of what I'm trying to do. | Believing |
| T₃₂ | I'm feeling unfulfilled. | Believing |
| T₃₃ | What do we want to achieve? | Believing |
| T₃₄ | Remind me why we are doing this again. | Believing |
| T₃₅ | We don't know what we want. | Believing |
| T₃₆ | We've lost sight of what we're trying to do. | Believing |
| T₃₇ | We wish we had more of a direction. | Believing |
| T₃₈ | What are we doing? | Believing |
| T₃₉ | What is the goal? | Believing |
| T₄₀ | I don't know why this matters to me. | Believing |
| T₄₁ | Maybe I need to ask somebody what to do. | Believing |
| T₄₂ | I could go either way on this. | Believing |
| T₄₃ | Can't someone else decide? | Believing |
| T₄₄ | I can't decide. | Believing |
| T₄₅ | There are too many choices. | Believing |
| T₄₆ | Why is it so hard to decide? | Believing |
| T₄₇ | We could go either way on this. | Believing |
| T₄₈ | Why can't someone else decide for us? | Believing |
| T₄₉ | We can't decide. | Believing |
| T₅₀ | Why is it so hard to decide? | Believing |
| T₅₁ | Maybe we should ask somebody what to do. | Believing |
| T₅₂ | I thought I knew what to do, but now I'm not sure. | Believing |
| T₅₃ | Change is hard. | Believing |
| T₅₄ | I'm finding it hard to adapt. | Believing |
| T₅₅ | I'm not sure how this affects me. | Believing |
| T₅₆ | Remind me why this is important to me. | Believing |
| T₅₇ | I'm questioning myself. | Believing |
| T₅₈ | We're not sure how this affects us. | Believing |
| T₅₉ | We thought we knew what to do, but now we're not | Believing |
| | sure. | |
| T₆₀ | Change is hard. | Believing |
| T₆₁ | Remind us why this is important to us. | Believing |
| T₆₂ | We're finding it hard to adapt. | Believing |
| T₆₃ | We're starting to question our decision. | Believing |
| T₆₄ | I know what I want to do, I'm just not doing it. | Believing |
| T₆₅ | I'm having trouble sticking to it. | Believing |
| T₆₆ | I keep starting and stopping. | Believing |
| T₆₇ | I need someone to keep on me. | Believing |
| T₆₈ | I'll do it tomorrow. | Believing |
| T₆₉ | We'll get to it tomorrow. | Believing |
| T₇₀ | We know what we want to do, we're just not doing it. | Believing |
| T₇₁ | We're having trouble sticking to it. | Believing |
| T₇₂ | We keep starting and stopping. | Believing |
| T₇₃ | It's hard for us to stay focused. | Believing |
| T₇₄ | We need someone to keep on us. | Believing |
| T₇₅ | I just can't see it. | Thinking |
| T₇₆ | It doesn't seem real yet. | Thinking |
| T₇₇ | I can't get others to see what I see. | Thinking |
| T₇₈ | I know what I want to do, but the details aren't clear | Thinking |
| | yet. | |
| T₇₉ | I can't see it in my mind's eye yet. | Thinking |
| T₈₀ | I can't get others to understand my idea. | Thinking |
| T₈₁ | We just can't see it. | Thinking |
| T₈₂ | We know what we want to do, but the details are | Thinking |
| | unclear. | |
| T₈₃ | It doesn't seem real to us yet. | Thinking |
| T₈₄ | It's clear to us but not to others. | Thinking |
| T₈₅ | We can't agree on what it should look like. | Thinking |
| T₈₆ | Other people just don't get it. | Thinking |
| T₈₇ | We each have different ideas of what this should be. | Thinking |
| T₈₈ | I'm not sure what to expect or do next. | Thinking |
| T₈₉ | This disorganization is killing me. | Thinking |
| T₉₀ | Doing a lot, but getting nowhere. | Thinking |
| T₉₁ | I don't know where to begin. | Thinking |
| T₉₂ | Everything is a mess. | Thinking |
| T₉₃ | I'm not so good at the details. | Thinking |
| T₉₄ | I know what I want to do, but I just don't know how. | Thinking |
| T₉₅ | We're not so good at the details. | Thinking |
| T₉₆ | We're not sure what to expect or do next. | Thinking |
| T₉₇ | We're trying hard, but getting nowhere. | Thinking |
| T₉₈ | Everything is a mess | Thinking |
| T₉₉ | We know what we want to do, but we just don't know | Thinking |
| | how. | |
| T₁₀₀ | The disorganization is killing us. | Thinking |
| T₁₀₁ | We don't know where to begin. | Thinking |
| T₁₀₂ | I don't know why this isn't working. | Thinking |
| T₁₀₃ | My old way of doing this just isn't working. | Thinking |
| T₁₀₄ | For every step forward, I take two steps back. | Thinking |
| T₁₀₅ | I never have enough time. | Thinking |
| T₁₀₆ | How do other people manage to do this? | Thinking |
| T₁₀₇ | Our priorities keep shifting. | Thinking |
| T₁₀₈ | We never have enough time. | Thinking |
| T₁₀₉ | How do other people manage to do this? | Thinking |
| T₁₁₀ | We don't know why this isn't working. | Thinking |
| T₁₁₁ | Our old way of doing this just isn't working. | Thinking |
| T₁₁₂ | There's got to be a better way. | Thinking |
| T₁₁₃ | I'm not sure how I'm going to do this all by myself. | Acting |
| T₁₁₄ | I wish I had an expert to help me. | Acting |
| T₁₁₅ | This is beyond me. | Acting |
| T₁₁₆ | There's only so much I can do on my own. | Acting |
| T₁₁₇ | I need help. | Acting |
| T₁₁₈ | This will take forever by myself. | Acting |
| T₁₁₉ | I have better things to do with my time. | Acting |
| T₁₂₀ | I'm spread too thin. | Acting |
| T₁₂₁ | We have better things to do with our time. | Acting |
| T₁₂₂ | There's only so much we can do on our own. | Acting |
| T₁₂₃ | Were not sure how we're going to get this all done. | Acting |
| T₁₂₄ | I wish we had an expert to help us. | Acting |
| T₁₂₅ | We're spread too thin. | Acting |
| T₁₂₆ | This is beyond us. | Acting |
| T₁₂₇ | This will take us forever. | Acting |
| T₁₂₈ | Fear is taking over. | Acting |
| T₁₂₉ | I'm scared to do what I know I have to do. | Acting |
| T₁₃₀ | I just can't seem to pull the trigger and go do it. | Acting |
| T₁₃₁ | I'm good at finding excuses not to do it. | Acting |
| T₁₃₂ | I'm nervous about what might happen next. | Acting |
| T₁₃₃ | I just don't have the (insert excuse here). | Acting |
| T₁₃₄ | There's no good reason why I'm not doing this. | Acting |
| T₁₃₅ | There's no good reason why we're not doing this. | Acting |
| T₁₃₆ | We're nervous about what might happen next. | Acting |
| T₁₃₇ | We just can't pull the trigger and go do it. | Acting |
| T₁₃₈ | Fear is taking over. | Acting |
| T₁₃₉ | We keep finding excuses not to do it. | Acting |

### Table IV

TABLE IV

| | | Flags | | | | |
|---|---|---|---|---|---|---|
| Thought | | me | me plus 1 | me plus 2 | personal | professional |
| T₁ | I don't have enough to go on. | 1 | 0 | 0 | 1 | 1 |
| T₂ | I don't know enough to really get it. | 1 | 0 | 0 | 1 | 1 |
| T₃ | There are too many things that I don't know. | 1 | 0 | 0 | 1 | 1 |
| T₄ | I need to know more. | 1 | 0 | 0 | 1 | 1 |
| T₅ | I must be missing something here. | 1 | 0 | 0 | 1 | 1 |
| T₆ | I feel like I'm caught in the weeds. | 1 | 0 | 0 | 1 | 1 |
| T₇ | We don't know enough to really get it. | 0 | 1 | 1 | 1 | 1 |
| T₈ | There are too many things that we don't know. | 0 | 1 | 1 | 1 | 1 |
| T₉ | We're missing something here. | 0 | 1 | 1 | 1 | 1 |
| T₁₀ | We need to know more. | 0 | 1 | 1 | 1 | 1 |
| T₁₁ | Feels like we're caught in the weeds. | 0 | 1 | 1 | 1 | 1 |
| T₁₂ | We don't have enough to go on. | 0 | 1 | 1 | 1 | 1 |
| T₁₃ | We don't understand the big picture. | 0 | 1 | 1 | 1 | 1 |
| T₁₄ | I'm just going through the motions. | 1 | 0 | 0 | 1 | 1 |
| T₁₅ | My heart just isn't in this. | 1 | 0 | 0 | 1 | 1 |
| T₁₆ | I'm stuck in a rut. | 1 | 0 | 0 | 1 | 1 |
| T₁₇ | Every day just feels the same. | 1 | 0 | 0 | 1 | 1 |
| T₁₈ | I could use a good dose of inspiration. | 1 | 0 | 0 | 1 | 1 |
| T₁₉ | Our hearts just aren't in this. | 0 | 1 | 1 | 1 | 1 |
| T₂₀ | We could use a good dose of inspiration. | 0 | 1 | 1 | 1 | 1 |
| T₂₁ | Every day just feels the same. | 0 | 1 | 1 | 1 | 1 |
| T₂₂ | We're stuck in a rut. | 0 | 1 | 1 | 1 | 1 |
| T₂₃ | What is the goal? | 0 | 1 | 1 | 1 | 1 |
| T₂₄ | I wish I had more of a direction. | 1 | 0 | 0 | 1 | 1 |
| T₂₅ | I don't know what I want. | 1 | 0 | 0 | 1 | 1 |
| T₂₆ | I want to be great, but at what? | 1 | 0 | 0 | 1 | 1 |
| T₂₇ | What do I want to achieve? | 1 | 0 | 0 | 1 | 1 |
| T₂₈ | Where am I going? | 1 | 0 | 0 | 1 | 1 |
| T₂₉ | What do I want to do? | 1 | 0 | 0 | 1 | 1 |
| T₃₀ | Why am I doing this? | 1 | 0 | 0 | 1 | 1 |
| T₃₁ | I've lost sight of what I'm trying to do. | 1 | 0 | 0 | 1 | 1 |
| T₃₂ | I'm feeling unfulfilled. | 1 | 0 | 0 | 1 | 1 |
| T₃₃ | What do we want to achieve? | 0 | 1 | 1 | 1 | 1 |
| T₃₄ | Remind me why we are doing this again. | 0 | 1 | 1 | 1 | 1 |
| T₃₅ | We don't know what we want. | 0 | 1 | 1 | 1 | 1 |
| T₃₆ | We've lost sight of what we're trying to do. | 0 | 1 | 1 | 1 | 1 |
| T₃₇ | We wish we had more of a direction. | 0 | 1 | 1 | 1 | 1 |
| T₃₈ | What are we doing? | 0 | 1 | 1 | 1 | 1 |
| T₃₉ | What is the goal? | 1 | 0 | 0 | 1 | 1 |
| T₄₀ | I don't know why this matters to me. | 1 | 0 | 0 | 1 | 1 |
| T₄₁ | Maybe I need to ask somebody what to do. | 1 | 0 | 0 | 1 | 1 |
| T₄₂ | I could go either way on this. | 1 | 0 | 0 | 1 | 1 |
| T₄₃ | Can't someone else decide? | 1 | 0 | 0 | 1 | 1 |
| T₄₄ | I can't decide. | 1 | 0 | 0 | 1 | 1 |
| T₄₅ | There are too many choices. | 1 | 1 | 1 | 1 | 1 |
| T₄₆ | Why is it so hard to decide? | 1 | 0 | 0 | 1 | 1 |
| T₄₇ | We could go either way on this. | 0 | 1 | 1 | 1 | 1 |
| T₄₈ | Why can't someone else decide for us? | 0 | 1 | 1 | 1 | 1 |
| T₄₉ | We can't decide. | 0 | 1 | 1 | 1 | 1 |
| T₅₀ | Why is it so hard to decide? | 0 | 1 | 1 | 1 | 1 |
| T₅₁ | Maybe we should ask somebody what to do. | 0 | 1 | 1 | 1 | 1 |
| T₅₂ | I thought I knew what to do, but now I'm not | 1 | 0 | 0 | 1 | 1 |
| | sure. | | | | | |
| T₅₃ | Change is hard. | 1 | 0 | 0 | 1 | 1 |
| T₅₄ | I'm finding it hard to adapt. | 1 | 0 | 0 | 1 | 1 |
| T₅₅ | I'm not sure how this affects me. | 1 | 0 | 0 | 1 | 1 |
| T₅₆ | Remind me why this is important to me. | 1 | 0 | 0 | 1 | 1 |
| T₅₇ | I'm questioning myself. | 1 | 0 | 0 | 1 | 1 |
| T₅₈ | We're not sure how this affects us. | 0 | 1 | 1 | 1 | 1 |
| T₅₉ | We thought we knew what to do, but now we're | 0 | 1 | 1 | 1 | 1 |
| | not sure. | | | | | |
| T₆₀ | Change is hard. | 0 | 1 | 1 | 1 | 1 |
| T₆₁ | Remind us why this is important to us. | 0 | 1 | 1 | 1 | 1 |
| T₆₂ | We're finding it hard to adapt. | 0 | 1 | 1 | 1 | 1 |
| T₆₃ | We're starting to question our decision. | 0 | 1 | 1 | 1 | 1 |
| T₆₄ | I know what I want to do, I'm just not doing it. | 1 | 0 | 0 | 1 | 1 |
| T₆₅ | I'm having trouble sticking to it. | 1 | 0 | 0 | 1 | 1 |
| T₆₆ | I keep starting and stopping. | 1 | 0 | 0 | 1 | 1 |
| T₆₇ | I need someone to keep on me. | 1 | 0 | 0 | 1 | 1 |
| T₆₈ | I'll do it tomorrow. | 1 | 0 | 0 | 1 | 1 |
| T₆₉ | We'll get to it tomorrow. | 0 | 1 | 1 | 1 | 1 |
| T₇₀ | We know what we want to do, we're just not | 0 | 1 | 1 | 1 | 1 |
| | doing it. | | | | | |
| T₇₁ | We're having trouble sticking to it. | 0 | 1 | 1 | 1 | 1 |
| T₇₂ | We keep starting and stopping. | 0 | 1 | 1 | 1 | 1 |
| T₇₃ | It's hard for us to stay focused. | 1 | 1 | 1 | 1 | 1 |
| T₇₄ | We need someone to keep on us. | 1 | 0 | 0 | 1 | 1 |
| T₇₅ | I just can't see it. | 1 | 0 | 0 | 1 | 1 |
| T₇₆ | It doesn't seem real yet. | 1 | 0 | 0 | 1 | 1 |
| T₇₇ | I can't get others to see what I see. | 1 | 0 | 0 | 1 | 1 |
| T₇₈ | I know what I want to do, but the details aren't | 1 | 0 | 0 | 1 | 1 |
| | clear yet. | | | | | |
| T₇₉ | I can't see it in my mind's eye yet. | 1 | 0 | 0 | 1 | 1 |
| T₈₀ | I can't get others to understand my idea. | 1 | 0 | 0 | 1 | 1 |
| T₈₁ | We just can't see it. | 0 | 1 | 1 | 1 | 1 |
| T₈₂ | We know what we want to do, but the details | 0 | 1 | 1 | 1 | 1 |
| | are unclear. | | | | | |
| T₈₃ | It doesn't seem real to us yet. | 0 | 1 | 1 | 1 | 1 |
| T₈₄ | It's clear to us but not to others. | 0 | 1 | 1 | 1 | 1 |
| T₈₅ | We can't agree on what it should look like. | 0 | 1 | 1 | 1 | 1 |
| T₈₆ | Other people just don't get it. | 1 | 1 | 1 | 1 | 1 |
| T₈₇ | We each have different ideas of what this | 0 | 1 | 1 | 1 | 1 |
| | should be. | | | | | |
| T₈₈ | I'm not sure what to expect or do next. | 1 | 0 | 0 | 1 | 1 |
| T₈₉ | This disorganization is killing me. | 1 | 0 | 0 | 1 | 1 |
| T₉₀ | Doing a lot, but getting nowhere. | 1 | 0 | 0 | 1 | 1 |
| T₉₁ | I don't know where to begin. | 1 | 0 | 0 | 1 | 1 |
| T₉₂ | Everything is a mess. | 1 | 0 | 0 | 1 | 1 |
| T₉₃ | I'm not so good at the details. | 1 | 0 | 0 | 1 | 1 |
| T₉₄ | I know what I want to do, but I just don't know | 1 | 0 | 0 | 1 | 1 |
| | how. | | | | | |
| T₉₅ | We're not so good at the details. | 0 | 1 | 1 | 1 | 1 |
| T₉₆ | We're not sure what to expect or do next. | 0 | 1 | 1 | 1 | 1 |
| T₉₇ | We're trying hard, but getting nowhere. | 0 | 1 | 1 | 1 | 1 |
| T₉₈ | Everything is a mess | 0 | 1 | 1 | 1 | 1 |
| T₉₉ | We know what we want to do, but we just don't | 0 | 1 | 1 | 1 | 1 |
| | know how. | | | | | |
| T₁₀₀ | The disorganization is killing us. | 0 | 1 | 1 | 1 | 1 |
| T₁₀₁ | We don't know where to begin. | 0 | 1 | 1 | 1 | 1 |
| T₁₀₂ | I don't know why this isn't working. | 1 | 0 | 0 | 1 | 1 |
| T₁₀₃ | My old way of doing this just isn't working. | 1 | 0 | 0 | 1 | 1 |
| T₁₀₄ | For every step forward, I take two steps back. | 1 | 0 | 0 | 1 | 1 |
| T₁₀₅ | I never have enough time. | 1 | 0 | 0 | 1 | 1 |
| T₁₀₆ | How do other people manage to do this? | 1 | 0 | 0 | 1 | 1 |
| T₁₀₇ | Our priorities keep shifting. | 0 | 1 | 1 | 1 | 1 |
| T₁₀₈ | We never have enough time. | 0 | 1 | 1 | 1 | 1 |
| T₁₀₉ | How do other people manage to do this? | 0 | 1 | 1 | 1 | 1 |
| T₁₁₀ | We don't know why this isn't working. | 0 | 1 | 1 | 1 | 1 |
| T₁₁₁ | Our old way of doing this just isn't working. | 0 | 1 | 1 | 1 | 1 |
| T₁₁₂ | There's got to be a better way. | 1 | 1 | 1 | 1 | 1 |
| T₁₁₃ | I'm not sure how I'm going to do this all by | 0 | 1 | 1 | 1 | 1 |
| | myself. | | | | | |
| T₁₁₄ | I wish I had an expert to help me. | 1 | 0 | 0 | 1 | 1 |
| T₁₁₅ | This is beyond me. | 1 | 0 | 0 | 1 | 1 |
| T₁₁₆ | There's only so much I can do on my own. | 1 | 0 | 0 | 1 | 1 |
| T₁₁₇ | I need help. | 1 | 0 | 0 | 1 | 1 |
| T₁₁₈ | This will take forever by myself. | 1 | 0 | 0 | 1 | 1 |
| T₁₁₉ | I have better things to do with my time. | 1 | 0 | 0 | 1 | 1 |
| T₁₂₀ | I'm spread too thin. | 1 | 0 | 0 | 1 | 1 |
| T₁₂₁ | We have better things to do with our time. | 0 | 1 | 1 | 1 | 1 |
| T₁₂₂ | There's only so much we can do on our own. | 0 | 1 | 1 | 1 | 1 |
| T₁₂₃ | We're not sure how we're going to get this all | 0 | 1 | 1 | 1 | 1 |
| | done. | | | | | |
| T₁₂₄ | I wish we had an expert to help us. | 0 | 1 | 1 | 1 | 1 |
| T₁₂₅ | We're spread too thin. | 0 | 1 | 1 | 1 | 1 |
| T₁₂₆ | This is beyond us. | 0 | 1 | 1 | 1 | 1 |
| T₁₂₇ | This will take us forever. | 0 | 1 | 1 | 1 | 1 |
| T₁₂₈ | Fear is taking over. | 1 | 0 | 0 | 1 | 1 |
| T₁₂₉ | I'm scared to do what I know I have to do. | 1 | 0 | 0 | 1 | 1 |
| T₁₃₀ | I just can't seem to pull the trigger and go do it. | 1 | 0 | 0 | 1 | 1 |
| T₁₃₁ | I'm good at finding excuses not to do it. | 1 | 0 | 0 | 1 | 1 |
| T₁₃₂ | I'm nervous about what might happen next. | 1 | 0 | 0 | 1 | 1 |
| T₁₃₃ | I just don't have the (insert excuse | 1 | 0 | 0 | 1 | 1 |
| | here). | | | | | |
| T₁₃₄ | There's no good reason why I'm not doing this. | 1 | 0 | 0 | 1 | 1 |
| T₁₃₅ | There's no good reason why we're not doing | 0 | 1 | 1 | 1 | 1 |
| | this. | | | | | |
| T₁₃₆ | We're nervous about what might happen next. | 0 | 1 | 1 | 1 | 1 |
| T₁₃₇ | We just can't pull the trigger and go do it. | 0 | 1 | 1 | 1 | 1 |
| T₁₃₈ | Fear is taking over. | 0 | 1 | 1 | 1 | 1 |
| T₁₃₉ | We keep finding excuses not to do it. | 0 | 1 | 1 | 1 | 1 |

### Table V—Doing

TABLE V
DOING

| | | | SBTA |
|---|---|---|---|
| | Doing Name | Rx category | Category |
| 1 | Ignoring things you know you shouldn't. | Stray from the usual | Seeing |
| 2 | Reading Wikipedia. | Stray from the usual | Seeing |
| 3 | Falling back on instinct. | Stray from the usual | Seeing |
| 4 | Constantly Googling. | Stray from the usual | Seeing |
| 5 | Shooting down ideas without solid reasons. | Stray from the usual | Seeing |
| 6 | Randomly filling in the blanks. | Stray from the usual | Seeing |
| 7 | Chasing the details. | Stray from the usual | Seeing |
| 8 | Making things up as you go. | Stray from the usual | Seeing |
| 9 | Overanalyzing. | Stray from the usual | Seeing |
| 10 | Avoiding the issue because you're just not into it. | Get restoked | Seeing |
| 11 | Looking for ways out. | Get restoked | Seeing |
| 12 | Going along with the pack. | Get restoked | Seeing |
| 13 | Giving in easily. | Get restoked | Seeing |
| 14 | Giving up. | Get restoked | Seeing |
| 15 | Longing for insight. | Get restoked | Seeing |
| 16 | Unable to explain what you want. | Figure it out | Believing |
| 17 | Letting life take you where it will. | Figure it out | Believing |
| 18 | Unable to imagine the future. | Figure it out | Believing |
| 19 | Doing busywork that gets you nowhere. | Figure it out | Believing |
| 20 | Feeling envious of others' accomplishments. | Figure it out | Believing |
| 21 | Looking for leadership. | Figure it out | Believing |
| 22 | Flip-flopping. | Figure it out | Believing |
| 23 | Unable to make a clear argument. | Take a stand | Believing |
| 24 | Overthinking it. | Take a stand | Believing |
| 25 | Second-guessing yourself. | Take a stand | Believing |
| 26 | Letting others take charge. | Take a stand | Believing |
| 27 | Regularly contradicting yourself. | Gut check it | Believing |
| 28 | Resisting change. | Gut check it | Believing |
| 29 | Debating an issue over and over again. | Gut check it | Believing |
| 30 | Questioning your choices. | Gut check it | Believing |
| 31 | Trying to ignore recent changes. | Commit | Believing |
| 32 | Continually talking about what you're going to do, but not | Commit | Believing |
| | actually doing it. | | |
| 33 | Hedging your bets by committing to a lot of different | Commit | Believing |
| | things. | | |
| 34 | Pursuing other projects. | Commit | Believing |
| 35 | Not giving it your all. | Commit | Believing |
| 36 | Letting yourself get distracted. | Commit | Believing |
| 37 | Every time you imagine it, it's a little bit different. | Envision success | Thinking |
| 38 | Having long conversations that end in confusion. | Envision success | Thinking |
| 39 | Being surprised when people don't fully get what you're | Envision success | Thinking |
| | saying. | | |
| 40 | Assuming people know what you mean, but they don't. | Envision success | Thinking |
| 41 | Obsessing about what is going on right now. | Make a game plan | Thinking |
| 42 | Endlessly re-doing the to-do list. | Make a game plan | Thinking |
| 43 | Running in place. | Make a game plan | Thinking |
| 44 | Constantly playing catch-up. | Make a game plan | Thinking |
| 45 | Making lots of lists. | Make a game plan | Thinking |
| 46 | Doing everything at the same time. | Make a game plan | Thinking |
| 47 | Starting new tasks without finishing what's already started. | Make a game plan | Thinking |
| 48 | Soldiering on. | Make a fresh start | Thinking |
| 49 | Head-scratching. | Make a fresh start | Thinking |
| 50 | Not getting the results you expected. | Make a fresh start | Thinking |
| 51 | Running lots of fire drills. | Make a fresh start | Thinking |
| 52 | Working hard, but not getting anywhere. | Make a fresh start | Thinking |
| 53 | Getting ready to quit. | Make a fresh start | Thinking |
| 54 | Finding workarounds. | Call in the cavalry | Acting |
| 55 | Doing nothing because you don't know where to start. | Call in the cavalry | Acting |
| 56 | Taking on everything yourself | Call in the cavalry | Acting |
| 57 | Looking for help. | Call in the cavalry | Acting |
| 58 | Faking it, hoping you'll make it. | Call in the cavalry | Acting |
| 59 | Deliberately getting in your own way. | Go for it | Acting |
| 60 | Putting off the inevitable. | Go for it | Acting |
| 61 | Doing everything except what you're supposed to be doing. | Go for it | Acting |
| 62 | Putting things off for no good reason. | Go for it | Acting |
| 63 | Making up excuses. | Go for it | Acting |
| 64 | Saying “I don't want to talk about it.” | Go for it | Acting |

### Table VI

TABLE VI

| | | Stray | | | | | | | Make | Make | Can | |
|---|---|---|---|---|---|---|---|---|---|---|---|---|
| | | from | Get | Figure | Take a | Gut | | Envision | a game | a Fresh | in the | Go |
| | Doing Name | the usual | restoked | it out | stand | check it | Commit | Success | plan | Start | cavalry | for it |
| 1 | Ignoring things you know you | 10 | | | | | | | | | | |
| | shouldn't. | | | | | | | | | | | |
| 2 | Reading Wikipedia. | 10 | | | | | | | | | | |
| 3 | Falling back on instinct. | 10 | | | | | | | | | | |
| 4 | Constantly Googling. | 10 | | | | | | | | | | |
| 5 | Shooting down ideas without | 10 | | | | | | | | | | |
| | solid reasons. | | | | | | | | | | | |
| 6 | Randomly filling in the blanks. | 10 | | | | | | | | | | |
| 7 | Chasing the details. | 10 | | | | | | | | | | |
| 8 | Making things up as you go. | 10 | | | | | | | | | | |
| 9 | Overanalyzing. | 10 | | | | | | | | | | |
| 10 | Avoiding the issue because you're | | 10 | | | | | | | | | |
| | just not into it. | | | | | | | | | | | |
| 11 | Looking for ways out. | | 10 | | | | | | | | | |
| 12 | Going along with the pack. | | 10 | | | | | | | | | |
| 13 | Giving in easily. | | 10 | | | | | | | | | |
| 14 | Giving up. | | 10 | | | | | | | | | |
| 15 | Longing for insight. | | 10 | | | | | | | | | |
| 16 | Unable to explain what you want. | | | 10 | | | | | | | | |
| 17 | Letting life take you where it will. | | | 10 | | | | | | | | |
| 18 | Unable to imagine the future. | | | 10 | | | | | | | | |
| 19 | Doing busywork that gets you | | | 10 | | | | | | | | |
| | nowhere. | | | | | | | | | | | |
| 20 | Feeling envious of others' | | | 10 | | | | | | | | |
| | accomplishments. | | | | | | | | | | | |
| 21 | Looking for leadership. | | | 10 | | | | | | | | |
| 22 | Flip-flopping. | | | 10 | | | | | | | | |
| 23 | Unable to make a clear argument. | | | | 10 | | | | | | | |
| 24 | Overthinking it. | | | | 10 | | | | | | | |
| 25 | Second-guessing yourself. | | | | 10 | | | | | | | |
| 26 | Letting others take charge. | | | | 10 | | | | | | | |
| 27 | Regularly contradicting yourself. | | | | | 10 | | | | | | |
| 28 | Resisting change. | | | | | 10 | | | | | | |
| 29 | Debating an issue over and over | | | | | 10 | | | | | | |
| | again. | | | | | | | | | | | |
| 30 | Questioning your choices. | | | | | 10 | | | | | | |
| 31 | Trying to ignore recent changes. | | | | | 10 | | | | | | |
| 32 | Continually talking about what | | | | | 10 | | | | | | |
| | you're going to do, but not | | | | | | | | | | | |
| | actually doing it. | | | | | | | | | | | |
| 33 | Hedging your bets by committing | | | | | | 10 | | | | | |
| | to a lot of different things. | | | | | | | | | | | |
| 34 | Pursuing other projects. | | | | | | 10 | | | | | |
| 35 | Not giving it your all. | | | | | | 10 | | | | | |
| 36 | Letting yourself get distracted. | | | | | | 10 | | | | | |
| 37 | Every time you imagine it, it's a | | | | | | | 10 | | | | |
| | little bit different. | | | | | | | | | | | |
| 38 | Having long conversations that | | | | | | | 10 | | | | |
| | end in confusion. | | | | | | | | | | | |
| 39 | Being surprised when people | | | | | | | 10 | | | | |
| | don't fully get what you're saying. | | | | | | | | | | | |
| 40 | Assuming people know what you | | | | | | | 10 | | | | |
| | mean, but they don't. | | | | | | | | | | | |
| 41 | Obsessing about what is going on | | | | | | | | 10 | | | |
| | right now. | | | | | | | | | | | |
| 42 | Endlessly re-doing the to-do list. | | | | | | | | 10 | | | |
| 43 | Running in place. | | | | | | | | 10 | | | |
| 44 | Constantly playing catch-up. | | | | | | | | 10 | | | |
| 45 | Making lots of lists. | | | | | | | | 10 | | | |
| 46 | Doing everything at the same | | | | | | | | 10 | | | |
| | time. | | | | | | | | | | | |
| 47 | Starting new tasks without | | | | | | | | 10 | | | |
| | finishing what's already started. | | | | | | | | | | | |
| 48 | Soldiering on. | | | | | | | | | 10 | | |
| 49 | Head-scratching. | | | | | | | | | 10 | | |
| 50 | Not getting the results you | | | | | | | | | 10 | | |
| | expected. | | | | | | | | | | | |
| 51 | Running lots of fire drills. | | | | | | | | | 10 | | |
| 52 | Working hard, but not getting | | | | | | | | | 10 | | |
| | anywhere. | | | | | | | | | | | |
| 53 | Getting ready to quit. | | | | | | | | | 10 | | |
| 54 | Finding workarounds. | | | | | | | | | | 10 | |
| 55 | Doing nothing because you don't | | | | | | | | | | 10 | |
| | know where to start. | | | | | | | | | | | |
| 56 | Taking on everything yourself. | | | | | | | | | | 10 | |
| 57 | Looking for help. | | | | | | | | | | 10 | |
| 58 | Faking it, hoping you'll make it. | | | | | | | | | | 10 | |
| 59 | Deliberately getting in your own | | | | | | | | | | | 10 |
| | way. | | | | | | | | | | | |
| 60 | Putting off the inevitable. | | | | | | | | | | | 10 |
| 61 | Doing everything except what | | | | | | | | | | | 10 |
| | you're supposed to be doing. | | | | | | | | | | | |
| 62 | Putting things off for no good | | | | | | | | | | | 10 |
| | reason. | | | | | | | | | | | |
| 63 | Making up excuses. | | | | | | | | | | | 10 |
| 64 | Saying “I don't want to talk about | | | | | | | | | | | 10 |
| | it.” | | | | | | | | | | | |

### Table VII

TABLE VII

| | Relationship |
|---|---|
| Statement/question | category_type |
| Who is in charge of this? | Leadership |
| Who is leading? | Leadership |
| Where are we going? Why? | Leadership |
| We have no real leader. | Leadership |
| We have too many cooks in the kitchen. | Leadership |
| We have lots of people who want to be in charge. | Leadership |
| He/she is being condescending to me. | Leadership |
| My ideas are not being taken seriously. | Leadership |
| I'm not being heard. | Leadership |
| I'm constantly being cut off. | Respect |
| I'm not respected. | Respect |
| I don't believe that person. | Respect |
| I'm tired of being talked down to by that person. | Respect |
| That person is not listening to me. | Respect |
| I'm being ignored on purpose. | Respect |
| People's ideas are not being taken seriously. | Respect |
| People are not being heard. | Respect |
| We're constantly cutting off each other when we're | Respect |
| talking. | |
| We're ignoring each other intentionally. | Respect |
| People are giving each other the “silent treatment.” | Respect |
| I think he/she might be misleading me. | Trust |
| I don't believe her/him. | Trust |
| People are lying. | Trust |
| People are holding things back. | Trust |
| People are undermining each other. | Trust |
| People are skeptical of each other. | Trust |
| I think people are misleading me. | Trust |
| It is exhausting working with that person. | Trust |
| Everything is a big deal and takes longer than it should | Trust |
| when I work with that person. | |
| I feel like doing it by myself because it would be faster | Trust |
| and easier. | |
| We're not in a good workflow. | Working style |
| We have very different ways of working. | Working style |
| This is exhausting. | Working style |
| Everything is a big deal and takes longer than it | Working style |
| should. | |
| We haven't agreed on how to get this done. | Working style |
| That person is not pulling his/her weight. | Working style |
| That person is not following through on his/her | Working style |
| commitments. | |
| I'm the only one that is really worried about this. | Working style |
| Not everyone is taking ownership. | Accountability |
| Not everyone is committed. | Accountability |
| We're not on the same page. | Accountability |
| We have different priorities. | Accountability |
| We have different goals. | Accountability |
| That person doesn't want to do any of the hard work. | Accountability |
| We're not equally invested in this. | Accountability |
| We're moving in different directions. | Alignment |
| We want different things. | Alignment |
| We're not sure what we want. | Alignment |
| We have different working styles. | Alignment |
| We're not clicking. | Alignment |
| We're not working well together. | Alignment |
| We can't get along. | Chemistry |
| We're just putting up with each other. | Chemistry |
| We have different personalities. | Chemistry |
| We can't get along. | Chemistry |
| We don't like each other. | Chemistry |
| We're just too different. | Chemistry |
| We have very different interests. | Chemistry |
| We don't all like each other. | Chemistry |
| We're not understanding each other. | Chemistry |
| I'm not clear what that person is saying. | Chemistry |
| That person doesn't understand me. | Chemistry |
| I can't get that person to see my point of view. | Communications |
| I don't know what that person is trying to tell me. | Communications |
| I'm not clear what others are saying and what they | Communications |
| mean. | |
| They don't understand me. | Communications |
| I can't get them to see my point of view. | Communications |
| That person is not taking ownership. | Communications |
| I am the only one that is committed. | Communications |
| I'm the only one that is really working on this. | Communications |
| None of these apply to me. | None |

APPENDIX B
SOURCE CODE

| | Diagnostic.h |
|---|---|
| 1 | #import <Foundation/Foundation.h> |
| 2 | #import “CSVParser.h” |
| 3 | #import “EntryReceiver.h” |
| 4 | @interface Diagnostic : NSObject { |
| 5 | NSDictionary* feeling 1 ; NSDictionary* feeling2; NSDictionary* feeling3; |
| 6 | BOOL isPersonal; BOOL isProfessional; BOOL isMe; |
| 7 | BOOL isMeAndAnother; BOOL isMeAndOthers; |
| 8 | NSString* stuckBecause; NSMutableArray* thoughts; |
| 9 | NSMutableArray* doing; NSDictionary* relationship; |
| 10 | NSMutableArray* rxInfo; NSMutableArray* dxFeelingInfo; |
| 11 | NSMutableArray* dxSayingInfo; NSMutableArray* dxRelationshipInfo; |
| 12 | NSMutableArray* theAlgorithm; NSString* stuckee; |
| 13 | } |
| 14 | @property (nonatomic, retain) NSString* stuckee; |
| 15 | @property (nonatomic, retain) NSDictionary* feeling1; |
| 16 | @property (nonatomic, retain) NSDictionary* feeling2; |
| 17 | @property (nonatomic, retain) NSDictionary* feeling3; |
| 18 | @property (nonatomic, assign) BOOL isPersonal; |
| 19 | @property (nonatomic, assign) BOOL isProfessional; |
| 20 | @property (nonatomic, assign) BOOL isMe; |
| 21 | @property (nonatomic, assign) BOOL isMeAndAnother; |
| 22 | @property (nonatomic, assign) BOOL isMeAndOthers; |
| 23 | @property (nonatomic, retain) NSString* stuckBecause; |
| 24 | @property (nonatomic, readonly) NSMutableArray* thoughts; |
| 25 | @property (nonatomic, readonly) NSMutableArray* doing; |
| 26 | @property (nonatomic, retain) NSDictionary* relationship; |
| 27 | @property (nonatomic, readonly) NSMutableArray* rxInfo; |
| 28 | @property (nonatomic, readonly) NSMutableArray* dxFeelingInfo; |
| 29 | @property (nonatomic, readonly) NSMutableArray* dxSayingInfo; |
| 30 | @property (nonatomic, readonly) NSMutableArray* dxRelationshipInfo; |
| 31 | -(NSString*) rx; |
| 32 | -(NSMutableArray*) availableDXOptionsChosenSoFar; |
| 33 | -(NSArray*) allMatchingRXForCurrentDiagnostic; |
| 34 | -(BOOL) matchesTheirDX:(NSDictionary*)anRXRow; |
| 35 | -(NSDictionary*) esmerelda; |
| 36 | -(NSMutableDictionary*) getSumValues; |
| 37 | -(NSDictionary*) getFeelingNamed:(NSString*)emotion; |
| 38 | -(NSDictionary*) getThoughtNamed:(NSString*)thought; |
| 39 | -(NSDictionary*) getDoingNamed:(NSString*)doing; |
| 40 | @end |
| | Diagnostic.m |
| 41 | #import “Diagnostic.h” |
| 42 | #import “NSMutableArray+Extras.h” |
| 43 | @interface Diagnostic (Private) |
| 44 | -(void) loadRX; -(void) loadDX; -(void) loadRel; -(void) loadAlgorithm; |
| 45 | -(NSString*) findLargestKeyInDictionary:(NSDictionary*)dict; |
| 46 | -(NSString*) findSecondLargestKeyInDictionary:(NSDictionary*)dict; |
| 47 | -(NSDictionary*) algorithmRowForDX:(NSString*)dx; |
| 48 | -(NSDictionary*) algorithmRowForRX:(NSString*)rx; |
| 49 | -(NSArray*) allAlgosForSBTA:(NSString*)sbta; |
| 50 | @end |
| 51 | @implementation Diagnostic |
| 52 | @synthesize feeling1; @synthesize feeling2; @synthesize feeling3; |
| 53 | @synthesize isPersonal; @synthesize isProfessional; |
| 54 | @synthesize isMe; @synthesize isMeAndOthers; @synthesize isMeAndAnother; |
| 55 | @synthesize stuckBecause; @synthesize thoughts; @synthesize doing; |
| 56 | @synthesize relationship; @synthesize rxInfo; @synthesize dxFeelingInfo; |
| 57 | @synthesize dxSayingInfo;@synthesize dxRelationshipInfo; |
| 58 | @synthesize stuckee; |
| 59 | -(id) init{ if((self = [super init])){ |
| 60 | thoughts = [[NSMutableArray alloc] init]; |
| 61 | doing = [[NSMutableArray alloc] init]; |
| 62 | [self loadRX]; [self loadDX]; [self loadRel]; [self loadAlgorithm]; |
| 63 | stuckee = nil; } |
| 64 | return self;} |
| 65 | -(BOOL) isProfessional{ return isProfessional; } |
| 66 | -(void) setIsMe:(BOOL)_isMe{ isMe = _isMe; if(isMe){ isMeAndOthers = NO; |
| 67 | isMeAndAnother = NO;} } |
| 68 | -(void) setIsMeAndAnother:(BOOL)_isMeAndAnother{ |
| 69 | isMeAndAnother = isMeAndAnother; |
| 70 | if(isMeAndAnother){ isMeAndOthers = NO; isMe = NO;} } |
| 71 | -(void) setIsMeAndOthers:(BOOL)_isMeAndOthers{ |
| 72 | isMeAndOthers = _isMeAndOthers; |
| 73 | if(isMeAndOthers){isMe = NO; isMeAndAnother = NO; } } |
| 74 | -(NSDictionary*) getFeelingNamed:(NSString*)emotion{ |
| 75 | for (NSDictionary* feeling in dxFeelingInfo) { |
| 76 | if([[[feeling objectForKey:@“name”] lowercaseString] isEqToString:[emotion |
| | lowercaseString]]){ |
| 77 | return feeling; } } |
| 78 | return nil; } |
| 79 | -(NSDictionary*) getThoughtNamed:(NSString*)thought{ |
| 80 | for (NSDictionary* obj in dxSayingInfo) { |
| 81 | if([[[obj objectForKey:@“name”] lowercaseString] |
| 82 | isEqToString:[thought lowercaseString]]){ return obj;} } return nil; } |
| 83 | -(NSDictionary*) getDoingNamed:(NSString*)name{ |
| 84 | for (NSDictionary* obj in rxInfo) { |
| 85 | if([[[obj objectForKey:@“name”] lowercaseString] isEqToString:[name |
| | lowercaseString]]){ |
| 86 | return obj; } } return nil;} |
| 87 | -(NSMutableDictionary*) getSumValues{ |
| 88 | NSMutableDictionary* sumValues = [[NSMutableDictionary alloc] init]; |
| 89 | for(NSDictionary* algRow in theAlgorithm){ |
| 90 | NSString* key = [algRow objectForKey:@“DX”] ; |
| 91 | CGFloat insightValue = |
| 92 | [[feeling1 objectForKey:key] floatValue] * [[feeling1 objectForKey:@“rating”] floatValue]/ |
| | 10; |
| 93 | insightValue += |
| 94 | [[feeling2 objectForKey:key] floatValue] * [[feeling1 objectForKey:@“rating”] floatValue]/ |
| | 10; |
| 95 | insightValue += |
| 96 | [[feeling3 objectForKey:key] floatValue] * [[feeling1 objectForKey:@“rating”] floatValue]/ |
| | 10; |
| 97 | for(NSDictionary* thought in thoughts){ |
| 98 | insightValue += [[thought objectForKey:key] floatValue]; } |
| 99 | insightValue += [[relationship objectForKey:key] floatValue]; |
| 100 | [sumValues setObject:[NSNumber numberWithFloat:insightValue] forKey:key];} |
| 101 | return sumValues; } |
| 102 | // this function returns the top DX results for the user, either an array |
| 103 | // of 2 if top are tied from SBTA, or multiple from the same SBTA |
| 104 | -(NSArray*) availableDXOptionsChosenSoFar{ |
| 105 | NSMutableDictionary* sumValues = [self getSumValues]; |
| 106 | NSString* dx1 = [self findLargestKeyInDictionary:sumValues]; |
| 107 | NSString* dx2 = [self findSecondLargestKeyInDictionary:sumValues]; |
| 108 | NSNumber* dxVal1 = [sumValues objectForKey:dx1]; |
| 109 | NSNumber* dxVal2 = [sumValues objectForKey:dx2]; |
| 110 | NSDictionary* algRow1 = [self algorithmRowForDX:dx1]; |
| 111 | NSDictionary* algRow2 = [self algorithmRowForDX:dx2]; |
| 112 | if([dxVal1 isEqToNumber:dxVal2] && ![[algRow1 objectForKey:@“SBTA”] |
| 113 | isEqToString:[algRow2 objectForKey:@“SBTA”]]){ |
| 114 | // values are Eq, and are not in the same SBTA, break tie with the RX from the top 2 |
| 115 | return [NSArray arrayWithObjects:algRow1, algRow2, nil]; |
| 116 | }else{ |
| 117 | // otherwise, us all RX from the SBTA of the leading DX result |
| 118 | return [self allAlgosForSBTA:[algRow1 objectForKey:@“SBTA”]]; |
| 119 | } } |
| 120 | -(NSArray*) allMatchingRXForCurrentDiagnostic{ |
| 121 | NSArray* itemsInTheList = [rxInfo randomOrderedArray]; |
| 122 | NSMutableArray* ret = [NSMutableArray array]; |
| 123 | for(int i=0;i<[itemsInTheList count];i++){ |
| 124 | NSDictionary* item = [itemsInTheList objectAtIndex:i]; |
| 125 | if((self.isPersonal && [[item objectForKey:@“flag_personal”] boolValue]) \|\| |
| 126 | (!self.isPersonal && [[item objectForKey:@“flag_professional”] boolValue])){ |
| 127 | // it passes the personal/professional check, now look at me, me+1, me++ |
| 128 | if((self.isMe && [[item objectForKey:@“flag_me”] boolValue]) \|\| |
| 129 | (self.isMeAndAnother && [[item objectForKey:@“flag_meplus1”] boolValue]) \|\| |
| 130 | (self.isMeAndOthers && [[item objectForKey:@“flag_meplus2”] boolValue])){ |
| 131 | if([[[item objectForKey:@“symptom_type”] lowercaseString] |
| | isEqToString:@“doing”]){ |
| 132 | // it passes the me / me plus1 / me plus others check |
| 133 | // let's look at if it matches their DX scores |
| 134 | if([self matchesTheirDX:item]){[ret addObject:item]; } |
| 135 | } } } } |
| 136 | return ret; } |
| 137 | /** determine the RX output given the current diagnostic answers */ |
| 138 | -(NSString*) rx{ |
| 139 | NSMutableDictionary* rx = [NSMutableDictionary dictionary]; |
| 140 | for(NSDictionary* dict in doing){ |
| 141 | NSNumber* value = [dict objectForKey:[dict objectForKey:@“category_type”]]; |
| 142 | NSNumber* currValue = [rx objectForKey:[dict objectForKey:@“category_type”]]; |
| 143 | if(!value){ [rx setObject:[NSNumber numberWithInt:1] |
| 144 | forKey:[dict objectForKey:@“category_type”]]; |
| 145 | }else if([value intValue] > 0){ |
| 146 | [rx setObject:[NSNumber numberWithInt:([value intValue]; |
| 147 | + [currValue intValue])] forKey:[dict |
| | objectForKey:@“category_type”]] |
| 148 | } } return [self findLargestKeyInDictionary:rx];} |
| 149 | -(NSDictionary*) esmerelda{ |
| 150 | NSMutableDictionary* sumValues = [self getSumValues]; |
| 151 | for(NSDictionary* dict in doing){ |
| 152 | NSString* key = [dict objectForKey:@“category_type”]; |
| 153 | NSDictionary* algRow = [self algorithmRowForRX:key]; |
| 154 | NSNumber* value = [dict objectForKey:key]; |
| 155 | NSNumber* currValue = [sumValues objectForKey:[algRow objectForKey:@“DX”]]; |
| 156 | if(!value){ |
| 157 | [sumValues setObject:[NSNumber numberWithInt:1] forKey:[algRow |
| | objectForKey:@“DX”]]; |
| 158 | }else if([value intValue] > 0){ |
| 159 | [sumValues setObject:[NSNumber numberWithInt:([value intValue] + [currValue |
| | intValue])] |
| 160 | forKey:[algRow objectForKey:@“DX”]]; } } |
| 161 | NSString* largestKey = [self findLargestKeyInDictionary:sumValues]; |
| 162 | return [self algorithmRowForDX:largestKey];} |
| 163 | -(BOOL) matchesTheirDX:(NSDictionary*)anRXRow{ |
| 164 | NSArray* availableDXOptions = [self availableDXOptionsChosenSoFar]; |
| 165 | for (NSDictionary* row in availableDXOptions) { |
| 166 | if([[[row objectForKey:@“RX”] lowercaseString] isEqToString:[[anRXRow |
| 167 | objectForKey:@“category_type”] lowercaseString]]){ |
| 168 | return YES; } } |
| 169 | return NO;} |
| 170 | #pragma mark - Private |
| 171 | -(NSArray*) allAlgosForSBTA:(NSString*)sbta{ |
| 172 | NSMutableArray* output = [NSMutableArray array]; |
| 173 | for(NSDictionary* row in theAlgorithm){ |
| 174 | if([[row objectForKey:@“SBTA”] isEqToString:sbta]){ |
| 175 | [output addObject:row]; } } |
| 176 | return output;} |
| 177 | -(NSString*) findLargestKeyInDictionary:(NSDictionary*)dict{ |
| 178 | NSString* largestKeySoFar = @“”; |
| 179 | for(NSString* key in [dict allKeys]){ |
| 180 | if([[dict objectForKey:key] floatValue] > [[dict objectForKey:largestKeySoFar] |
| | floatValue]){ |
| 181 | largestKeySoFar = key; } } |
| 182 | return largestKeySoFar;} |
| 183 | -(NSString*) findSecondLargestKeyInDictionary:(NSDictionary*)dict{ |
| 184 | NSString* largestKeySoFar = [self findLargestKeyInDictionary:dict]; |
| 185 | NSString* secondKeySoFar = @“”; |
| 186 | for(NSString* key in [dict allKeys]){ |
| 187 | if(![key isEqToString:largestKeySoFar]){ |
| 188 | if([[dict objectForKey:key] floatValue] > [[dict objectForKey:secondKeySoFar] |
| | floatValue]){ |
| 189 | secondKeySoFar = key; } |
| 190 | } } return secondKeySoFar; } |
| 191 | // export the .xls file to csv - remove all commas from text values |
| 192 | -(void) loadDX{ |
| 193 | // load the points from our local resource |
| 194 | NSString* filePath = [[NSBundle mainBundle] pathForResource:@“US_DXsymptoms” |
| | ofType:@“csv”]; |
| 195 | NSString* fileContents = |
| 196 | [NSString stringWithContentsOfFile:filePath encoding:NSUTF8StringEncoding |
| | error:nil]; |
| 197 | dxFeelingInfo = [[NSMutableArray alloc] init]; |
| 198 | dxSayingInfo = [[NSMutableArray alloc] init]; |
| 199 | CSVParser *parser = |
| 200 | [[[CSVParser alloc] |
| 201 | initWithString:fileContents |
| 202 | separator:@“,” |
| 203 | hasHeader:YES |
| 204 | fieldNames:nil] |
| 205 | autorelease]; |
| 206 | [parser parseRowsForReceiver:self selector:@selector(receiveDXRecord:)]; |
| 207 | } |
| 208 | // export the .xls file to csv -- remove all commas from text values |
| 209 | -(void) loadRel{ // load the points from our local resource |
| 210 | NSString* filePath = [[NSBundle mainBundle] pathForResource:@“US_RELsymptoms” |
| | ofType:@“csv”]; |
| 211 | NSString* fileContents = |
| 212 | [NSString stringWithContentsOfFile:filePath encoding:NSUTF8StringEncoding |
| | error:nil]; |
| 213 | dxRelationshipInfo = [[NSMutableArray alloc] init]; |
| 214 | CSVParser *parser = [[[CSVParser alloc] |
| 215 | initWithString:fileContents |
| 216 | separator:@“,” |
| 217 | hasHeader:YES |
| 218 | fieldNames:nil] |
| 219 | autorelease]; |
| 220 | [parser parseRowsForReceiver:self selector:@selector(receiveDXRecord:)];} |
| 221 | - (void)receiveDXRecord:(NSDictionary *)aRecord { |
| 222 | // NSLog(@“record: %@”, [[aRecord objectForKey:@“symptom_type”] |
| | lowercaseString]); |
| 223 | if(aRecord && [[[aRecord objectForKey:@“symptom_type”] lowercaseString] |
| 224 | isEqToString:@“feeling”]){[dxFeelingInfo addObject:aRecord]; |
| 225 | }else if(aRecord && [[[aRecord objectForKey:@“symptom_type”] lowercaseString] |
| 226 | isEqToString:@“saying”]){ |
| 227 | [dxSayingInfo addObject:aRecord]; |
| 228 | }else if(aRecord && [[[aRecord objectForKey:@“symptom_type”] lowercaseString] |
| 229 | isEqToString:@“relationship”]){ |
| 230 | [dxRelationshipInfo addObject:aRecord]; |
| 231 | } } |
| 232 | // export the .xls file to csv -- remove all commas from text values |
| 233 | -(void) loadRX{ |
| 234 | // load the points from our local resource |
| 235 | NSString* filePath = |
| 236 | [[NSBundle mainBundle] pathForResource:@“unstuck_RXsymptoms” |
| | ofType:@“csv”]; |
| 237 | NSString* fileContents = |
| 238 | [NSString stringWithContentsOfFile:filePath encoding:NSUTF8StringEncoding |
| | error:nil]; |
| 239 | rxInfo = [[NSMutableArray alloc] init]; |
| 240 | CSVParser *parser = |
| 241 | [[[CSVParser alloc] |
| 242 | initWithString:fileContents |
| 243 | separator:@“,” |
| 244 | hasHeader:YES |
| 245 | fieldNames:nil] |
| 246 | autorelease]; |
| 247 | [parser parseRowsForReceiver:self selector:@selector(receiveRXRecord:)]; |
| 248 | } |
| 249 | - (void)receiveRXRecord:(NSDictionary *)aRecord { |
| 250 | [rxInfo addObject:aRecord]; } |
| 251 | -(void) loadAlgorithm{ NSString* filePath = |
| 252 | [[NSBundle mainBundle] pathForResource:@“the algorithm” ofType:@“csv”]; |
| 253 | NSString* fileContents = |
| 254 | [NSString stringWithContentsOfFile:filePath encoding:NSUTF8StringEncoding |
| | error:nil]; |
| 255 | theAlgorithm = [[NSMutableArray alloc] init]; |
| 256 | CSVParser *parser = |
| 257 | [[[CSVParser alloc] |
| 258 | initWithString:fileContents |
| 259 | separator:@“,” |
| 260 | hasHeader:YES |
| 261 | fieldNames:nil] |
| 262 | autorelease]; |
| 263 | [parser parseRowsForReceiver:self selector:@selector(receiveAlgorithmRecord:)];} |
| 264 | - (void)receiveAlgorithmRecord:(NSDictionary *)aRecord { |
| 265 | [theAlgorithm addObject:aRecord]; } |
| 266 | -(NSDictionary*) algorithmRowForDX:(NSString*)dx{ |
| 267 | for(NSDictionary* row in theAlgorithm){ |
| 268 | if([[row objectForKey:@“DX”] isEqToString:dx]){ return row;} } |
| 269 | return nil; |
| 270 | } |
| 271 | -(NSDictionary*) algorithmRowForRX:(NSString*)rx{ |
| 272 | for(NSDictionary* row in theAlgorithm){ |
| 273 | if([[row objectForKey:@“RX”] isEqToString:rx]){ |
| 274 | return row; } } |
| 275 | return nil;} |
| 276 | @end |

What is claimed:

1. A computer-implemented system for helping a person get unstuck from a stuck moment, the system implemented on a computer device comprising hardware, including a processor and memory, the system including software programmed to perform, using the hardware to:
(a) determine the person's feelings about the stuck moment;
(b) determine which parties are involved in the stuck moment;
(c) determine the person's thoughts about the stuck moment;
(d) based at least in part on the person's feelings about the stuck moment, as determined in (a), and thoughts about the stuck moment, as determined in (c), determine one or more archetypes corresponding to the stuck moment;
(e) using the one or more archetypes determined in (d), determine what the person is doing about the stuck moment;
(f) based at least in part on what the person is doing, as determined in (e), and the one or more archetypes, as determined in (d), determine a diagnosis for the person;
(g) provide the person with the diagnosis as determined in (f) and with access to at least one computer-implemented tool to deal with the stuck moment.

2. The system of claim 1 wherein the system provides a graphical user interface (GUI), and wherein the system uses the GUI, at least in part, to perform (a), (b), (c), and (g).

3. The system of claim 1 wherein each of the one or more archetypes corresponds to one category in a paradigm.

4. The system of claim 3 wherein the paradigm is a “See, Believe, Think, Act” (SBTA) paradigm.

5. The system of claim 4 wherein the one or more archetypes comprise one or more of: Tunnel Visionary, Deflated Doer, Drifter, Waffler, Reluctant Adapter, Idle Achiever, Fuzzy Forecaster, Adlibber, Perplexed Planner, Lone Leader, and Avoider.

6. The system of claim 1 wherein each of the one or more archetypes has a corresponding prescription, wherein each prescription has a corresponding computer-implemented tool, and wherein the diagnosis for the person determines, at least in part, a prescription for that person, and wherein the prescription for that person determines the at least one computer-implemented tool for that person to deal with the stuck moment.

7. A computer-implemented method, the method implemented on a computer device comprising hardware, including a processor and memory, and software, the method comprising, using the hardware in combination with the software:
(A) determining a person's feelings about a stuck moment;
(B) determining which parties are involved in the stuck moment;
(C) determining the person's thoughts about the stuck moment;
(D) based at least in part on the person's feelings about the stuck moment, as determined in (A), and thoughts about the stuck moment, as determined in (C), determining one or more archetypes corresponding to the stuck moment;
(E) using the one or more archetypes determined in (D), determining what the person is doing about the stuck moment;
(F) based at least in part on what the person is doing, as determined in (E) and the one or more archetypes determined in (D), determining a diagnosis for the person;
(G) providing the person with the diagnosis determined in (F) and with access to at least one computer-implemented tool to deal with the stuck moment.

8. The method of claim 7 further comprising:
providing a graphical user interface (GUI), and wherein said steps (A), (B), (C), and (G) are performed, at least in part, using said GUI.

9. The method of claim 7 wherein each of the one or more archetypes corresponds to one category in a paradigm.

10. The method of claim 9 wherein the paradigm is a “See, Believe, Think, Act” (SBTA) paradigm.

11. The system of claim 10 wherein the one or more archetypes comprise one or more of: Tunnel Visionary, Deflated Doer, Drifter, Waffler, Reluctant Adapter, Idle Achiever, Fuzzy Forecaster, Adlibber, Perplexed Planner, Lone Leader, and Avoider.

12. The system of claim 7 wherein each of the one or more archetypes has a corresponding prescription, wherein each prescription has a corresponding computer-implemented tool, and wherein the diagnosis for the person determines, at least in part, a prescription for that person, and wherein the prescription for that person determines the at least one computer-implemented tool for that person to deal with the stuck moment.

13. A device comprising hardware and software, in conjunction with said hardware constructed and adapted to:
perform the method of claim 1.

14. A non-transient computer-readable storage medium comprising computer-readable program code, the computer-readable storage code being executable by a processor to perform a process comprising:
(A) determining a person's feelings about a stuck moment;
(B) determining which parties are involved in the stuck moment;
(C) determining the person's thoughts about the stuck moment;
(D) based at least in part on the person's feelings about the stuck moment determined in (A) and thoughts about the stuck moment as determined in (C), determining one or more archetypes corresponding to the stuck moment;
(E) using the one or more archetypes determined in (D), determining what the person is doing about the stuck moment;
(F) based at least in part on what the person is doing, as determined in (E), and the one or more archetypes, as determined in (D), determining a diagnosis for the person;
(G) providing the person with the diagnosis, as determined in (F), and with access to at least one computer-implemented tool to deal with the stuck moment.

15. The non-transient computer-readable storage medium of claim 14 further comprising computer-readable program code, the computer-readable storage code being executable by the processor to:
provide a graphical user interface (GUI), and wherein said steps (A), (B), (C), and (G) are performed, at least in part, using said GUI.

16. The non-transient computer-readable storage medium of claim 14 wherein each of the one or more archetypes corresponds to one category in a paradigm.

17. The non-transient computer-readable storage medium of claim 16 wherein the paradigm is a “See, Believe, Think, Act” (SBTA) paradigm.

18. The non-transient computer-readable storage medium of claim 16 wherein the one or more archetypes comprise one or more of: Tunnel Visionary, Deflated Doer, Drifter, Waffler, Reluctant Adapter, Idle Achiever, Fuzzy Forecaster, Adlibber, Perplexed Planner, Lone Leader, and Avoider.

19. The non-transient computer-readable storage medium of any of claims 14 and 15 wherein each of the one or more archetypes has a corresponding prescription, wherein each prescription has a corresponding computer-implemented tool, and wherein the diagnosis for the person determines, at least in part, a prescription for that person, and wherein the prescription for that person determines the at least one computer-implemented tool for that person to deal with the stuck moment.

20. The system of claim 2 wherein the GUI is a web-based interface.

21. The method of claim 8 wherein the GUI is a web-based interface.

22. The non-transient computer-readable storage medium of claim 15 wherein the GUI is a web-based interface.

23. The device of claim 13 wherein the device is a hand-held device.
